(19) United States
(12) Patent Application Publication
(10) Pub. No.: US 2008/0111773 A1
(43) Pub. Date: May 15, 2008

(54) ACTIVE MATRIX DISPLAY DEVICE USING ORGANIC LIGHT-EMITTING ELEMENT AND METHOD OF DRIVING ACTIVE MATRIX DISPLAY DEVICE USING ORGANIC LIGHT-EMITTING ELEMENT

(75) Inventor: HITOSHI TSUGE, Ibaraki-Shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Toshiba Matsushita Display Technology, Tokyo (JP)

(21) Appl. No.: 11/937,720

(22) Filed: Nov. 9, 2007

(30) Foreign Application Priority Data
Nov. 10, 2006 (JP) 2006-305797

(51) Int. Cl. G09G 3/30

(52) U.S. Cl. 345/76

(57) ABSTRACT

An active matrix display device using an organic light-emitting element has a pixel having the organic light-emitting element; a driving transistor that determines an electric current flowing to the organic light-emitting element according to a gate voltage; a storing unit; and a voltage output unit that supplies a voltage to the pixel, wherein a voltage output from the voltage output unit varies depending on data in the storing unit.

### CROSS-REFERENCE TO RELATED APPLICATIONS

This application claims priority to Japanese Patent Application No. 2006-305797, filed in the Japanese Patent Office on Nov. 10, 2006, and the entire contents are hereby incorporated herein by reference.

### BACKGROUND OF THE INVENTION

1. Field of the Invention

The present invention relates to an active matrix display device that performs gradation display according to a current amount using an organic light-emitting element or the like and a method of driving an active matrix display device using organic light-emitting element.

2. Description of the Related Art

Since an organic light-emitting element is a self-emitting element, the organic light-emitting element does not need a backlight required in a liquid crystal display device and has a wide view angle. Because of these advantages, the organic light-emitting element is promising as a display device in the next generation.

A sectional view of an element structure of a general organic light-emitting element is shown in FIG. 1. In the element structure, an organic layer 12 is sandwiched by a cathode 11 and an anode 13. When a CD power supply 14 is connected to the organic light-emitting element, holes and electrons are injected into the organic layer 12 from the anode 13 and the cathode 11, respectively. The injected holes and electrons are moved to the counter electrodes in the organic layer 12 by an electric field formed by the power supply 14. During the movement, the electrons and the holes are recombined in the organic layer 12 to generate excitons. Light emission is observed in a process in which energy of the excitons are deactivated. An emitted light color is different depending on energy of the excitons. In general, emitted light has a wavelength of energy corresponding to a value of an energy band gap of the organic layer 12.

In order to extract light generated in an organic layer, a material transparent in a visible light area is used for at least one of electrodes. A material having a low work function is used for a cathode to facilitate electron injection into the organic layer. For example, the material is aluminum, magnesium, or calcium. For durability and a lower work function, a material such as an alloy of these materials or an aluminum-lithium alloy may be used.

On the other hand, a material having large ionization potential is used for an anode because of easiness of hole injection. Since the cathode does not have transparency, a transparent material is often used for this electrode. Therefore, in general, ITO (Indium Tin Oxide), gold, indium zinc oxide (IZO), or the like is used.

In recent years, in the organic light-emitting element formed by using a low molecular material, in order to increase light emission efficiency, the organic layer 12 may be formed by plural layers. Consequently, functions of carrier injection, carrier movement to a light-emitting area, and emission of light having a desired wavelength can be divided among the respective layers. An organic light-emitting element having higher efficiency can be formed by using materials having high efficiency for the respective layers.

In the organic light-emitting element formed in this way, luminance is proportional to an electric current as shown in FIG. 2A and is in a nonlinear relation with a voltage as shown in FIG. 2B. Therefore, it is advisable to perform gradation control according to a current value.

In the case of the active matrix display device, there are two driving systems, a voltage driving system and a current driving system.

The voltage driving system is a method of using a source driver of a voltage output type, converting a voltage into an electric current in pixels, and supplying the electric current converted from the voltage to an organic light-emitting element.

In this method, since the voltage to current conversion is performed by a transistor provided for each of the pixels, fluctuation occurs in an output current and luminance unevenness is caused according to fluctuation in a characteristic of the transistor.

The current driving system is a method of using a source driver of a current output type, giving only a function of holding a current value outputted in one horizontal scanning period in pixels, and supplying a current value same as that of the source driver to an organic light-emitting element (see, for example, Japanese Patent Laid-Open No. 2004-271646 and Japanese Patent Laid-Open No. 2006-154302).

The entire disclosure of the documents described above is incorporated herein by reference in its entirety.

An example of the current driving system is shown in FIG. 3. In the system in FIG. 3, a current copier system is used for a pixel circuit.

The circuit during operation of a pixel 37 in FIG. 3 is shown in FIGS. 4A and 4B.

When the pixel is selected, as shown in FIG. 4A, a signal is inputted to a gate signal line 31a in a row of the pixel from a gate driver 35 to bring a switch into a conduction state. A signal is inputted to a gate signal line 31b to bring the switch into a non-conduction state. A state of the pixel circuit at this point is shown in FIG. 4A. An electric current flowing to a source signal line 30, which is an electric current drawn into a source driver 36, flows through a path indicated by a dotted line 41. Thus, an electric current identical with the electric current flowing to the source signal line 30 flows to a driving transistor 32. Then, a potential at a node 42 changes to a potential corresponding to a current-voltage characteristic of the driving transistor 32.

When the pixel changes to an unselected state, a circuit shown in FIG. 4B is formed by the gate signal line 31. An electric current flows from an EL power supply line 34 to an organic light-emitting element 33 through a path of a dotted line indicated by 43. This electric current depends on the potential at the node 42 and the current-voltage characteristic of the driving transistor 32.

The potential at the node 42 does not change in FIGS. 4A and 4B. Therefore, a drain current flowing to the identical driving transistor 32 is identical in FIGS. 4A and 4B. Consequently, an electric current having a value same as the value of the electric current flowing to the source signal line 30 flows to the organic light-emitting element 33. Even if there is fluctuation in the current-voltage characteristic of the driving transistor 32, values of the electric currents 41 and 43 are not affected in principle. Therefore, uniform display not affected by fluctuation in a characteristic of a transistor can be realized.

Therefore, it is necessary to use the current driving system in order to obtain the uniform display. For that purpose, the source driver 36 has to be a driver IC of a current output type.

An example of an output stage of a current driver IC that outputs a current value corresponding to a gradation is shown in FIG. 6. An analog current output to display gradation data 54 is performed by a digital-analog conversion section 66 as indicated by 64. The digital-analog conversion section 66 includes plural (at least the number of bits of the display gradation data 54) current sources for gradation display 63 and switches 68 and a common gate line 67 that defines a current value fed by one of the current sources for gradation display 63.

In FIG. 6, an analog current is outputted to the 4-bit input 54. It is selected by the switches 68 whether current sources for gradation display 63 in a number corresponding to a weight of bits are connected to the current output 64. Thus, an electric current corresponding to a gradation can be outputted. For example, in the case of data 1, an electric current of one current source for gradation display 63 is outputted and, in the case of data 7, electric currents of seven current sources 63 are outputted. It is possible to realize a current output type driver by arranging the digital-analog conversion sections 66 in a number corresponding to the number of outputs of a driver. A voltage of the common gate line 67 for compensating for a temperature characteristic of transistors used in the current sources for gradation display 63 depends on a mirror transistor for distribution 62. The transistor for distribution 62 and the current sources for gradation display 63 are formed in a current mirror structure. An electric current per one gradation is determined according to a value of a reference current 99. With this structure, an output current changes according to a gradation and an electric current per one gradation depends on a reference current.

Besides the gradation display according to a difference in the number of the current sources for gradation display 63, gradation display can also be realized by a method of uniting the plural current sources 63, drain electrodes of which are connected to the identical switch 68, into one current source in FIG. 6 and a method of forming the current sources 63 by changing a channel size ratio thereof such that an electric current flowing via the switches 68 does not change. (In this case, the current sources 63 include at least four transistors.)

Gradation display may be carried out by combining a current change according to the number of transistors of the current sources 63 and a current change according to a change in a channel size ratio.

A value of the reference current 99 depends on a resistance of a resistance element 60 and a power supply voltage of a power supply 69. Since a reference current for determining an electric current per one gradation is generated by a circuit including the resistance element 60, the mirror transistor for distribution 62, and the power supply 69, the circuit is set as a reference-current generating section 61.

However, in the display device in the past, display unevenness occurs in display performed by using the organic light-emitting element.

The inventor has noticed that such display unevenness is particularly conspicuous in black display and analyzed that a reason for the display unevenness is fluctuation in a TFT characteristic as explained below.

When a pixel circuit is formed by a low-temperature polysilicon TFT, there is a process of polycrystallizing amorphous silicon with laser annealing.

In the process, as shown in FIG. 47, rather than annealing an entire display area at a time, a laser is irradiated in a line shape and an irradiated area is polycrystallized as indicated by 471. To irradiate the laser over an entire screen, the area 471 is moved to gradually scan the screen as indicated by an arrow, the entire screen is polycrystallized, and a low-temperature polysilicon TFT is formed.

In forming the low-temperature polysilicon TFT, fluctuation occurs in a state of polycrystallization because of fluctuation in the intensity of the laser and fluctuation occurs in mobility of the TFT and a threshold voltage. The fluctuation in the intensity of the laser is substantially affected by temporal fluctuation. Areas on which the laser is irradiated at timing when the intensity is high and areas on which the laser is irradiated at timing when the intensity is low are distributed in a shape of the area 471.

As a result, a difference in laser intensity occurs in pixels indicated by 472, 473, and 474 in FIG. 47. As shown in FIG. 48, a difference occurs in voltage-current characteristics of source signal lines 482 to 484 because of the fluctuation in a characteristic of the driving transistor 32 in the pixel circuit 37.

When gradation 0 display is performed by voltage pre-charge, fluctuation occurs in an electric current flowing to pixels in a row including the pixels 472 to 474 (i.e., an electric current flowing to an EL element) depending on the pixels as indicated by 491 in FIG. 49. In this example, a minimum current of 10 MIN and a maximum current of 10 MAX flow.

The luminance of the EL element is affected by a difference in this current value. Pixels to which the current 10 MAX flows emit light brightly compared with pixels around the pixels. When this luminance difference is visually recognized as unevenness, a display quality is deteriorated.

### SUMMARY OF THE INVENTION

The present invention has been devised in view of the problems and it is an object of the present invention to provide an active matrix display device that can prevent display unevenness from occurring in display performed by using an organic light-emitting element, and a method of driving an active matrix display device using organic light-emitting element.

The first aspect of the present invention is an active matrix display device using an organic light-emitting element comprising a pixel having the organic light-emitting element; a driving transistor that determines an electric current flowing to the organic light-emitting element according to a gate voltage; a storing unit; and a voltage output unit that supplies a voltage to the pixel, wherein a voltage output from the voltage output unit varies depending on data in the storing unit.

The second aspect of the present invention is the active matrix display device using an organic light-emitting element according to the first aspect of the present invention, further comprising a voltage detecting unit which detects at least one of a gate voltage of the driving transistor, a drain voltage of the driving transistor, and an output voltage from the voltage output unit.

The third aspect of the present invention is the active matrix display device using an organic light-emitting element according to the second aspect of the present invention, wherein the voltage detecting unit is formed in a driver unit including the voltage output unit.

The fourth aspect of the present invention is the active matrix display device using an organic light-emitting element according to the second aspect of the present invention, wherein the voltage detecting unit is provided in an array substrate on which the pixel is arrayed.

The fifth aspect of the present invention is the active matrix display device using an organic light-emitting element according to the second aspect of the present invention, wherein the gate voltage of the driving transistor or the drain voltage of the driving transistor is a voltage taken when a first electric current is flown to the driving transistor.

The sixth aspect of the present invention is the active matrix display device using an organic light-emitting element according to the second aspect of the present invention, wherein the gate voltage of the driving transistor or the drain voltage of the driving transistor is a voltage taken when a drain current at a first input gradation is flown to the driving transistor.

The seventh aspect of the present invention is the active matrix display device using an organic light-emitting element according to the second aspect of the present invention, wherein the output voltage from the voltage output unit is a voltage at a second input gradation.

The eighth aspect of the present invention is the active matrix display device using an organic light-emitting element according to the first aspect of the present invention, wherein the storing unit retains correction data generated on the basis of at least one of a gate voltage of the driving transistor, a drain voltage of the driving transistor, and an output voltage from the voltage output unit.

The ninth aspect of the present invention is the active matrix display device using an organic light-emitting element according to the eighth aspect of the present invention, further comprising a voltage detecting unit which detects at least one of a gate voltage of the driving transistor, a drain voltage of the driving transistor, and an output voltage from the voltage output unit, wherein a voltage is detected by using the voltage detecting unit.

The tenth aspect of the present invention is the active matrix display device using an organic light-emitting element according to the eighth aspect of the present invention, wherein the gate voltage of the driving transistor or the drain voltage of the driving transistor is a gate voltage of the driving transistor or a drain voltage of the driving transistor for a fourth gradation input different from second and third gradation inputs, wherein a gate voltage of the driving transistor or a drain voltage of the driving transistor is measured with respect to the second gradation input and the third gradation input different from the second gradation input, respectively, and the gate or drain voltage for the fourth gradation input is calculated based on, with regard to the pixel in the same position, the gate voltage of the driving transistor or the drain voltage of the driving transistor corresponding to the second gradation input and the gate voltage of the driving transistor or the drain voltage of the driving transistor corresponding to the third gradation input.

The eleventh aspect of the present invention is the active matrix display device using an organic light-emitting element according to the eighth aspect of the present invention, wherein a potential difference per one gradation in the voltage output unit is calculated based on an output at a fifth gradation input in the voltage output unit and an output at a sixth gradation input different from the fifth gradation input in the voltage output unit, and wherein the voltage is sampled according to the calculated potential difference and retained.

The twelfth aspect of the present invention is the active matrix display device using an organic light-emitting element according to the eighth aspect of the present invention, wherein two or more pieces of the correction data are retained with regard to the pixel in the same position, and the respective retained correction data is a voltage for a different input.

The thirteenth aspect of the present invention is the active matrix display device using an organic light-emitting element according to the eighth aspect of the present invention, wherein the correction data is formed for each of the pixel.

The fourteenth aspect of the present invention is the active matrix display device using an organic light-emitting element according to the first aspect of the present invention, further comprising an electronic volume for adjusting a voltage applied to the pixel, wherein a luminance during black display is adjusted by adjusting the electronic volume, and a value of the electronic volume at a predetermined black luminance is retained in the storing unit.

The fifteenth aspect of the present invention is the active matrix display device using an organic light-emitting element according to the first aspect of the present invention, further comprising a voltage output unit that performs D/A conversion using gradation data inputted to perform display corresponding to display gradations and correction data stored by the storing unit.

The sixteenth aspect of the present invention is the active matrix display device using an organic light-emitting element according to the fifteenth aspect of the present invention, wherein the voltage output unit outputs linear outputs and performs the D/A conversion by adding up the inputted gradation data and the stored correction data.

The seventeenth aspect of the present invention is the active matrix display device using an organic light-emitting element according to the fifteenth aspect of the present invention, wherein when two or more pieces of the correction data exist with regard to the pixel in the same position and forms a correction data group, the correction data closest to the inputted gradation data in terms of a measurement condition is used from within the correction data group to perform the D/A conversion.

The eighteenth aspect of the present invention is the active matrix display device using an organic light-emitting element according to the fifteenth aspect of the present invention, wherein when two or more pieces of the correction data exist for the pixel in the same position and forms a correction data group, third correction data corresponding to the inputted gradation data is calculated based on two first and second correction data, the first being the data closest to the inputted gradation data in terms of a measurement condition from within the correction data group and the second being the next closest data, and the third correction data and the inputted gradation data are used in the D/A conversion to determine an output of the voltage output unit.

The nineteenth aspect of the present invention is a method of driving the active matrix display device using an organic light-emitting element of the first aspect of the present invention, wherein there is a duration during which the voltage output unit performs output.

The twentieth aspect of the present invention is the method of driving the active matrix display device using an organic light-emitting element according to the nineteenth aspect of the present invention, wherein the pixel has a pixel structure corresponding to a current driving system, and the voltage is applied by the voltage output unit to the pixel in a voltage pre-charge period in the current driving system on the basis of gradation data inputted to perform display corresponding to display gradations and compensation data stored by the storing unit.

The twenty-first aspect of the present invention is the method of driving the active matrix display device using an organic light-emitting element according to the nineteenth aspect of the present invention, wherein the voltage is applied by the voltage output unit to the pixel in a signal writing period on the basis of compensation data stored by the storing unit.

The twenty-second aspect of the present invention is the active matrix display device using an organic light-emitting element according to the first aspect of the present invention, further comprising an AD converting unit that performs A/D conversion in order to perform measurement of a voltage applied to the pixel during operation; and a voltage control unit that performs control of a voltage applied to the pixel according to a result of the measurement.

The twenty-third aspect of the present invention is the active matrix display device using an organic light-emitting element according to the twenty-second aspect of the present invention, wherein the voltage control unit performs control of the voltage according to a result of comparison between a result of the measurement and compensation data stored by the storing unit.

The twenty-fourth aspect of the present invention is the active matrix display device using an organic light-emitting element according to the twenty-third aspect of the present invention, wherein the voltage control unit performs control of the voltage taking into account ambient temperature.

The twenty-fifth aspect of the present invention is the active matrix display device using an organic light-emitting element according to the twenty-third aspect of the present invention, wherein the voltage control unit performs control of the voltage taking into account elapsed time after a power supply is turned on.

According to the present invention, it is possible to prevent display unevenness from occurring in display performed by using an organic light-emitting element.

### BRIEF DESCRIPTION OF THE DRAWINGS

FIG. 1 is a diagram showing the structure of an organic light-emitting element in the past;

FIGS. 2A and 2B are graphs showing a current-voltage-luminance characteristic of the organic light-emitting element in the past;

FIG. 3 is a diagram showing a circuit of an active matrix display device in the past in which a pixel circuit of a current copier structure is used;

FIGS. 4A and 4B are diagrams showing operations of a current copier circuit in the past;

FIG. 5 is a diagram showing a circuit configuration of a current mirror according to an embodiment of the present invention;

FIG. 6 is a diagram showing a circuit in the past for outputting an electric current to respective outputs of a current output type driver;

FIG. 7 is a graph showing light-emitting efficiency of an organic light-emitting element for each of display colors according to the embodiment;

FIG. 8 is a diagram for explaining preparation of an individual current output circuit for each of display colors according to the embodiment;

FIG. 9 is a diagram showing an example of the structure of a reference-current generating section according to the embodiment;

FIG. 10 is a diagram for explaining a method of adjusting an output current according to the embodiment;

FIG. 11 is a diagram showing a display pattern for explaining a problem during current driving according to the embodiment;

FIG. 12 is a diagram showing a display pattern for explaining the problem during current driving according to the embodiment;

FIG. 13 is a diagram showing a temporal change in an electric current in a source signal line according to the embodiment;

FIG. 14 is a diagram showing a temporal change in a potential in the source signal line according to the embodiment;

FIG. 15A is a diagram showing an equalizing circuit at the time when a source signal line current flows to a pixel according to the embodiment;

FIG. 15B is a current-voltage characteristic diagram of a transistor according to the embodiment;

FIG. 16 is a diagram showing a relation of a current output in one output terminal to a pre-charge voltage applying section and a changeover switch according to the embodiment;

FIG. 17 is a diagram showing a relation among a pre-charge pulse, a pre-charge judging signal, and an application judging section output according to the embodiment;

FIG. 18 is a diagram showing a temporal change in an electric current in the source signal line at the time when current pre-charge is performed according to the embodiment;

FIG. 19 is a diagram showing a temporal change in a source driver output at the time when an electric current ten times as large as a predetermined current is outputted in the beginning of a horizontal scanning period according to the embodiment;

FIG. 20 is a diagram showing a state of a change in a source signal line current at the time when current pre-charge is performed according to the embodiment;

FIG. 21 is a sequence chart during implementation of current pre-charge in one horizontal scanning period according to the embodiment;

FIG. 22 is a diagram showing a temporal change in a source signal line current during implementation of current pre-charge according to the embodiment;

FIG. 23 is a diagram showing a state of a source signal line change at the time when current pre-charge is performed in a first row according to the embodiment;

FIG. 24 is a diagram showing comparison of source signal line potentials according to time in which voltage pre-charge is performed according to the embodiment;

FIG. 25 is a diagram showing a circuit of a current output section 255 having a function of performing current pre-charge according to the embodiment;

FIG. 26 is a diagram showing a relation between input and output signals of a pulse selecting section 252 according to the embodiment;

FIG. 27 is a diagram showing temporal changes in a pre-charge pulse group, a pre-charge judgment line, and an output according to the embodiment;

FIG. 28 is a table showing correspondence between respective gradations and pre-charge pulses in use according to the embodiment;

FIG. 29 is a table showing a relation between a display gradation and a necessary pre-charge current output period according to the embodiment;

FIG. 30 is a diagram showing a temporal change in a source signal line current at the time when a current pre-charge pulse 256d is selected according to the embodiment;

FIG. 31 is a diagram showing a circuit configuration of a pulse generating section that outputs a different current pre-charge period for each of emitted light colors according to the embodiment;

FIG. 32 is a diagram showing a circuit configuration for performing voltage pre-charge according to the embodiment;

FIG. 33 is a diagram showing a circuit configuration for adjusting a black luminance according to the embodiment;

FIG. 34 is a diagram showing an adjusting method during black adjustment according to the embodiment;

FIG. 35 is a diagram showing a temporal change in a source signal line current according to the embodiment;

FIG. 36 is a diagram showing a temporal change in a source signal line current according to the embodiment;

FIG. 37 is a diagram for explaining a method of judging whether pre-charge should be performed according to the embodiment;

FIG. 38 is a diagram showing a correspondence relation between a writing current in an immediately preceding row and a writing current at the time when 255 gradations are an electric current of 1 μA, the number of pixels is QCIF+, and a capacity of a source signal line is 10 pF;

FIG. 39 is a diagram showing a temporal change in a source signal line current during the judgment processing in FIG. 37 according to the embodiment;

FIG. 40 is a diagram showing a circuit configuration for inserting a gradation 0 in a video signal and outputting a specific signal in a pre-charge judgment signal generating section in a vertical blanking period according to the embodiment;

FIG. 41 is a table showing a relation between a pre-charge operation and a pre-charge judgment signal according to the embodiment;

FIG. 42 is a diagram showing a circuit configuration of a display device incorporating a source driver and a control IC according to the embodiment;

FIG. 43 is a diagram for explaining a method of serially transferring data of one pixel at an N-fold clock frequency according to the embodiment;

FIG. 44 is a diagram showing a circuit configuration of a source driver that carries out current and voltage pre-charge according to the embodiment;

FIG. 45 is a diagram showing a reference current generating section according to the embodiment;

FIG. 46 is a diagram showing a pixel circuit formed by using a current copier at the time when an n-type transistor is used according to the embodiment;

FIG. 47 is a diagram showing a relation between a display panel and a laser annealing operation according to the embodiment;

FIG. 48 is a graph indicating that a relation between a source signal line current and a source signal line voltage is difference depending on a pixel according to the embodiment;

FIG. 49 is a diagram showing a distribution of output currents with respect to an identical pre-charge voltage input according to the embodiment;

FIG. 50A is a diagram showing the distribution of a current flowing to a pixel having characteristics shown in FIGS. 47 to 49 with respect to the output voltage distribution in FIG. 50B according to the embodiment, and FIG. 50B is a diagram showing the distribution of an output voltage applied to a gate electrode of a driving transistor in the case of the output current distribution in FIG. 49 according to the embodiment;

FIG. 51 is a diagram showing a pre-charge voltage generating section that supplies plural voltages according to the embodiment;

FIG. 52 is a diagram showing an output stage of a source driver that supplies plural pre-charge voltages according to the embodiment;

FIG. 53 is a diagram showing the source driver that supplies plural pre-charge voltages according to the embodiment;

FIG. 54 is a diagram showing a circuit configuration that detects a source signal line voltage at the time when a current of a certain value is fed according to the embodiment;

FIG. 55 is a graph indicating that a source signal line voltage during gradation 0 display can be calculated from current-voltage characteristics at another two points according to the embodiment;

FIG. 56 is a diagram showing a flow of voltage calculation for supplying appropriate pre-charge voltages to respective pixels according to the embodiment;

FIG. 57A is a diagram showing the distribution of a current flowing to a pixel having characteristics shown in FIGS. 47 to 49 with respect to the output voltage distribution in FIG. 57B according to the embodiment, and FIG. 57B is a diagram showing a voltage applied to a gate electrode of a driving transistor using the pre-charge voltage generating section shown in FIG. 51 in the case of the output current distribution in FIG. 49 according to the embodiment;

FIG. 58 is a diagram showing fluctuation in a size of a transistor and an output current according to the embodiment;

FIG. 59 is a diagram showing a display device applied to a television according to the embodiment;

FIG. 60 is a diagram showing a display device applied to a digital camera according to the embodiment;

FIG. 61 is a diagram showing a display device applied to a portable information terminal according to the embodiment;

FIG. 62 is a diagram showing an internal structure of the source driver for detecting a source signal line voltage using the source driver according to the embodiment;

FIG. 63 is a diagram showing temporal changes in respective signal lines at the time when a voltage value is read out using FIG. 62 according to the embodiment;

FIG. 64 is a diagram showing a circuit configuration of an apparatus for reading out a gate voltage value of a driving transistor of a pixel according to the embodiment;

FIG. 65 is a diagram showing an adjustment method for defining a pre-charge selection voltage for black display and maximum and minimum voltages according to the embodiment;

FIG. 66 is a diagram showing a voltage distribution in an identical signal line including a defective pixel at the time when amorphous silicon is polycrystallized by the methods in FIG. 47;

FIGS. 67A and 67B are diagrams showing a relation between a distribution of a pixel voltage value and a distribution of a pre-charge voltage in the source driver according to the embodiment;

FIG. 68 is a diagram showing a result of an interpolation calculation of intermediate terminals at the time when a pre-charge voltage selection signal is given for every several outputs according to the embodiment;

FIG. 69A is a diagram showing an example of adjusting a pre-charge voltage (before adjustment) for settling a current in a predetermined range during black display according to the embodiment, and FIG. 69B is a diagram showing an example of adjusting a pre-charge voltage (after adjustment) for settling a current in a predetermined range during black display according to the embodiment;

FIG. 70 is a diagram showing a relation among a storing unit which corrects a voltage output for each of pixels, a control section, and a driver section, which becomes available after a storing section is provided, according to the embodiment;

FIG. 71 is a diagram showing a circuit block with voltage fluctuation correction for each of pixels at the time when a RAM area is provided in the driver section;

FIG. 72 is a diagram showing the structure of an output stage of the driver section in FIG. 70;

FIG. 73 is a diagram showing a flow of processing from detection of fluctuation in a transistor from an electric current written in a pixel until writing of fluctuation data in a ROM;

FIG. 74 is a diagram showing a circuit configuration from a video signal input to one output in a driver IC capable of performing gradation display with a voltage and an electric current according to the embodiment;

FIG. 75 is a diagram showing a relation between input data and an output voltage in a voltage DAC section according to the embodiment;

FIG. 76 is a diagram showing a flow of one output of a driver IC capable of performing voltage and current output at the time when a voltage characteristic for each of pixels is stored in the ROM with respect to all gradations according to the embodiment;

FIG. 77 is a diagram showing a flow of one output of the driver IC capable of performing voltage and current output at the time when a voltage characteristic for each of pixels is stored in the ROM with respect to plural gradations according to the embodiment;

FIG. 78 is a diagram showing a flow of one output of the driver IC capable of performing voltage and current output at the time when a voltage characteristic for each of pixels is stored in the ROM with respect to plural gradations according to the embodiment;

FIG. 79 is a diagram showing a pixel circuit with a threshold correcting function according to the embodiment;

FIG. 80 is a diagram showing an operation for writing a gradation corresponding to a video signal in the pixel circuit in FIG. 79 according to the embodiment;

FIG. 81 is a diagram showing an operation during lighting in the pixel circuit in FIG. 79 according to the embodiment;

FIG. 82 is a diagram showing an operation at the time when a gate voltage of a driving transistor for each of pixels is measured in the pixel circuit in FIG. 79 according to the embodiment;

FIG. 83 is a diagram at the time when the pixel circuit in FIG. 79 is reset according to the embodiment;

FIG. 84 is a diagram showing an output section of a driver in which a voltage DAC and a current DAC are formed for one output according to the embodiment;

FIG. 85 is a diagram showing a pixel obtained by adding a function of correcting mobility fluctuation to an offset cancel pixel and a peripheral circuit according to the embodiment;

FIG. 86 is a diagram showing a gate signal line operation in FIG. 85 according to the embodiment;

FIG. 87 is a diagram showing a circuit operation at the time when a constant current is supplied to a pixel in order to measure voltage fluctuation in the structure in FIG. 85 according to the embodiment;

FIG. 88 is a diagram showing respective signal waveforms for measuring a gate voltage with respect to a predetermined current in the structure in FIG. 85 according to the embodiment;

FIG. 89 is a diagram showing a driver output stage in the structure in FIG. 85 according to the embodiment;

FIG. 90 is a diagram showing a current applying method of a circuit having a pixel structure identical with that in FIG. 85 in which a current source is formed in a driver IC according to the embodiment;

FIG. 91 is a diagram showing a driver output stage in FIG. 90 according to the embodiment;

FIG. 92 is a graph indicating that an output voltage is different for each of pixels even at an identical gradation according to the embodiment;

FIG. 93 is a graph showing an example of fluctuation in an output voltage with respect to a gradation at the time when pixel potentials are read out at three points and a corrected voltage is calculated according to the embodiment;

FIG. 94 is a diagram for explaining a method of reading out voltages of all pixels in the driver IC in FIG. 84 and the pixel circuit in FIG. 3 according to the embodiment;

FIG. 95 is a diagram showing the structure of a panel with a characteristic fluctuation compensating function and a circuit of a driving transistor according to the embodiment;

FIG. 96 is a diagram showing the structure of a voltage generating section according to the embodiment;

FIG. 97 is a diagram showing the structure of a current writing path at the time when pixel readout is performed and an AD conversion section to which a pixel voltage is inputted according to the embodiment;

FIG. 98 is a diagram showing the structure of a display device in which a readout section is provided separately from a driver section according to the embodiment;

FIG. 99 is a diagram for explaining a method of inspection voltage application at the time when the readout section is used for an inspection according to the embodiment;

FIG. 100 is a diagram showing a circuit in which a voltage of a read-out pixel can be captured and fed back to the voltage generating section according to the embodiment;

FIG. 101 is a diagram showing a correction method during temperature characteristic correction according to the embodiment;

FIG. 102 is a diagram showing a flow of a method of creating room temperature data and creation of storage data in the ROM during temperature characteristic correction according to the embodiment;

FIG. 103 is a diagram showing the structure of the voltage generating section at the time when the number of voltage outputs is curtailed according to the embodiment; and

FIG. 104 is a diagram showing an input and output relation of a voltage DAC section at the time when the voltage generating section in FIG. 103 is used according to the embodiment.

FIG. 105 is a diagram showing an operation of a gate signal line for determining whether a current is supplied to the organic light-emitting element when providing a display with black insertion;

FIG. 106 is a diagram showing a structure of the voltage generating section; and

FIG. 107 is a diagram showing an input and output relation of a voltage DAC section.

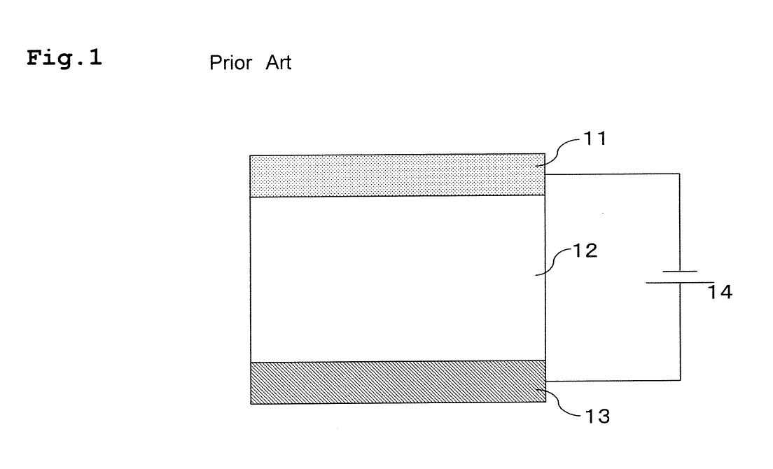

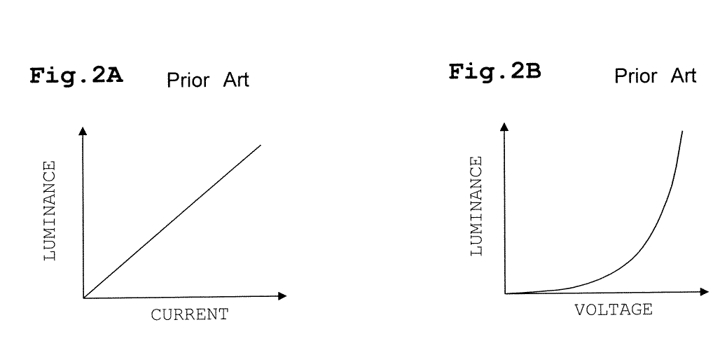

### DESCRIPTION OF SYMBOLS

11 Cathode
12 Organic layer
13 Anode
14 Power supply
28 Control IC
30, 30a, 30b, 30c Source signal lines
31a, 31b Gate signal lines
32 Driving transistor
33 Organic light-emitting element
34 EL power supply line
35 Gate driver
36 Driver IC (Source driver)
37 Pixel
39a, 39b, 62, 491 Transistors
54 Gradation data
60 Resistance element
61, 61a, 61b, 61c Reference-current generating sections
62 Mirror transistor for distribution
63 Display current source for gradation
64 Current output
65 Current output circuit
66 Digital to analog conversion section
67 Common gate line
68 Switch
91 Resistor
92 Operational amplifier
93 Transistor
94 Resistor
95 Voltage adjusting section
96 Power supply line
97 Switching unit (Switch)
98 Electronic volume
99 Reference current line
111, 112 Display areas
169 Application judging section
151 Stray capacitance
152 Current source
252 Pulse selecting section
253a, 253d, 253f Voltage-application selecting sections
255a, 255b Current output sections
256 Current pre-charge pulse group
258 Voltage pre-charge pulse
311 Timing pulse
313 Dividing circuit
314 Source driver clock (Clock)
317 Counter
319 Pulse generating section
323 Pre-charge voltage generating section
324 Electronic volume
330 EL cathode power supply
333 Control device
337 Storing unit
381, 382 Areas
384 Latch section
323 Pre-charge voltage generating section
402 Black-data inserting section
403 Gamma correction circuit
406 Pre-charge flag
420 Start pulse
421 Power supply control line
422 ROM
423 Synchronization signal
424 Video signal
425 Power supply line (Battery output, etc.)
426 Power supply circuit
427 Gate line
428 Gate driver control line
429 Video signal line
430 Shift direction control
471, 472, 531, 551 Selectors
473 Display data
474 Reference current line
475 Display color switching signal
491 Transistor
511 Gate signal enable circuit
514 Decode section
541 Pulse generating section
601 Main body
602 Photographing section
603 Shutter switch
604 Finder
605, 614 Display panel
611 Antenna
612 Key
613 Housing

### DETAILED DESCRIPTION OF THE PREFERRED EMBODIMENTS

Embodiments of the present invention will be hereinafter explained with reference to the accompanying drawings.

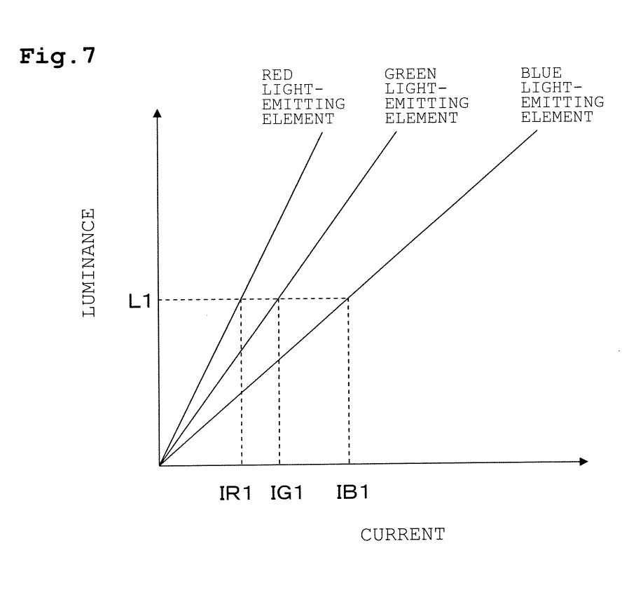

When a pixel is formed using different materials for the three primary colors, respectively, in a display device in which a color organic light-emitting element is used, as shown in FIG. 7, light-emitting efficiency is different for each of display colors and, depending on chromaticities of respective light-emitting colors, electric currents of the respective display colors during white display have different values. Thus, it is necessary to individually set an electric current for one gradation.

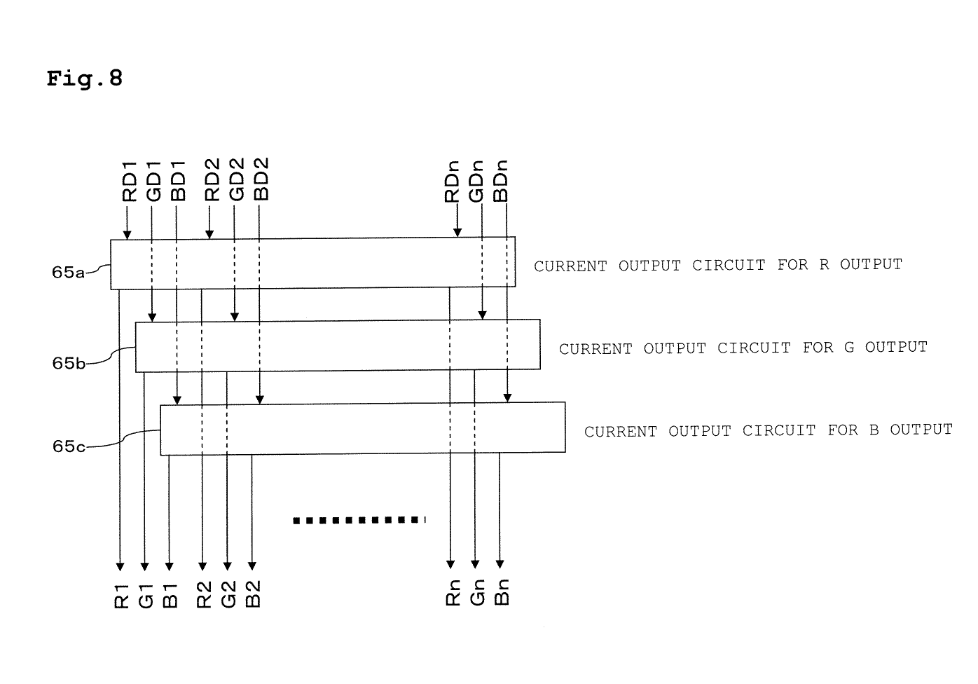

Therefore, as shown in FIG. 8, a current output circuit 65 including a reference-current generating section 61 is individually prepared for each of the display colors. Even if a light emitting material used for a display device is changed, it is possible to set panel luminance and chromaticity to target values by changing and using a value of a resistance element 60.

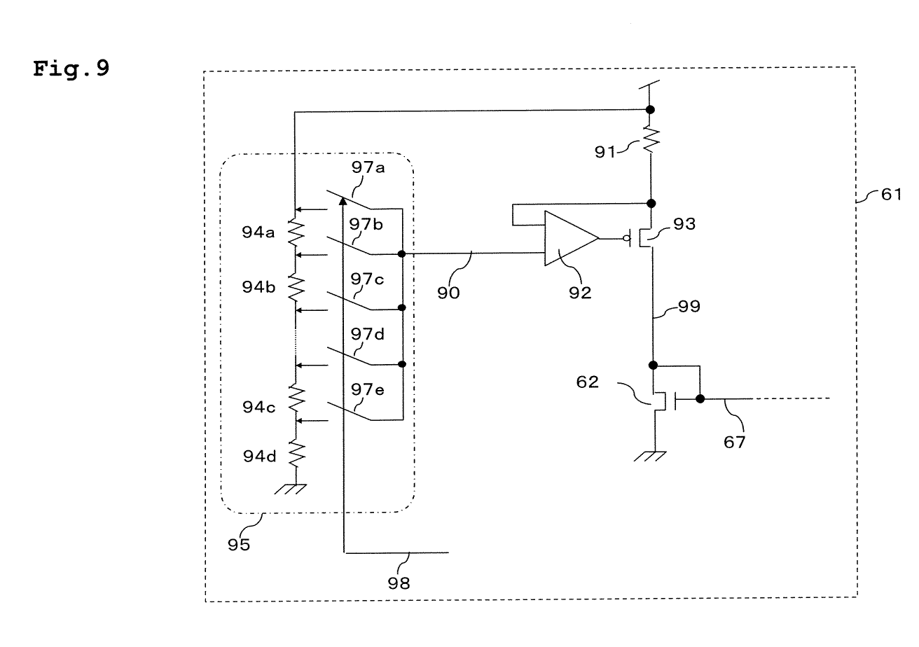

Fluctuation in light emitting efficiency for each color of the light-emitting material affects white chromaticity and a white color looks different for each of panels. To cope with this problem, as shown in FIG. 9, in the reference-current generating section 61, a circuit including an electronic volume and a constant current source is provided instead of the resistance element 60, a value of control data 98 is changed according to light emitting efficiency, and a reference current is changed to adjust an output current value. This makes it possible to adjust luminance to be within a fixed range. It is also possible to adjust chromaticity to be in a fixed range. The control data 98 is referred to as reference current electronic volume.

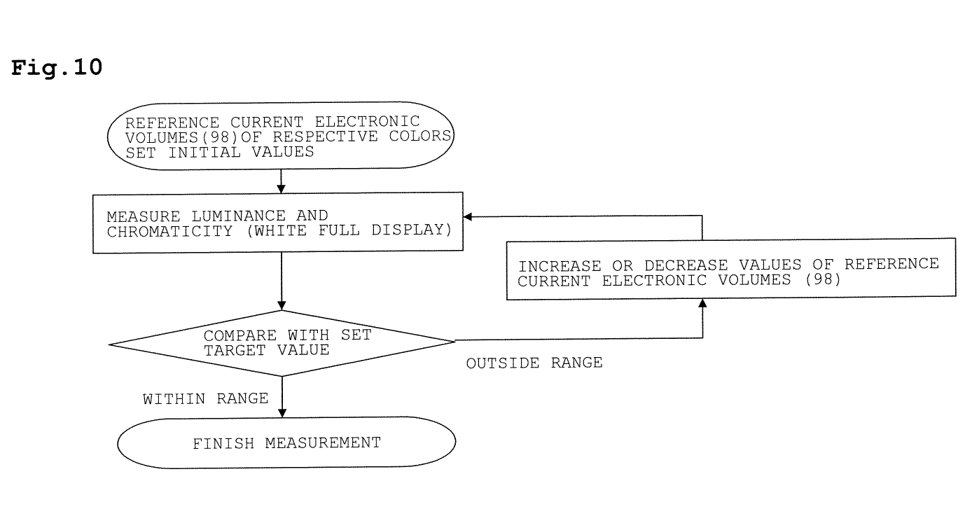

A method for the adjustment is shown in FIG. 10.

Full white display is performed according to an initial value of a reference current electronic volume calculated from assumed light-emitting efficiency. At this point, luminance and chromaticity measurement is carried out. When measurement data is within a range of a design specification of a panel, this initial value is determined as an electronic volume. When the measurement data is out of the range, the measurement data is compared with a set value, values of reference current electronic volumes 98 of respective colors are increased or decreased, and white display is performed to measure luminance and chromaticity again. This operation is repeatedly carried out until the luminance and the chromaticity fall within the design ranges. Finally, an appropriate value of the reference current electronic volume 98 is determined for each of the panels.

As an interval width of a voltage adjusting section 95 for an electronic volume is finer, fine adjusting for a reference current value is more effective and it is possible to set a voltage to a value closer to a target value. As a margin between a maximum value and a minimum value is larger, it is possible to more accurately adjust a voltage to a value as designed even if fluctuation in light emission efficiency is large. However, if the voltage adjusting section 95 is designed to satisfy this condition, a circuit size thereof increases. As a result, an area of the driver IC 36 is increased to cause an increase in cost. Therefore, it is practically desirable to set an adjustment range to about two times at the maximum (set fluctuation in light emission efficiency within two times), set an interval width as a current change of 1%, and constitute the voltage adjusting section 95 with a 6-bit electronic volume. Consequently, fluctuation in chromaticity for each of the panels can be set to be equal to or lower than ±0.005 for both x and y.

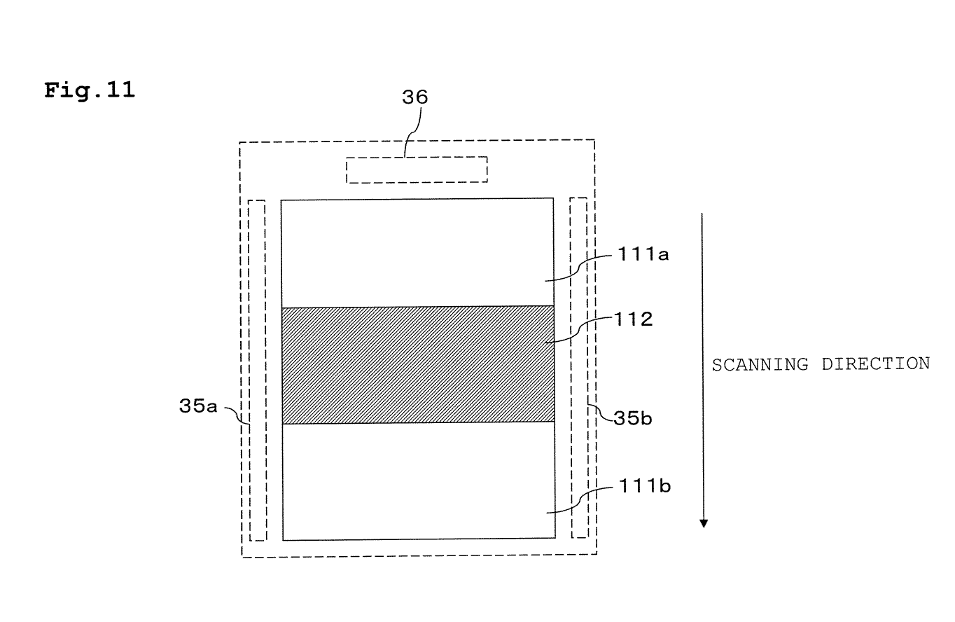

As a problem during current driving, when an area 111 has a gradation equal to or lower than a half tone and equal to or higher than a ¼ tone and low gradation display is carried out in an area 112 in a display pattern shown in FIG. 11, a phenomenon in which boundaries of the areas are blurred occurs.

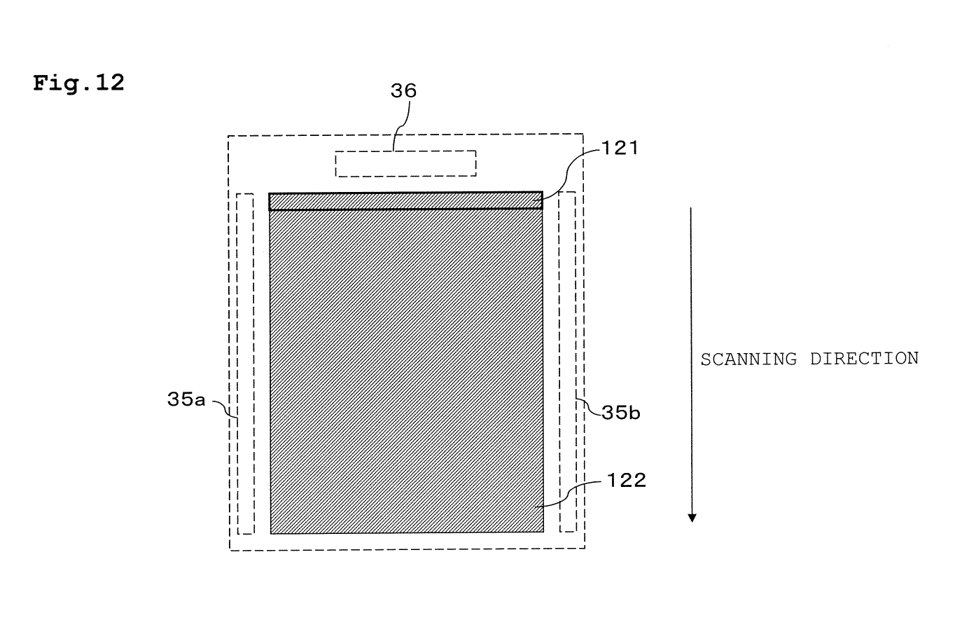

When low gradation display is performed over the entire screen as shown in FIG. 12, a phenomenon in which the luminance of a first row of display (an area 121) is higher than that of other rows occurs.

This is because a writing current in respective pixels is small (about 10 nA), it is difficult to charge and discharge a stray capacitance of a source signal line with the writing current, and a current value thereof cannot be changed to a predetermined current value in one horizontal scanning period.

These phenomena are known from a document Proc. EuroDisplay2002 pp. 855 to 858 and the like.

The entire disclosure of the document is incorporated herein by reference in its entirety.

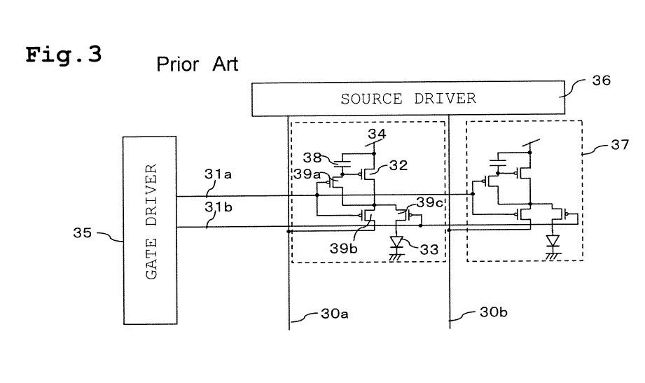

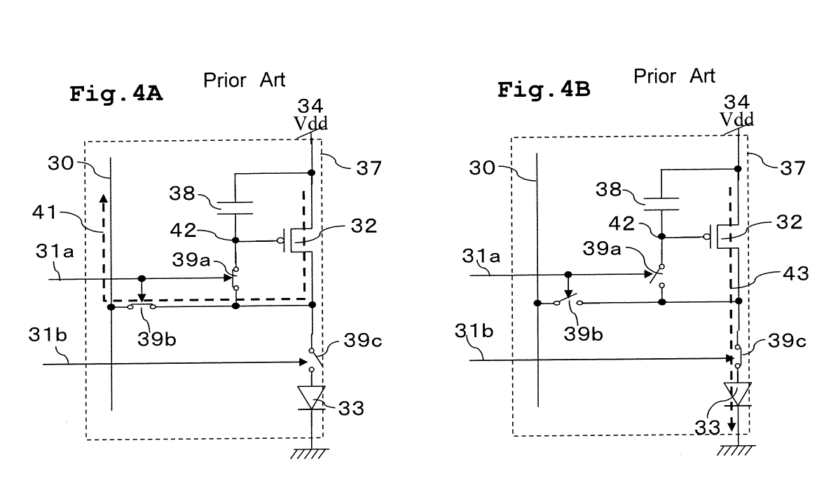

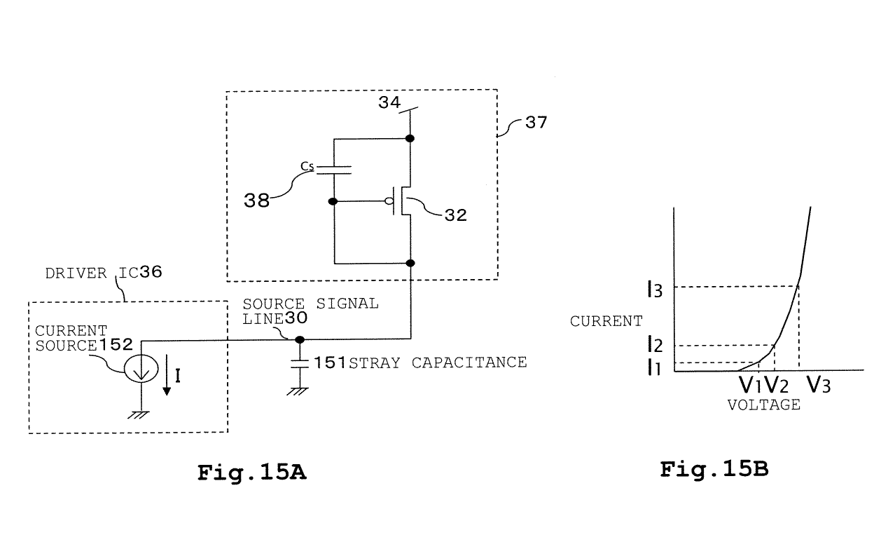

For example, in an active matrix display device having a pixel structure shown in FIG. 3, a predetermined current value is written in a certain pixel from a source signal line. In this case, a circuit related to a current path from an output stage of a source driver 36 to the pixel is as shown in FIG. 15A.

An electric current I corresponding to a gradation flows from the source driver 36 as a pull-in current in a form of a current source 152. This electric current is captured into a pixel 37 through the source signal line 30. The captured electric current flows in a driving transistor 32. In other words, the electric current I flows from an EL power supply line 34 to the source driver 36 through the driving transistor 32 and the source signal line 30 in the selected pixel 37.

When a video signal changes and a current value of the current source 152 changes, an electric current flowing to the driving transistor 32 and the source signal line 30 also changes. A voltage at the source signal line 30 changes according to a current-voltage characteristic of the driving transistor 32. When the current-voltage characteristic of the driving transistor 32 is as shown in FIG. 15B, for example, if a current value fed by the current source 152 changes from 12 to 11, a voltage at the source signal line 30 changes from V2 to V1. This change in the voltage is caused by an electric current of the current source 152.

A stray capacitance 151 is present in the source signal line 30. To change the source signal line voltage from V2 to V1, it is necessary to draw out a charge of this stray capacitance. Time ΔT required for drawing out the charge is calculated as follows: ΔQ(the charge of the stray capacitance)=I(the electric current flowing to the source signal line)×ΔT=C(a stray capacitance value)×ΔV.

If a gradation of the area 111 is 32 and a gradation of the area 112 is 0 in a panel that requires an electric current of 1 μA in white (255 gradation level), ΔV (a signal line amplitude from black display time to gradation 32 display time) is 3 [V], C=10 pF, and the electric current I during 32 gradation display is 125 nA. Thus, ΔT=240 microseconds is necessary. This time is longer than one horizontal scanning period (75 microseconds) at the time when a QCIF+ size (the number of pixels 176×220) is driven at a frame frequency of 60 Hz. Thus, if it is attempted to perform 32 gradation display in a pixel to be scanned next, switch transistors 39a and 39b for writing an electric current in the pixel are closed while a source signal line current is changing. Thus, the pixel shines at luminance in the middle between 32 gradations and black because a half tone is memorized in the pixel.

Since the change takes time ΔT, luminance takes a value in the middle between a predetermined value and a value of the preceding pixel over plural rows. Thus, display looks gently changing and, as a result, boundary lines look blurred.

Since a value of I is smaller as a gradation is lower, it is more difficult to draw out a charge of the stray capacitance 151. Therefore, the problem in that a signal is written in the pixel before the luminance changes to predetermined luminance more conspicuously appears in lower gradation display. To put it in an extreme way, an electric current of the current source 152 is 0 during black display and it is difficult to draw out a charge of the stray capacitance 151 without feeding an electric current in the area 112 below the area 111. (To be precise, the driving transistor 32 feeds an electric current equivalent to the gradation 32 in an initial state and a source signal line potential is changed using this electric current to reduce a drain current.)

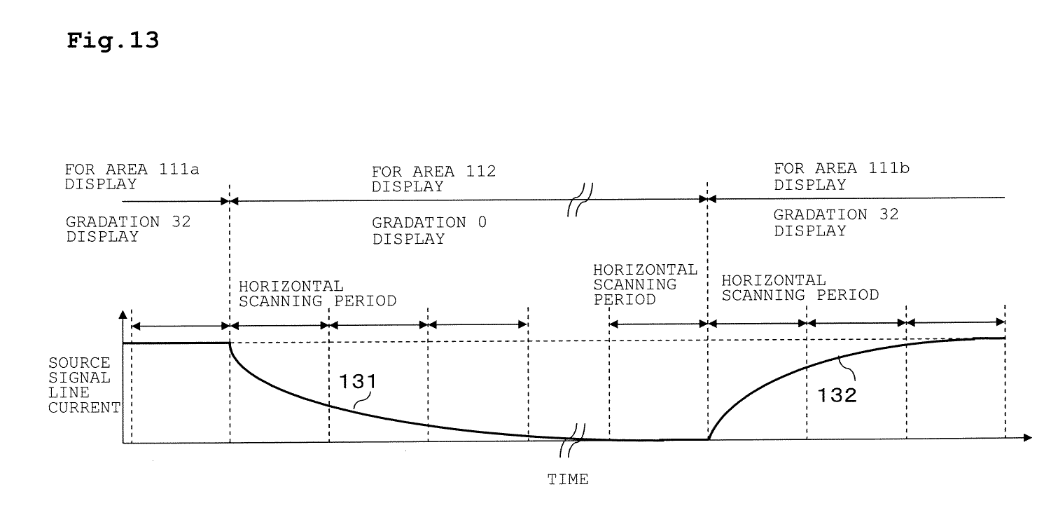

Therefore, a temporal change in the source signal line is gentle as shown in FIG. 13 when the area 111 has a gradation 32 and the area 112 has a gradation 0 in the display shown in FIG. 11. Display abnormality is confirmed in rows in which the source signal line changes.

The phenomenon in which the luminance of the first row of scanning is higher than that of the other rows in FIG. 15 is explained as a gradation 5 displayed over the entire screen as an example.

In a vertical blanking period, the source signal line 30 is not connected to any of pixel circuits. Only an operation for pulling in an electric current is performed in the source driver 36.

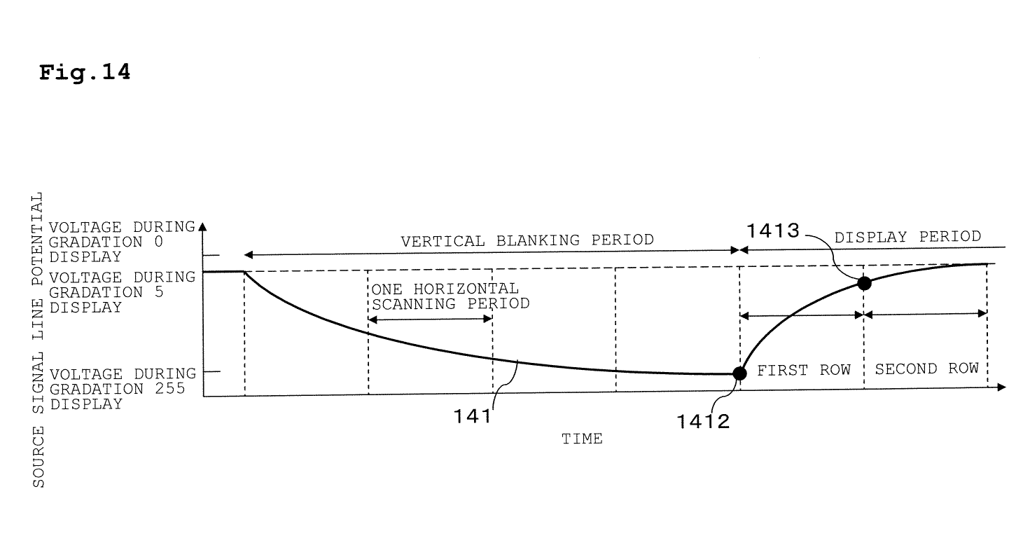

As a result, as shown in FIG. 14, a potential of the source signal line 30 is reduced by a current source 63 as time passes. The potential falls to a potential equivalent to a white gradation at the end of the vertical blanking period. When it is attempted to perform gradation 5 display in this state, it is necessary to substantially change a signal line potential in a first row. As in the example in FIG. 11, the change takes time and an intermediate potential of white and a target gradation is memorized (a point 1413 in FIG. 14). As a result, display is performed with high luminance and the first row looks bright.

In order to solve these problems, the display device is driven using a pre-charge method.

To solve the problem of inability to display the gradation 0, a voltage equivalent to gradation 0 display is applied to the pixel 37 during gradation 0 display to increase speed of a change to a gradation 0 state. The voltage at this point is referred to as a pre-charge voltage. A method of changing a state of a source signal line to a black display state at high speed during current driving by applying a voltage is referred to as voltage pre-charge.

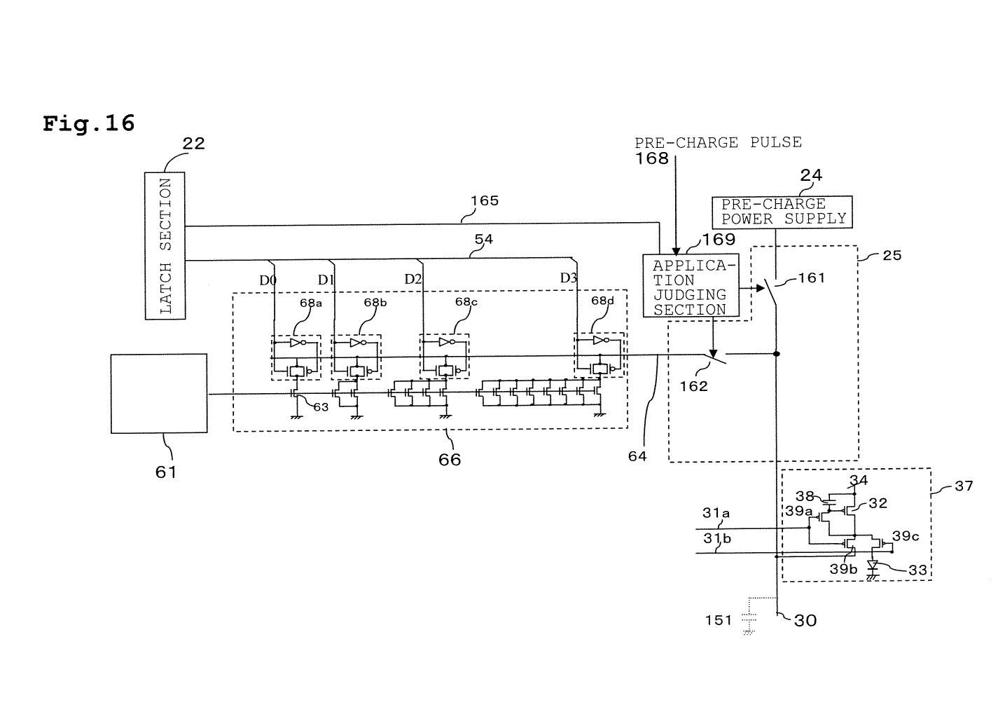

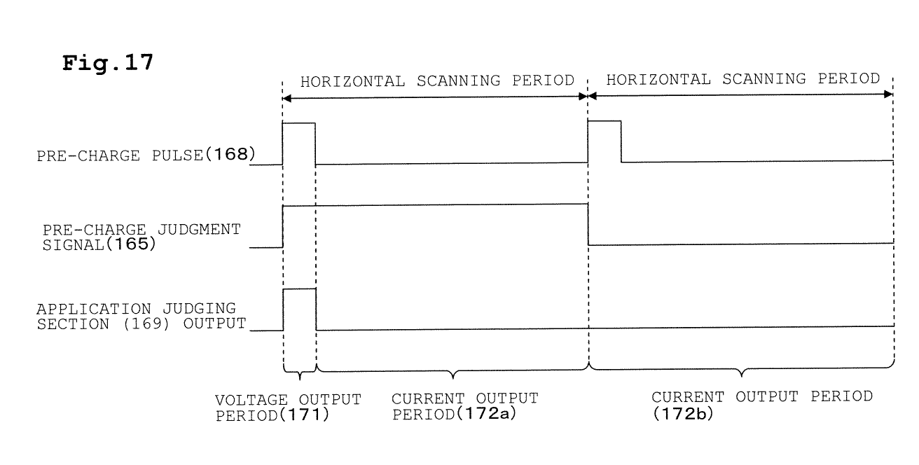

The structure of the output stage of the source driver 36 is shown in FIG. 16. The source driver 36 is different from the drive in the past in that a pre-charge power supply 24 that supplies a voltage applied during gradation 0 display and an application judging section 169 for judging whether the pre-charge power supply 24 should be applied to a pixel are added and the number of bits of a latch section 22 is increased in order to transmit judgment data to the application judging section 169 in synchronization with a video signal. A period in which the voltage pre-charge is carried out depends on a pre-charge pulse 52. Source driver operations during presence and absence of the voltage pre-charge are shown in FIG. 17.

The length of a voltage period depends on the stray capacitance 151 of the source signal line 30, the length of a horizontal scanning period, and a buffer ability of the pre-charge power supply 24. However, the length of the voltage period is set to the length of about 2 microseconds. An ability of the pre-charge power supply 24 is designed to change the stray capacitance 151 (about 10 pF) by a potential of about 5 V in 2 microseconds.

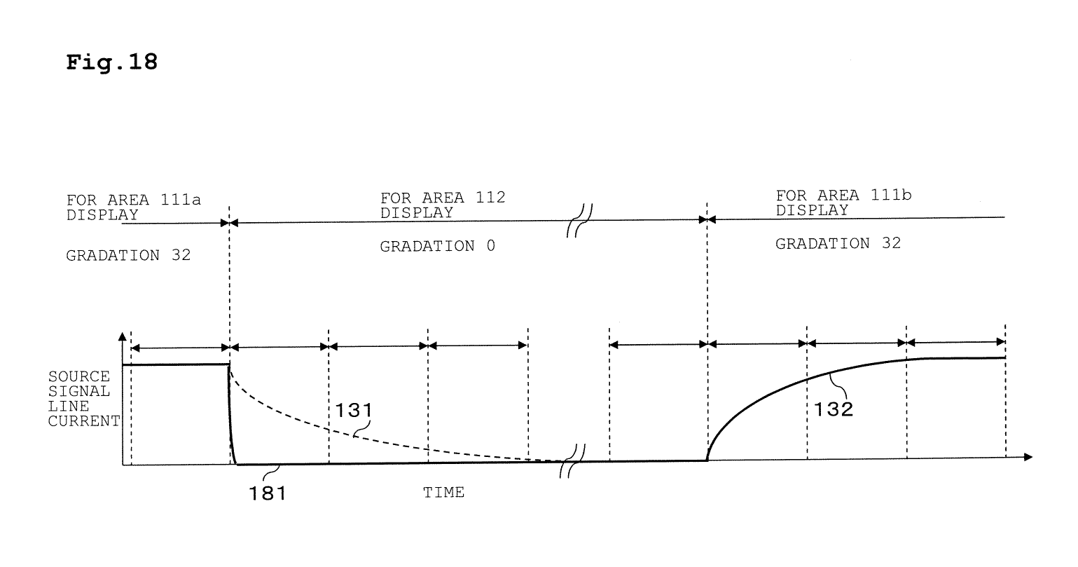

Consequently, a source signal line current that changes as indicated by 131 in FIG. 13 in the past changes as indicated by 181 in FIG. 18 and it is possible to display a gradation 0 from the first row of display in the area 112.

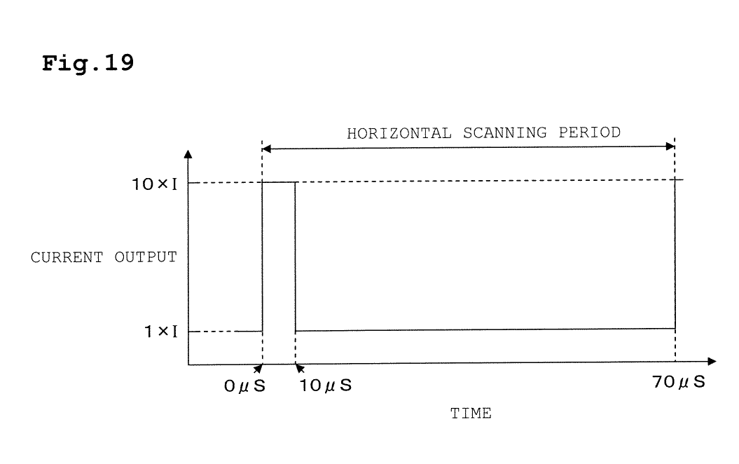

This method is ineffective for a change indicated by 132. Thus, as a unit which accelerates change speed, as shown in FIG. 19, a method of providing a period in which a current amount is temporarily increased, accelerating the change speed in the period, and quickly changing a current amount to a predetermined current value is adopted. In an example shown in FIG. 19, a ten-fold electric current is fed. The electric current is not limited to ten-fold electric current. It is effective to feed an electric current such as a maximum gradation current larger than a predetermined gradation current. The method of providing a period in which a large amount of an electric current is fed is referred to as current pre-charge. The electric current fed in a large amount is referred to as a pre-charge current.

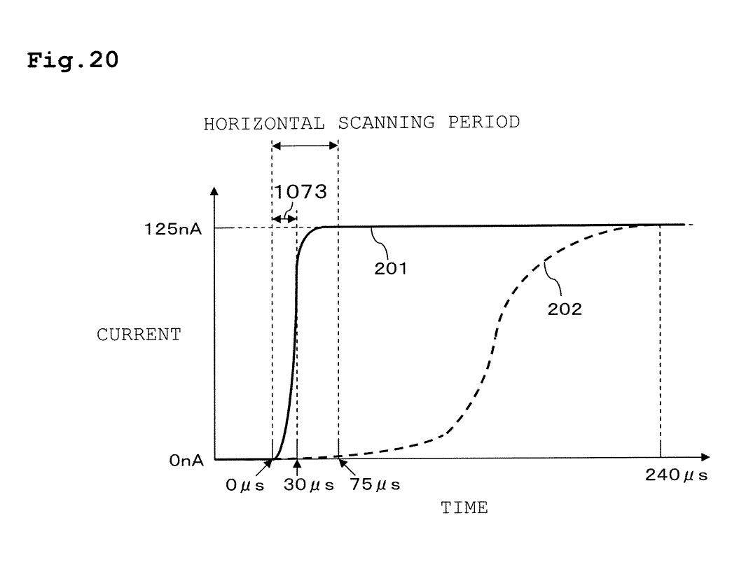

A state of a current change at the time when an electric current is changed to an electric current of a 32 gradation level is shown in FIG. 20. Whereas a change to 125 nA takes 240 microseconds in a curve 202, the method can change the electric current within 75 microseconds. In this example, a pre-charge current equivalent to a maximum gradation current (in an example of 8 bits, 255 gradations) is fed. Therefore, if a current pre-charge period 1073 shown in FIG. 20 is about 30 microseconds, it is possible to change the electric current to near the predetermined current value. Using the remaining 45 microseconds, a predetermined gradation display current is fed to correct unevenness of the driving transistor 32, which is a characteristic in a pixel structure of a current copier. Consequently, the current change is quickened and predetermined luminance can be displayed even in a low gradation.

Time of change to a predetermined current by the current pre-charge changes according to a state of a source signal line in an immediately preceding row. For example, a voltage change amount is different when the immediately preceding row is at a black level and changed to 32 gradations and when the immediately preceding row is 3 gradations and changed to 32 gradations. Even if writing is performed with a 32 gradation current, a writing state is different. Writing is easier when the immediately preceding row is 3 gradations. Therefore, a period of the current pre-charge has to be short. (This is a comparison in the case of an identical pre-charge current value. The same holds true when a current value is reduced and the length of the period is shortened.)

Consequently, to put it simply, 256×256 kinds of pre-charge periods are necessary and it is complicated to judge and output a pre-charge.

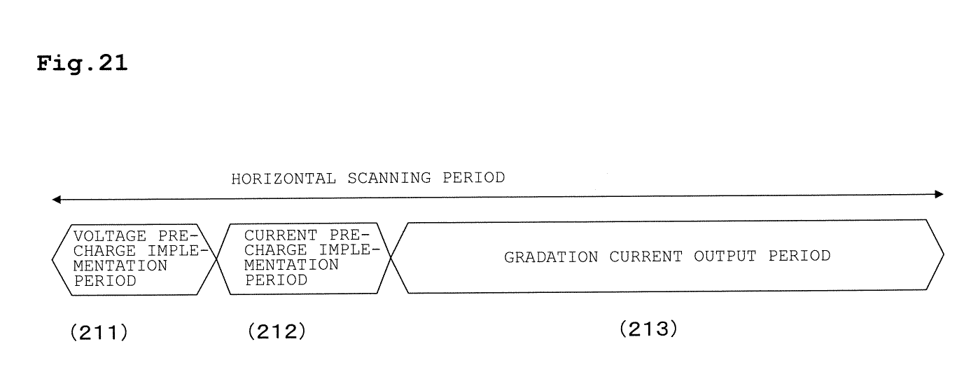

Thus, in order to reduce the types of pre-charges, before carrying out current pre-charge, a state of a source signal line is fixed to a certain value and a gradation is changed from the state to a predetermined gradation. Then, it is possible to perform predetermined display simply by deciding a current pre-charge period according to a gradation of a relevant row. A sequence in carrying out the current pre-charge in one horizontal scanning period is shown in FIG. 21. First, voltage pre-charge is carried out (211). A voltage is set in a black display state by the voltage pre-charge. Subsequently, current pre-charge is carried out (212). A current value is changed to near a predetermined current by the current pre-charge. Lastly, a potential of the driving transistor 32 is corrected and gradation display is carried out according to a gradation current output period (213).

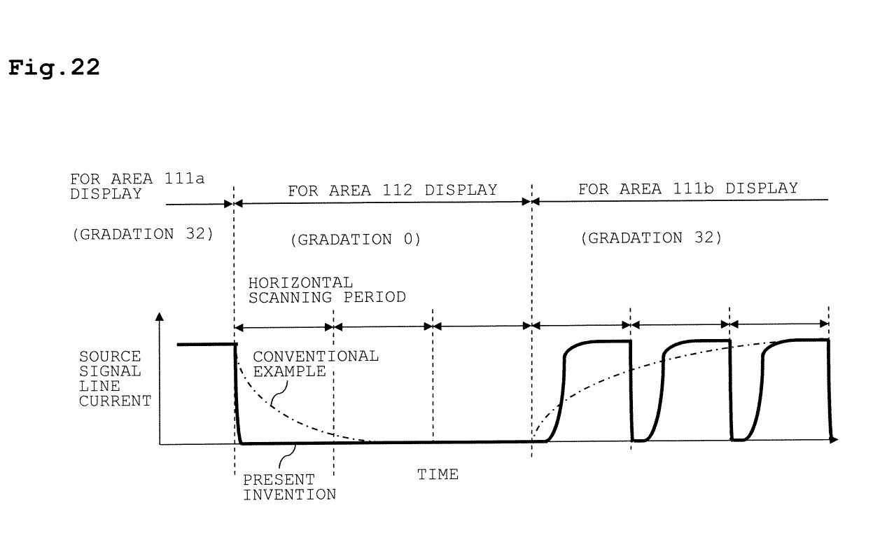

Consequently, in the display pattern in FIG. 11, as shown in FIG. 22, speed of change from the area 111a to the area 112 and change from the area 112 to the area 111b is increased. As shown in FIG. 22, a predetermined gradation can be properly displayed even in a first row after the change.

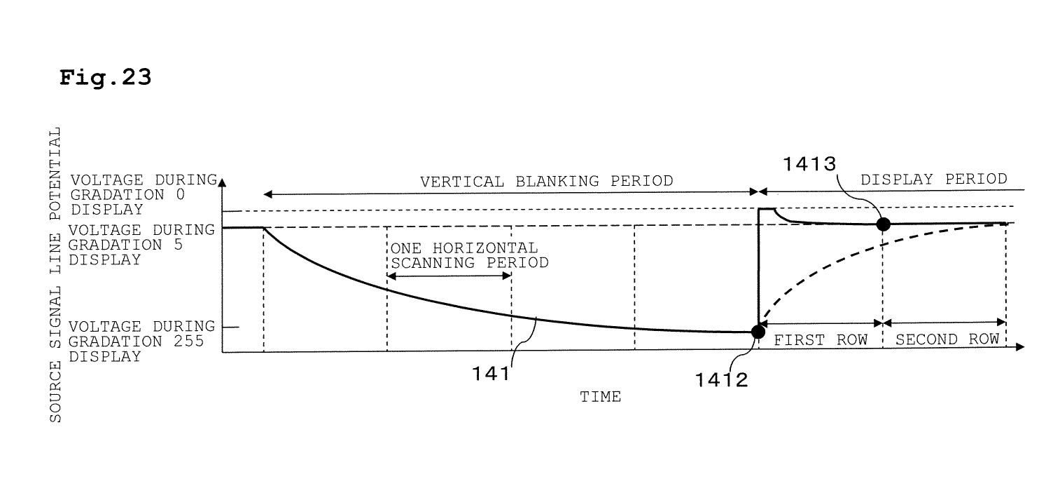

If this is always carried out in a first row of display, gradation 5 display can be carried out from the first row as shown in FIG. 23.

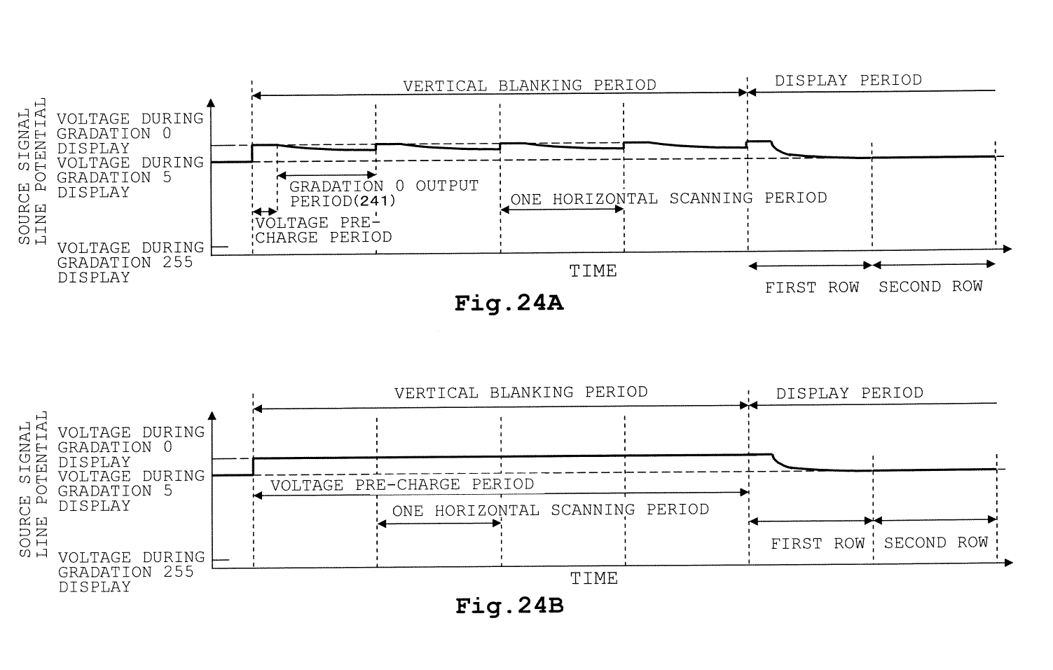

In order to prevent the fall in a potential in the vertical blanking period, there is a method of forcibly setting a source driver output to a gradation 0 output (i.e., no current pull-in) in the vertical blanking period or carrying out voltage pre-charge to fix the potential to a black potential during the vertical blanking period. Any one of a method of performing the voltage pre-charge only about 2 microseconds in the same manner as the usual voltage pre-charge as shown in FIG. 24A and a method of always performing the voltage pre-charge as shown in FIG. 24B may be adopted. In the case of FIG. 24A, since there is a gradation output period, it is preferable to fix a gradation to a gradation 0 and set the gradation output period as a gradation 0 output period 241.

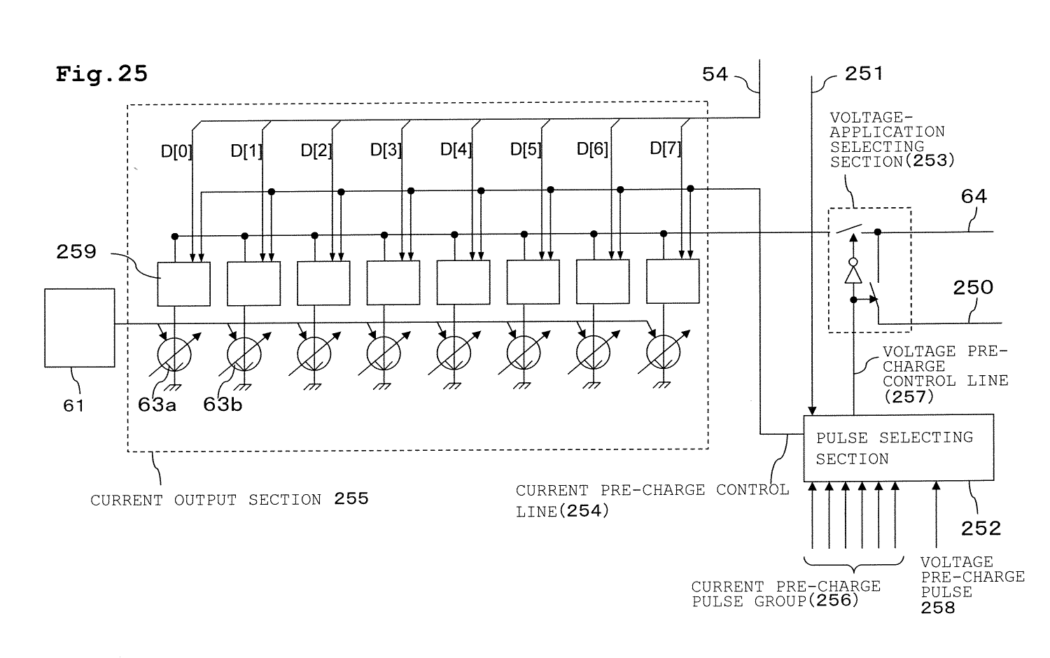

The structure of a current output section for performing current pre-charge and voltage pre-charge is shown in FIG. 25. A selecting section 259 connects the current source for gradation display 63 to a current output 64 when gradation data 54 or a current pre-charge control line 254 is at a high level. The selecting section 259 is a unit which determines whether the current source for gradation display 63 should be connected. A voltage pre-charge implementation period 211 shown in FIG. 21 depends on a pulse width of a voltage pre-charge pulse 258. A current pre-charge implementation period 212 depends on a current pre-charge pulse group 256. The plural current pre-charge pulses are provided because an optimum current pre-charge period is different depending on a display gradation. A current pre-charge pulse having an optimum pulse width is selected according to a gradation. A period in which both a current pre-charge pulse 256 and a voltage pre-charge pulse 258 are not inputted is a gradation current output period 213 shown in FIG. 21.

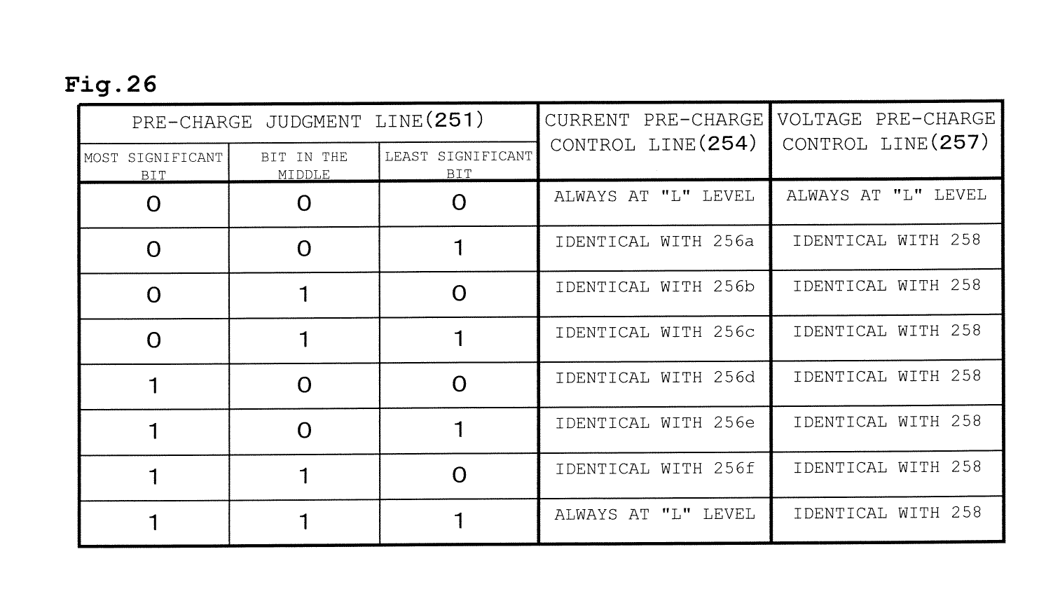

A pre-charge judgment line 251 selects the optimum current pre-charge pulse 256 according to a gradation and sets presence or absence of a voltage pre-charge pulse. A signal is inputted to the pre-charge judgment line 251 in synchronization with the gradation data 54. The pulse selecting section 252 outputs a pre-charge pulse in response to a value of the pre-charge judgment line 251, as shown in, for example, FIG. 26. When the value of the pre-charge judgment line 251 is 0, a pre-charge pulse cannot be outputted. Therefore, the pulse selecting section 252 performs usual gradation output. When the value of the pre-charge judgment line 251 is 7, only the voltage pre-charge is performed. In other cases, after carrying out the voltage pre-charge, the current pre-charge is carried out.

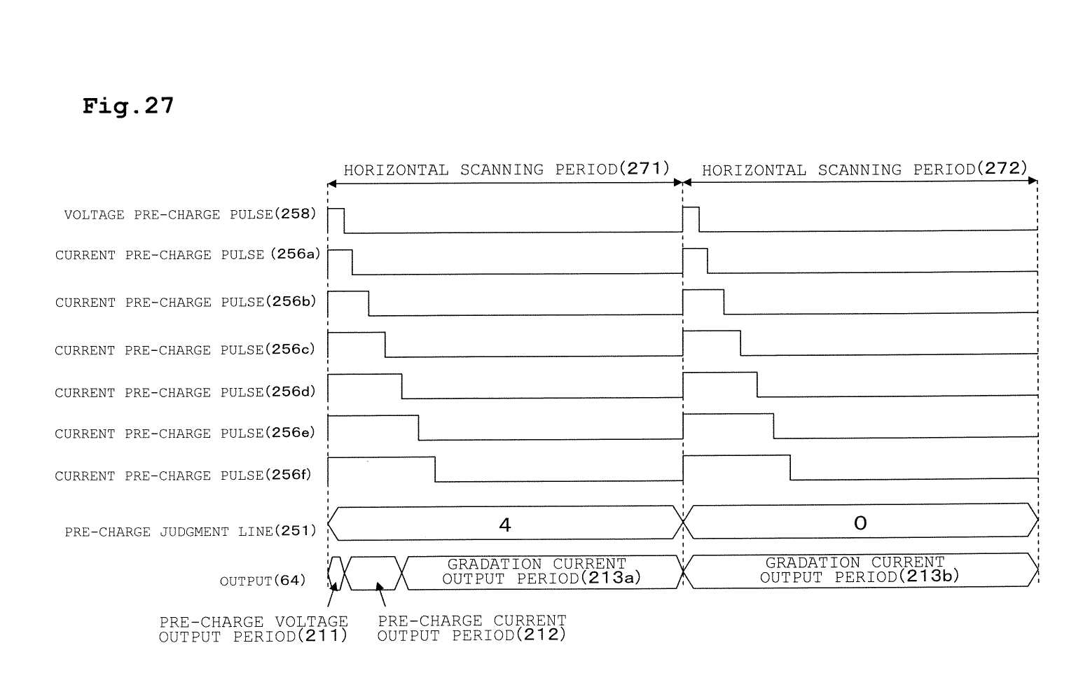

An example of setting of respective pre-charge pulses is shown in FIG. 27. When the voltage pre-charge pulse 258 and the current pre-charge pulse 256 are simultaneously inputted, the voltage pre-charge pulse 258 is selected by a voltage-application selecting section 253 and preferentially acts. Thus, the pulse rises simultaneously with the start of a horizontal scanning period. Six kinds of current pre-charge pulses 256a to 256f are prepared. The pre-charge pulses are set to be longer in order from 256a.

If a value of the pre-charge judgment line 251 is 4, as shown in FIG. 26, first, the voltage pre-charge implementation period 211 is set by the voltage pre-charge pulse 258, then, the current pre-charge implementation period 212 (only a period set by the current pre-charge pulse 256d) is set, and the remaining time is set as the gradation current output period 213.

If a value of the pre-charge judgment line 251 is 0, as indicated by the horizontal scanning period 272, the entire period is the gradation current output period 213.

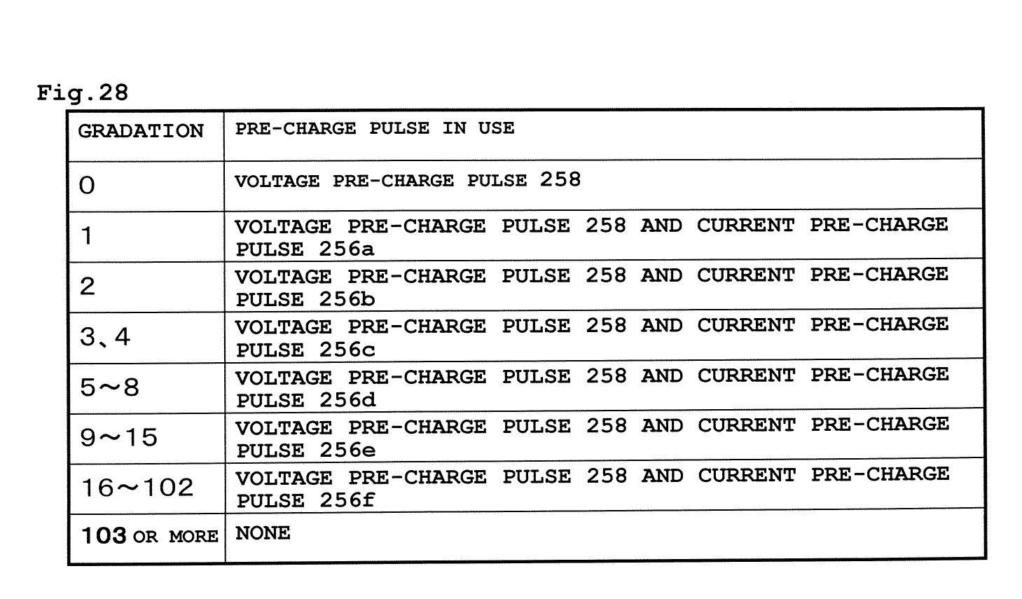

FIG. 28 shows how pre-charge is carried out for respective gradations. In the case of a gradation 0, as described above, voltage pre-charge is carried out. In gradations 1 to 102, current pre-charge is carried out. A current pre-charge period (in which a voltage pre-charge period is always present before current pre-charge) is set to be longer every time a gradation increases. At a gradation equal to or higher than a gradation 103, when 255 gradations are an electric current of 1 μA in an example of QCIF+ pixels, even if an immediately preceding row has a gradation 0, since the gradation can change within 75 microseconds, pre-charge is unnecessary. Therefore, output only with a gradation current is performed.

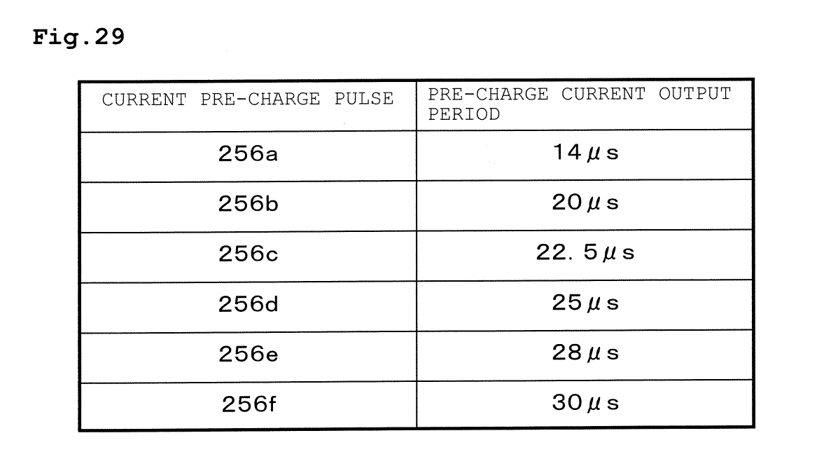

An example of respective pre-charge pulse widths is shown in FIG. 29. The pre-charge pulse widths are set according to voltage change amounts from a pre-charge voltage value corresponding to gradation 0 display. Combinations of gradations with the respective pre-charge pulses are as shown in FIG. 28.

An identical pre-charge pulse can be shared by plural gradations in FIG. 28 because, if a potential is varied to near a target value by current pre-charge, the potential can be corrected to a predetermined value with a gradation current.

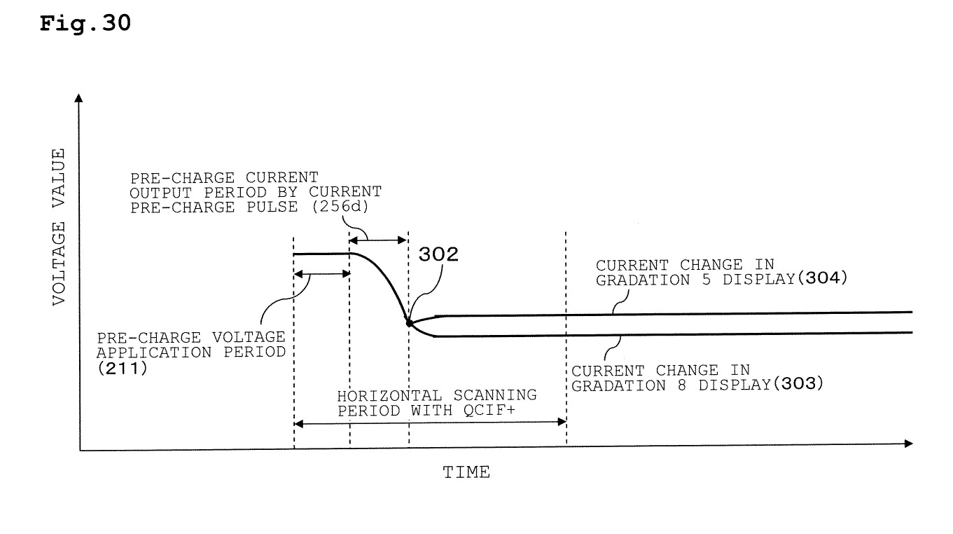

States of current changes at the time when the current pre-charge pulse 256d is applied at a gradation 5 and a gradation 8 are shown in FIG. 30. In the case of gradation 5 display, 2.4 V is required for a potential change of a source signal line from a black display state. In the case of gradation 8 display, 2.65 V is required.

When the length of the current pre-charge shown in FIG. 29 is set in the current pre-charge period 212, a potential change is 2.5 V. After this, the potential is changed to a predetermined potential with a gradation current. In gradation 5 display, as indicated by 304, the potential needs to be changed to reduce a voltage by about 0.1 V. Since a current value is 20 nA and the gradation current output period 213 is 55 microseconds, it is possible to change a voltage by 0.11 V with a gradation 5 current. It is seen that a predetermined gradation can be displayed if the current pre-charge 256d is used. On the other hand, at a gradation 8, since a current value is 31 nA, it is possible to change a voltage by 0.16 V in 55 microseconds. Thus, a sufficient change in a voltage is possible with respect to a voltage value 0.15 V necessary for the change. In this way, it is possible to perform display of the gradations 5 to 8 using the identical current pre-charge pulse 256d.

By selecting the optimum current pre-charge pulse 256 for each of the gradations in this way, it is possible to perform display without insufficiency of writing for all the gradations.

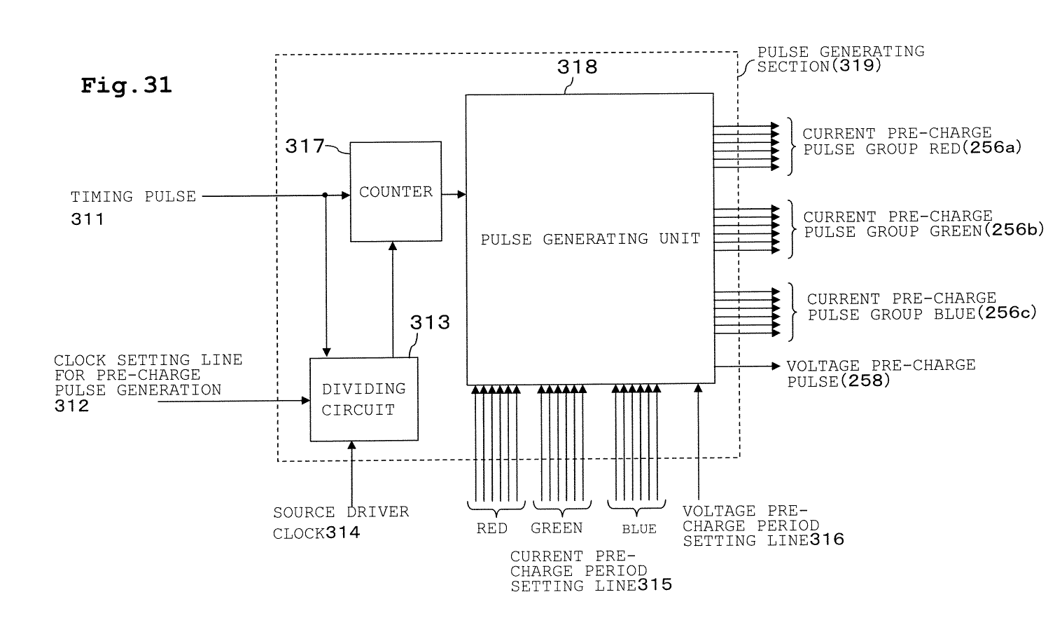

A pre-charge pulse is supplied from a pulse generating section as shown in FIG. 31. Since pre-charge is carried out after the start of a horizontal scanning period, a pulse is generated by a timing pulse 311 for determining analog output timing of a source driver. Thereafter, in order to determine the length of respective pre-charge pulses, values of a clock 314 and a counter 317 are compared with values of pre-charge period setting lines (315 and 316) and pulse generation is continued until values of the clock 314 and the counter 317 coincide with the values.

The group of current pre-charge pulse groups are separately set for each of the colors because values of gradation currents are different for the respective colors and it is likely that, even if current pre-charge is carried out with a maximum gradation current, time required for changing to the predetermined current value is different.

Voltage pre-charge forcibly changes a voltage to a certain potential with a voltage. Since a necessary pre-charge period does not change according to a voltage value, the voltage pre-charge is set commonly for all the colors.

Since the respective pre-charge pulses are generated by the source driver clock 314, depending on a frequency of a clock, a pulse width can only be set short (when the pulse is applied to a high resolution panel) or can only be set long (when the pulse is applied to a low resolution panel). There is a method of increasing the number of bits of the setting line 315 that sets a period in the pulse generating section and expanding a variable range. However, in this case, a circuit size of the pulse generating unit 318 increases. Thus, a dividing circuit 313 that divides the source drive clock 314 and controls a clock frequency is provided and a clock after division is inputted to a circuit of the counter 317 for pulse generation. This makes it possible to set a pulse width without being substantially affected by a resolution of a screen.

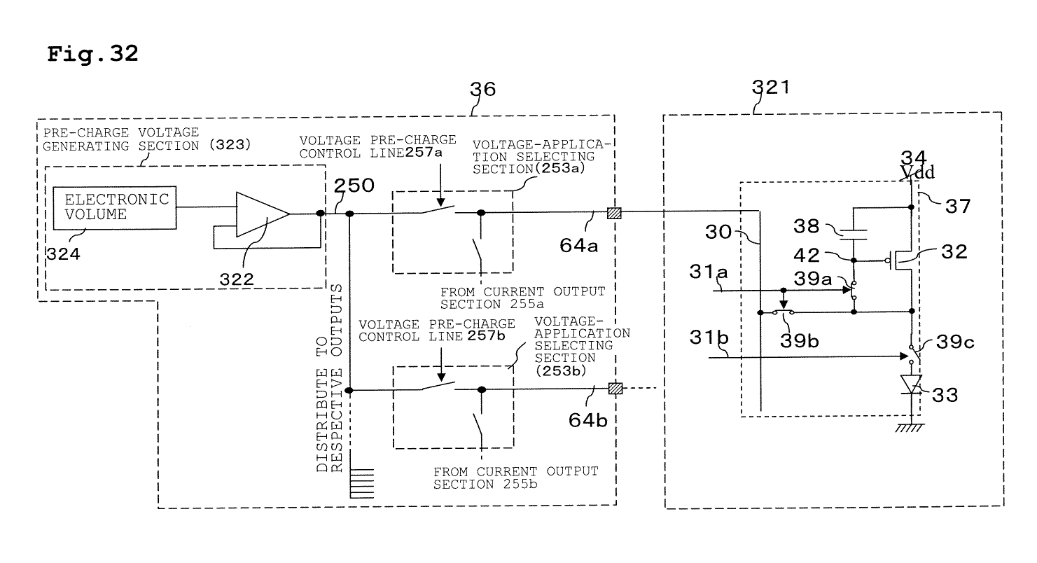

A circuit configuration for performing voltage pre-charge in FIG. 25 is shown in FIG. 32. A pre-charge voltage generating section 323 can change an output voltage value with a command in an electronic volume 324. An output of the pre-charge voltage generating section 323 is connected to the outputs 64 via voltage pre-charge control lines 257. A common voltage is outputted as all outputs. This is because, since a voltage during black display cannot be individually set for each of the colors, circuits for individual setting are unnecessary and only one circuit is present for reduction of a circuit size.

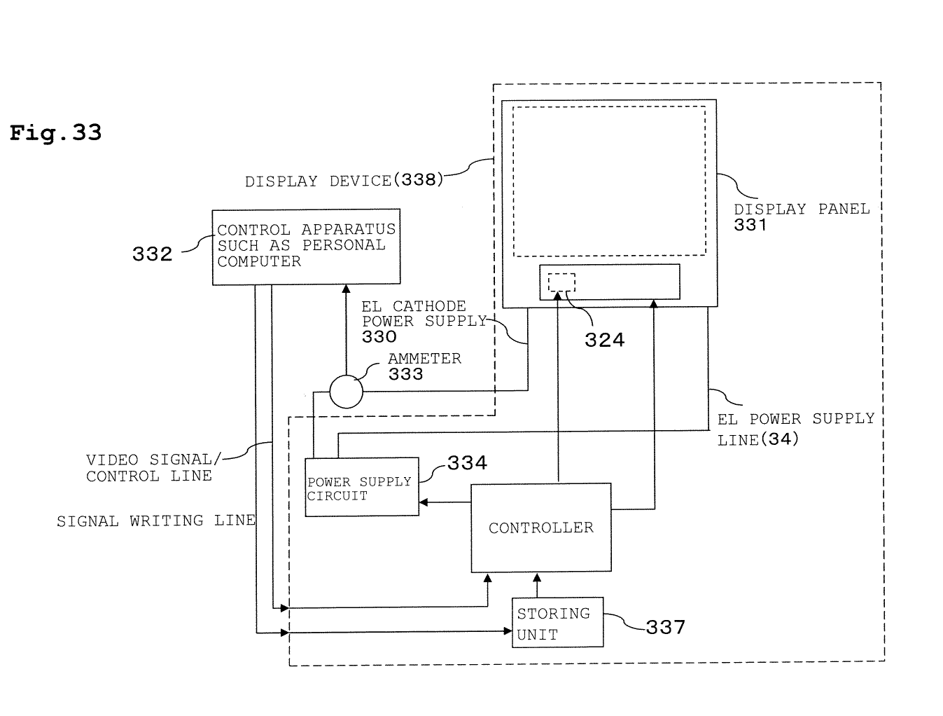

The electronic volume 324 is used for adjusting black luminance different for each of the panels and suppressing fluctuation. A circuit configuration for adjusting black luminance is shown in FIG. 33. Originally, as the adjustment of black luminance, it is necessary to measure luminance with a luminance meter and adjust the luminance to be fixed. However, in an organic light-emitting element of a self-emitting type, black luminance is equal to or lower than 0.05 candela. Thus, for the measurement of luminance, a luminance meter has to be selected and adjustment in a dark room is required. Thus, instead of luminance measurement, a method of measuring a sum of current values flowing to all pixels and adjusting the electric currents to be within a fixed range making use of the fact that a luminance-current characteristic of the organic light-emitting element is substantially in a proportional relation. Thus, in FIG. 33, an ammeter 333 is inserted in an EL cathode power supply line 330 in which a sum of electric currents flowing to the organic light-emitting element can be found, a value of the ammeter 333 is read out, and a control apparatus 332 such as a personal computer controls the electronic volume 324 in the source driver. Finally, the control apparatus 332 causes a storing unit 337 to store an optimum electronic volume value. (The storing unit is mounted on a final module and, after writing, united as a module in a pair with an adjusted panel). After the adjustment, a voltage value of voltage pre-charge is a value stored in the storing unit 337.

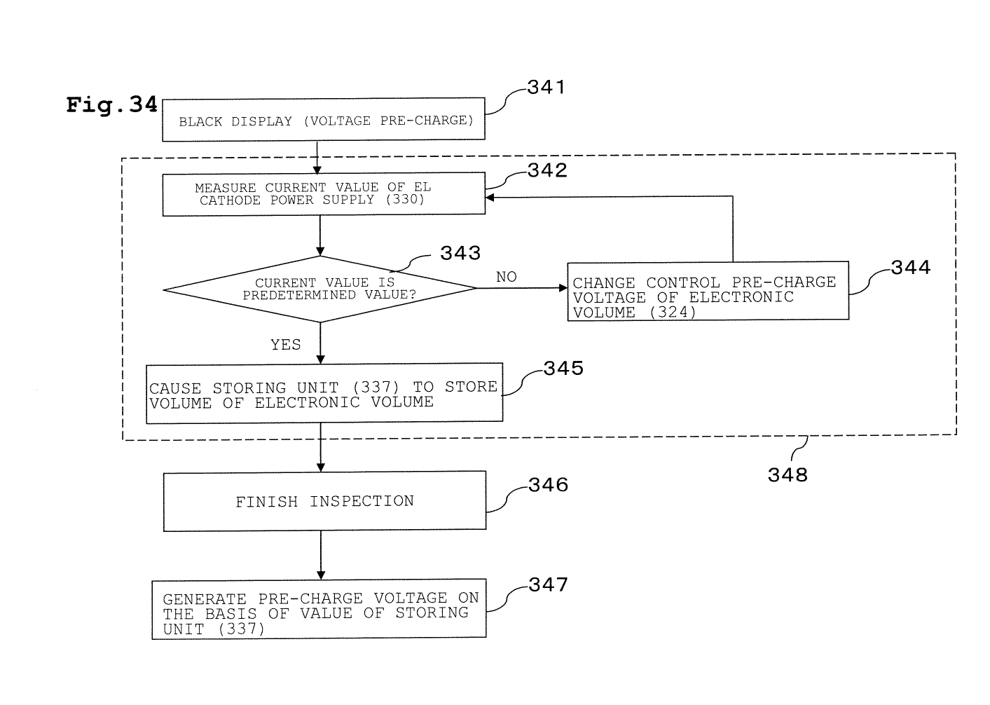

An adjustment method during black adjustment is shown in FIG. 34. The control apparatus 332 carries out voltage pre-charge to perform black display (341). Subsequently, the control apparatus 332 measures a current value of the EL cathode power supply 330. The control apparatus 332 judges whether the current value is within a predetermined range. If the current value is outside the range, the control apparatus 332 changes a value of the electronic volume for voltage pre-charge 324 again in order for the current value to fall within the range and measures an EL cathode current. The control apparatus 332 repeatedly carries out the change until the current value falls within the range. When the luminance can be measured during black display, the luminance may be measured instead of the current value of the EL cathode power supply 330 and the value of the electronic volume for voltage pre-charge 324 may be changed so that the luminance falls within a predetermined range.

When the current value falls within the range, the control apparatus 332 writes an electronic volume value at that point in the storing unit 337. Here, the adjustment is finished. The control apparatus 332 checks whether a value finally described in the storing unit 337 is correct and finishes the check. After that, a pre-charge voltage based on the value of the storing unit 337 is generated. Consequently, a display device with less fluctuation in black luminance among panels is realized.

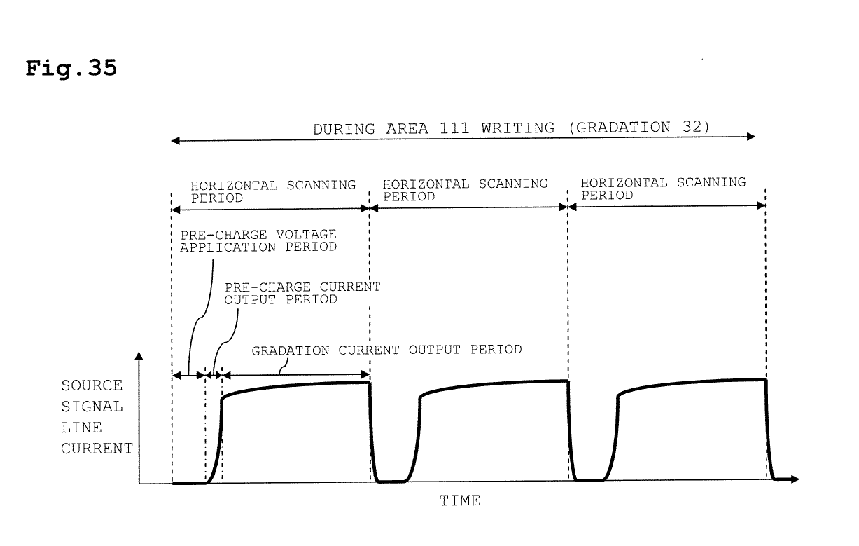

Display without insufficiency of writing is realized by carrying out the current pre-charge and the voltage pre-charge. However, when fixed luminance is displayed over plural rows, since pre-charge is carried out every time, a change in a signal line potential may be more intense than that before the pre-charge is carried out. For example, this occurs when a gradation 32 is displayed in the area 111 shown in FIG. 11. A state of a change in a signal line current is shown in FIG. 35. An electric current substantially changes to 0 once when respective horizontal scanning periods begin. On the other hand, in the method without pre-charge in the past, although a predetermined current is not obtained in several rows after a change in an area, a constant current always flows in the case of identical gradation display over plural rows and display with less current change is performed. Thus, it is easier to write an electric current.

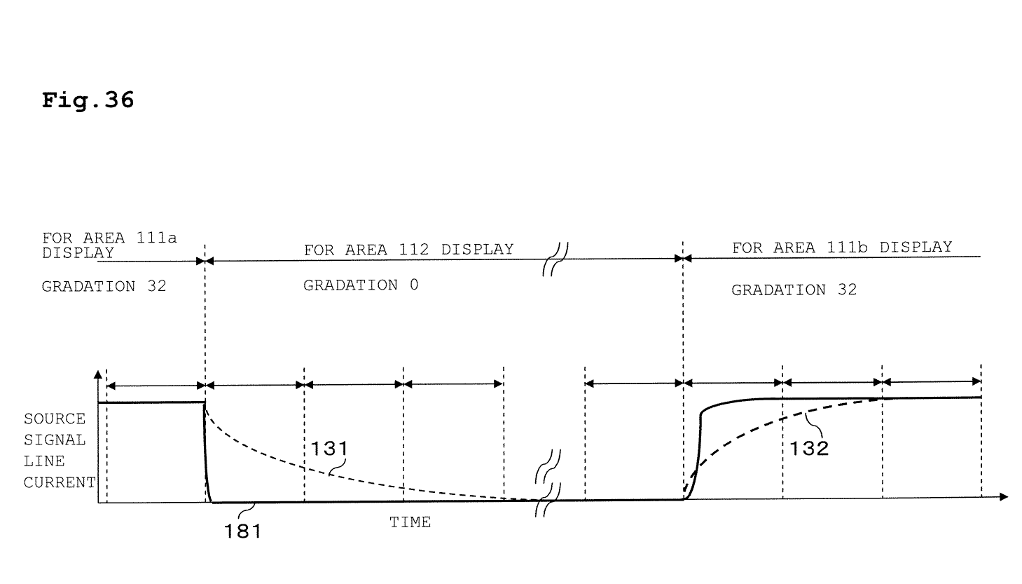

Thus, the inventor considered adopting a method of determining whether pre-charge should be performed according to a state of an immediately preceding row. The method is a method of performing pre-charge at points of change from the area 111 to the area 112 and from the area 112 to the area 111 but not carrying out pre-charge in the areas 111 and 112 in which there is no gradation change. Judgment processing for not carrying out pre-charge when an electric current can be written without the necessity of pre-charge is performed. The length of pre-charge depends on a relevant gradation as in the past. Consequently, as shown in FIG. 36, display can be properly performed in a section where a current change is large. A current change can be reduced by stopping pre-charge in a section where a current change is small. As a result, a display panel with an improved display quality is realized.

A method of determining a reference for judgment on whether pre-charge should be performed is explained. The judgment depends on whether an electric current can change to a predetermined state without pre-charge. When an electric current cannot change, pre-charge is performed.

Whether writing is possible depends on a display gradation (a writing current) and an amount of change (a potential difference) from an immediately preceding row.

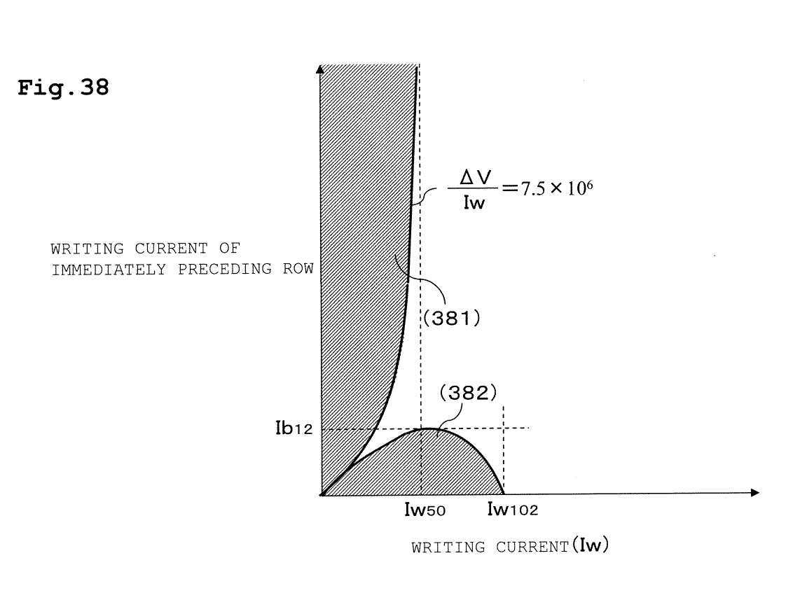

A relation of areas in which an electric current cannot be written without pre-charge to a combination of a writing current of an immediately preceding row and a writing current of a displayed row is shown in FIG. 38. A boundary line between the areas 381 and 382 is a line represented by ΔV×C=Iw×T (C is a stray capacitance of 10 pF, Iw is a writing current, and T is a horizontal scanning period of 75 microseconds). The areas 381 and 382 are areas in which ΔV×C/Iw>75 microseconds and are areas in which an electric current cannot change (cannot be written) within the horizontal scanning period.

Thus, the judgment on whether pre-charge should be performed only has to be carried out when an immediately preceding row and a relevant row in the areas 381 and 382 are combined. However, since multiplication is included in the judgment, this results in a judgment logic with a large circuit size.

In order to eliminate the multiplication, an area is judged according to whether a gradation of a relevant row is higher or lower than a fixed value and whether a gradation of an immediately preceding row is higher or lower than the fixed value to prevent the area from being narrower than the areas of 381 and 382.

In an example in FIG. 38, 255 gradations are an electric current of 1 μA, the number of pixels is QCIF+, and a source line capacity is 10 pF. Pre-charge is performed when a writing current is smaller than 103 gradations (Iw103) and an immediately preceding row current is smaller than 12 gradations (Ib12) and when a writing current is smaller than 50 gradations (Iw50). However, if gradations of the immediately preceding row and the relevant row are identical, writing is possible regardless of a current value. Thus, a determination that pre-charge is not performed when gradations are identical is added.

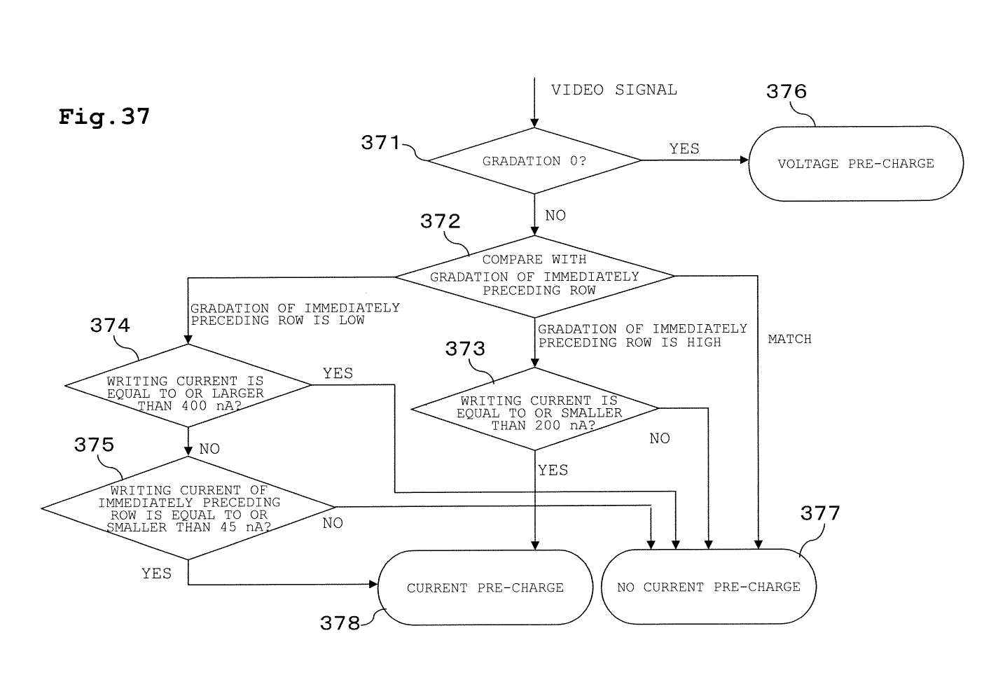

A system of a judging section for carrying out this judgment is shown in FIG. 37.

First, the judging section judges whether a gradation to be displayed is 0 (371). When the gradation is 0, voltage pre-charge is performed. Even if the gradation 0 continues over plural rows, since a pre-charge voltage value is a potential during gradation 0, the problem of an increase in potential fluctuation caused by performing pre-charge every time shown in FIG. 35 does not occur. Thus, pre-charge is performed every time.

When the gradation is not 0, the judging section compares the gradation with gradation data of an immediately preceding row (372). In order to carryout the comparison, a circuit for storing data for one row is necessary in a RAM or a latch circuit.

When the gradation coincides with the gradation data of the immediately preceding row, writing is possible regardless of a display gradation (a writing current). (This is because a potential of a source signal line does not change.) Therefore, current pre-charge is not carried out in this case.

When the gradation of the immediately preceding row is larger, taking into account the area 381 in FIG. 38, current pre-charge is carried out when an electric current to be written is equal to or smaller than 200 nA equivalent to a gradation 50. Although pre-charge is carried out in an area larger than the area 381, since prevention of image quality deterioration due to insufficiency of writing is given priority, taking into account simplicity of processing, such judgment is performed. When the gradation is larger than 200 nA, current pre-charge is not performed because it is possible to change, with a writing current, a source signal line potential to a predetermined current value without pre-charge.

When the immediately preceding row gradation is lower, taking into account the area 382 in which writing is possible with a gradation current, first, when a writing current is equal to or larger than 400 nA equivalent to a gradation 103, it is judged in the judgment 374 that pre-charge is not performed because writing is possible without pre-charge regardless of a writing current in the immediately preceding row.

At a gradation equal to or lower than a gradation 102, since writing is possible or impossible depending on a writing current of the immediately preceding row, when it is judged by a judging section 375 that an electric current of the immediately preceding row is equal to or smaller than 45 nA equivalent to a gradation 12, pre-charge is carried out.

Consequently, a combination of areas in which pre-charge is carried out including the area 382 in which an electric current cannot be performed without pre-charge is determined. It is possible to select ON and OFF of pre-charge corresponding to necessity.

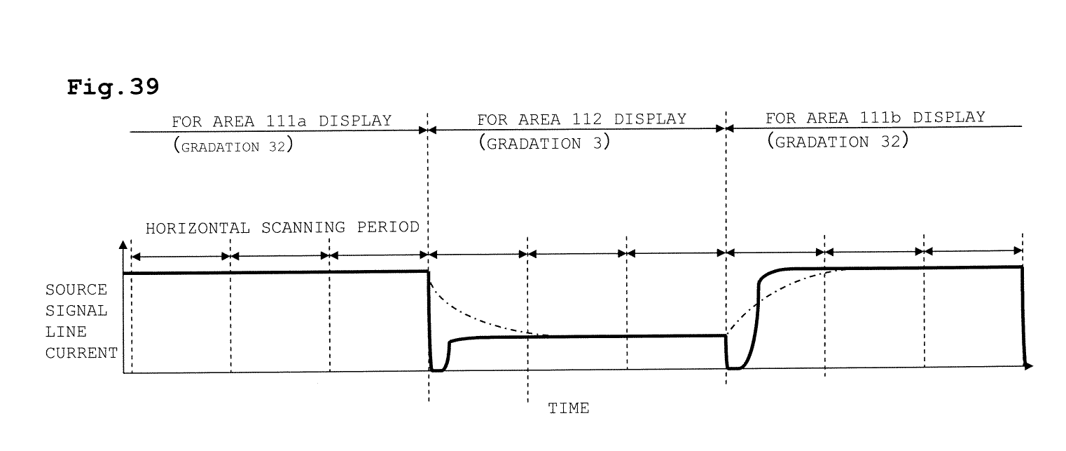

A state of a change in a source signal line current at the time when the judgment processing in FIG. 37 is performed is shown in FIG. 39. (The area 111 in FIG. 11 has a gradation 32 and the area 112 has a gradation 3). Compared with the circuit configuration without pre-charge, speed during a change in an electric current increases and gradation display can be properly realized even in a boundary row between the areas.

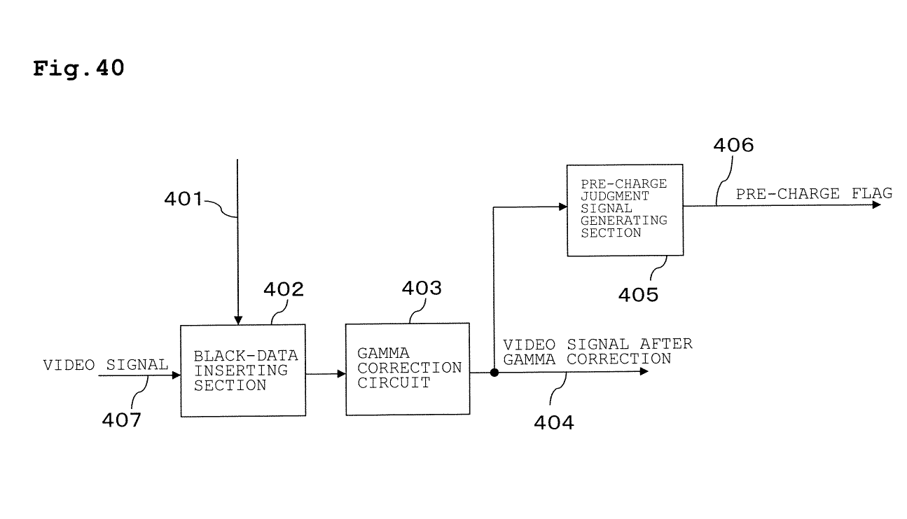

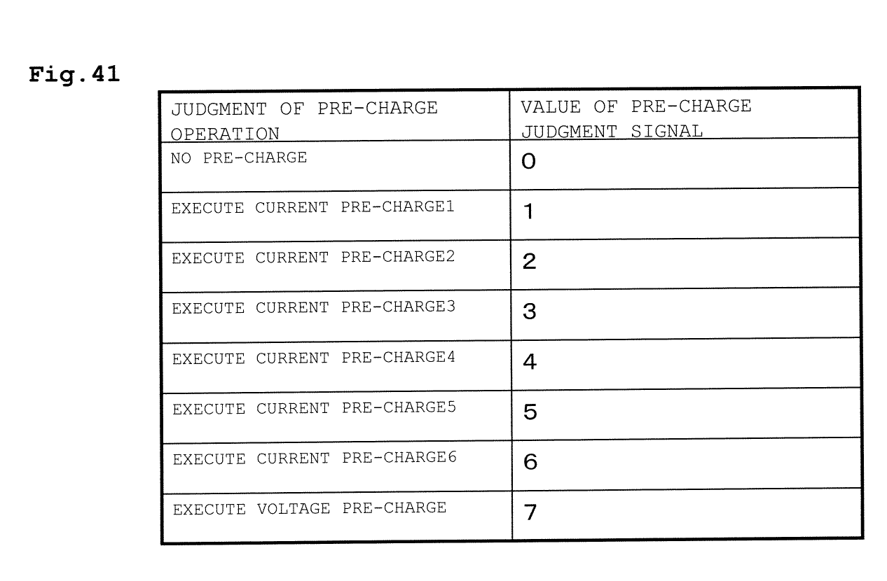

A circuit that selects an optimum pre-charge pulse or judges that pre-charge is not performed according to a gradation needs to carry out pre-charge judgment for a video signal 407 transmitted from the outside of the display panel on the basis of data transmitted to the source driver with an output of a gamma correction circuit, which performs gamma correction, through a black-data inserting section 402 that outputs black data regardless of an input in a vertical blanking period according to a data enable signal 401. Therefore, the circuit is formed in the structure shown in FIG. 40. Pre-charge judgment is performed using a video signal after gamma correction 404. A pre-charge flag 406 is transmitted to the source driver in synchronization with this data. The pre-charge flag 406 is transmitted in a relation shown in FIG. 41 in association with FIG. 26 such that the pre-charge flag 406 does not contradict the pulse selecting section 252 on the source driver side in use.

Described is processing of a first row without a video signal to be compared as opposed to the comparing section for comparison with the immediately preceding row data. Since the black-data inserting section 402 for inserting black data in a vertical blanking period is added, a black gradation for which voltage pre-charge is carried out is always present before the first row. Data transmitted at timing of the immediately preceding row is always stored in the storing unit and used as comparison data. Thus, this data is also held. When pre-charge of the first row is judged, it is automatically judged that pre-charge at the time when gradation 0 display is in the immediately preceding row is performed. Thus, it is possible to carry out the processing for the first row in the same manner as processing for second and subsequent rows.

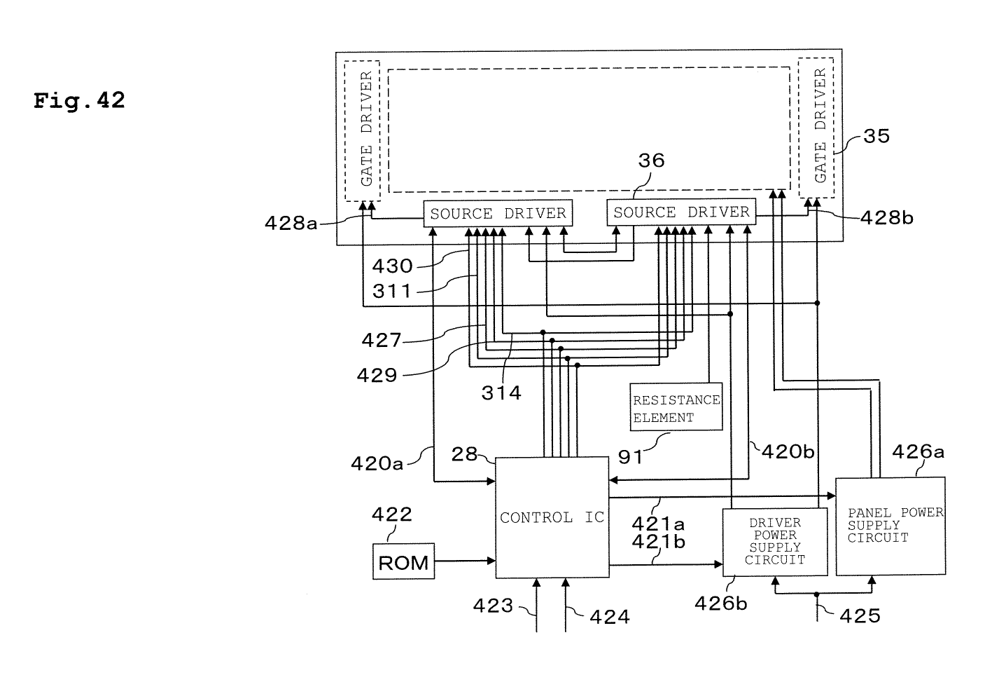

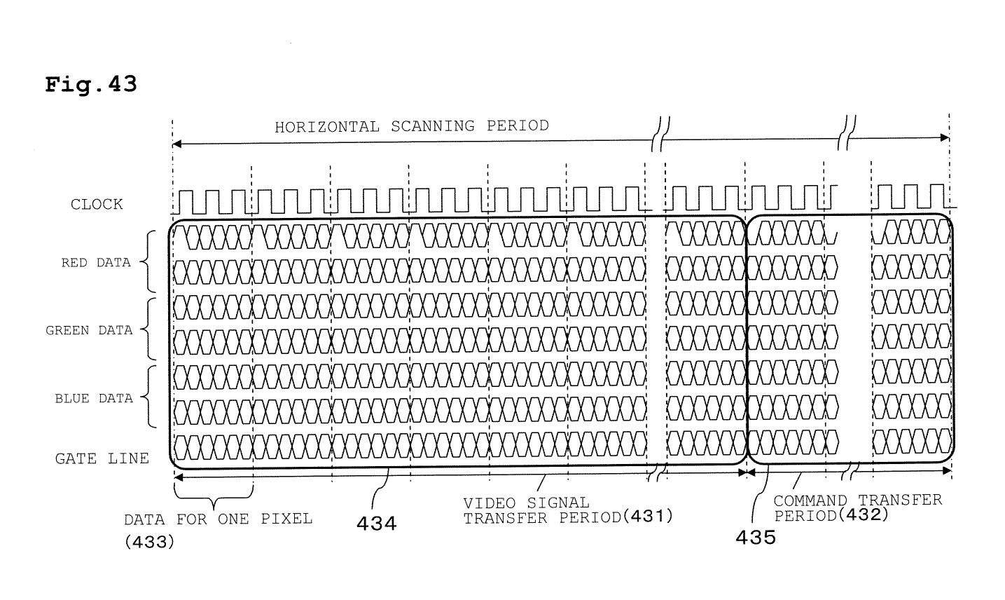

A pulse width of the pre-charge pulse 256 does not need to be judged for each video signal and is a fixed value in an identical panel. Thus, the pulse width is separately transmitted to the source driver according to command setting or the like. A pre-charge flag is necessary in synchronization with a video signal and there are many commands such as commands for setting of a pre-charge pulse and setting of a pre-charge voltage value. Thus, in the case of a module in which a controller and a driver are constituted by separate chips (FIG. 42), there are many control signal lines between two ICs. It is anticipated that external wiring is complicated. Thus, for example, there is a method of serially transferring data necessary for one pixel by multiplying the data with a clock frequency N as shown in FIG. 43 and a method of reducing external signal lines by setting various commands on a signal line identical with a video signal input line (432) using a horizontal blanking period. A ROM 422 is present for storing command setting different for each of the panels and stores an electronic volume value of a pre-charge voltage and reference current electronic volume values of the respective colors.

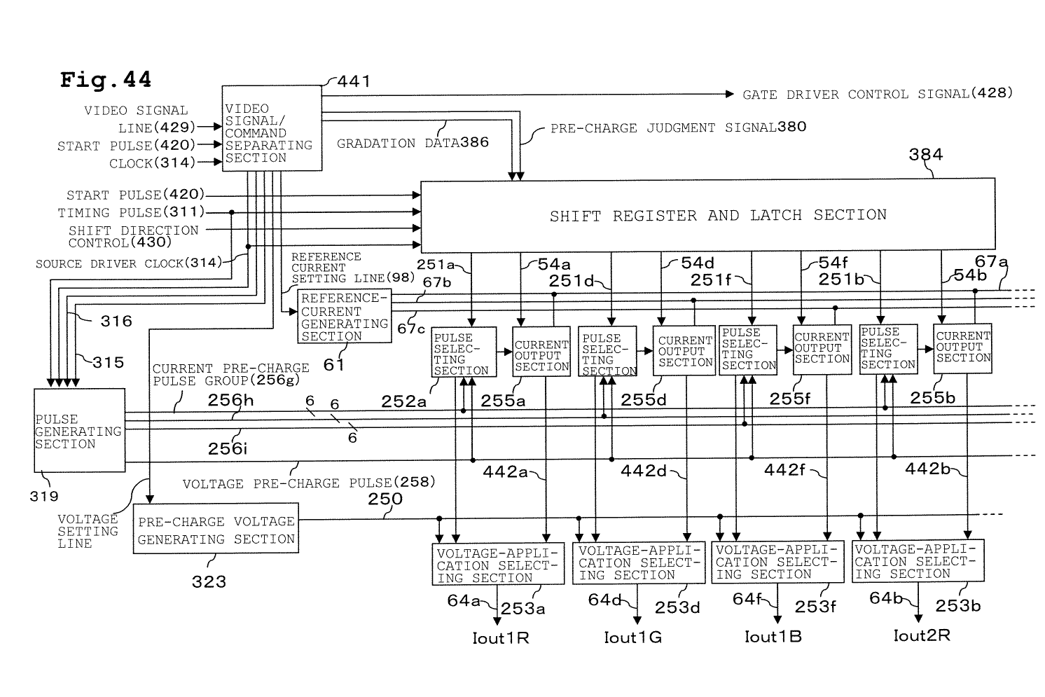

A circuit configuration of a source driver capable of carrying out current pre-charge and voltage pre-charge is shown in FIG. 44. In this example, a video signal 434 and a command 435 are transmitted on an identical line (a video signal line 429) as shown in FIG. 43. Video signal line data is separated into commands (315, 316, 98, and 502), gradation data 386, a pre-charge judgment signal 380, and a control signal for gate driver 428 by a video signal and command separating section.

Six kinds of current pre-charge pulses 256 are generated by the pulse generating section 319. Six pulses for each of the colors are generated and inputted to the pulse selecting section 252. A current output section 255 performs current output on the basis of the gradation data 54 and current setting per one gradation generated by the reference-current generating section 61. At this point, depending on an operation of the pulse selecting section 252, a period in which a maximum gradation is outputted according to a pulse width of a current pre-charge pulse is generated (current pre-charge). At a final stage, the voltage-application selecting section determines a judgment on whether voltage pre-charge should be carried out. The judgment is determined according to an output of the pulse selecting section. An outputted voltage is a voltage determined by the pre-charge voltage generating section. Consequently, a source driver capable of performing current pre-charge and voltage pre-charge is realized.

In the above explanation, there are the six kinds of current pre-charge pulses. However, depending on efficiency of the organic light-emitting element, a current value per one gradation further decreases and plural gradations cannot be shared by identical pre-charge pulses in the relation between gradations and pre-charge pulses shown in FIG. 28. Thus, the necessary number of pulses increases. For example, when the current value decreases to a half, current values of the gradations 16 and 102 decrease to those equivalent to gradations 8 and 51. At the gradations 8 and 51, different pre-charge pulses are selected. In this case, three kinds of pre-charge pulses are selected. In other words, the necessary number of pre-charge pulses increases. Therefore, it is possible that the number of current pre-charge pulses is larger than six.

In this case, the number of current pre-charge pulses in the current pre-charge pulse group 256 is increased. The number of selections of operations of the pulse selecting section 252 also increases. Therefore, it is necessary to cope with the increase by increasing the number of bits of the pre-charge judgment line 251.

It is also possible to cope with the relation in FIG. 28 by allocating gradations in a range of the increased number of pre-charge pulses even if an electric current decreases to a half.

For example, when sixteen kinds of pre-charge pulses are necessary, the pre-charge judgment line 251 has 5 bits. Concerning the allocation of gradations, a method of preparing individual pre-charge pulses for each of gradations on a low gradation side and sharing plural gradations at higher gradations is adopted.

If the kinds of pre-charge pulses necessary for solving insufficiency of writing are prepared, effects same as those explained above can be obtained. It is also possible to prepare an arbitrary number (to put it in an extreme way, (the number of gradations-1)) kinds of pre-charge pulses.

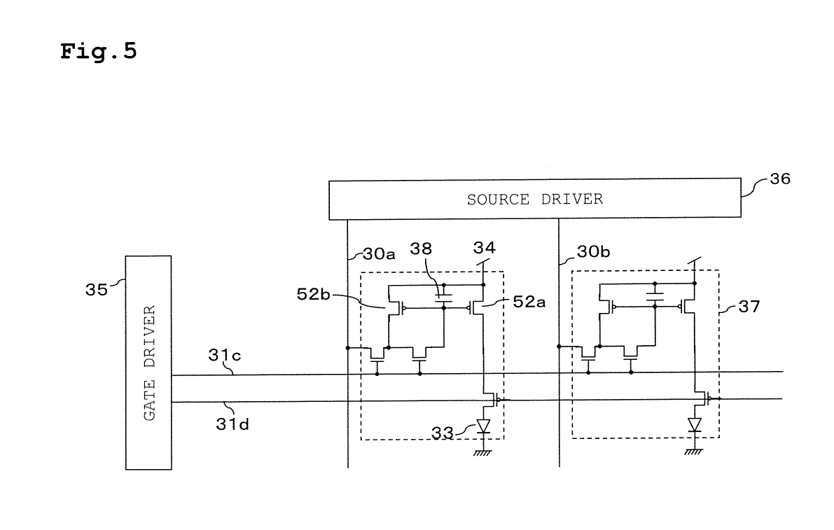

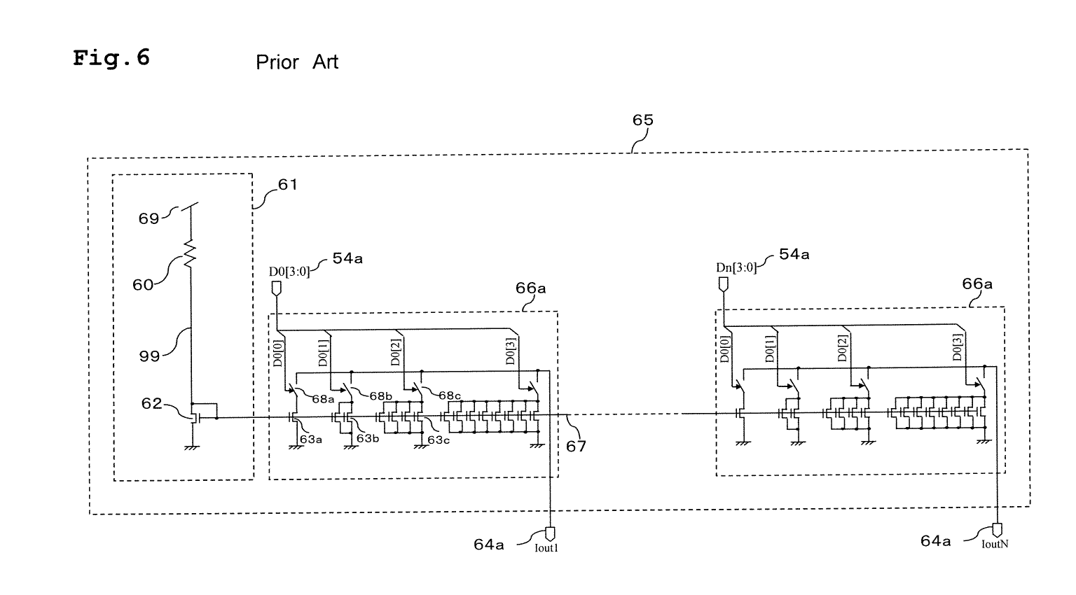

The source driver used for the above explanation can be implemented not only in the current copier circuit configuration in FIG. 3 but also in the current mirror circuit configuration shown in FIG. 5. This is because an operation for changing a gate potential (a source signal line potential) of the driving transistor 52 with a micro current and writing the gate potential is the same in both the circuit configurations.

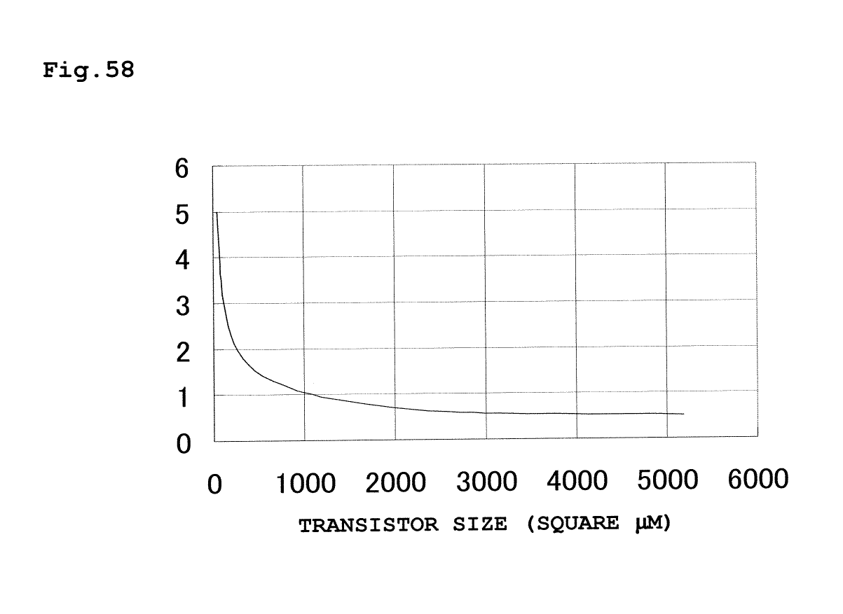

In the current output type source driver, if a current output is formed by an array of transistors, an area for the number of transistors is required. Since it is necessary to take into account fluctuation in a reference current and keep fluctuation among adjacent terminals in a chip and among chips within 2.5%, it is desirable to reduce fluctuation in an output current (fluctuation in a current at an output stage) in FIG. 58 to be equal to or lower than 2.5%. It is advisable that a transistor size of the current source 63 is equal to or larger than 160 square microns.

When a pixel circuit is formed by a low-temperature polysilicon TFT, there is a process for polycrystallizing amorphous silicon with laser annealing.

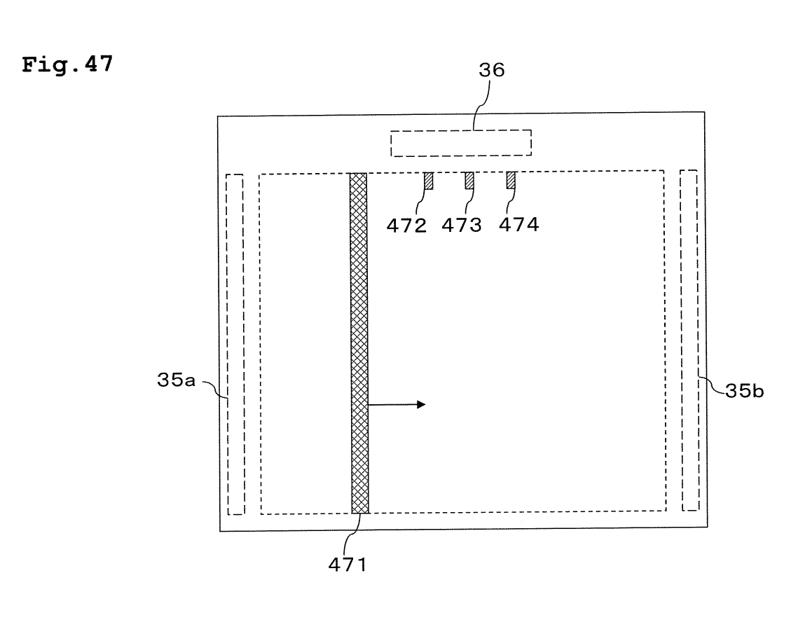

In this case, as shown in FIG. 47, instead of annealing an entire display area at a time, a laser is irradiated in a line shape and an irradiated area is polycrystallized as indicated by 471. To irradiate the laser over an entire screen, the area 471 is moved to gradually scan the screen as indicated by an arrow, the entire screen is polycrystallized, and a low-temperature polysilicon TFT is formed.

In this case, fluctuation occurs in a state of polycrystallization depending on the intensity of the laser. Fluctuation occurs in mobility of the TFT and a threshold voltage. The fluctuation in the laser intensity is substantially affected by temporal fluctuation. Areas on which the laser is irradiated at timing when the intensity is high and areas on which the laser is irradiated at timing when the intensity is low are distributed in a shape of the area 471.

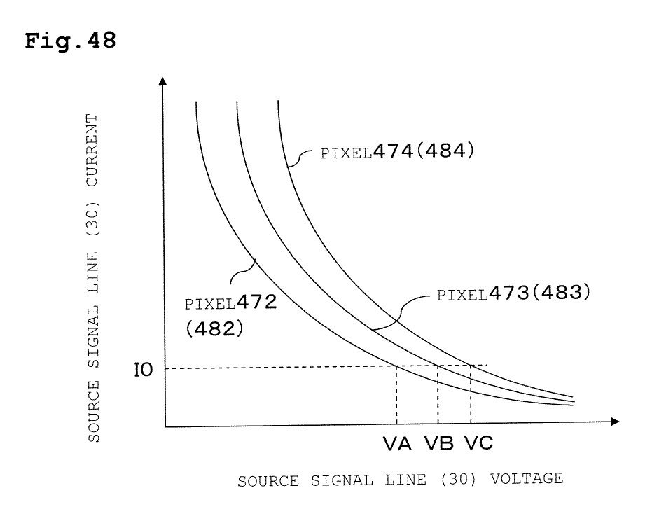

As a result, a difference occurs in the laser intensity in pixels indicated by 472, 473, and 474 in FIG. 47. A difference occurs in voltage-current characteristics of source signal lines 482 to 484 because of characteristic fluctuation of the driving transistor 32 in the pixel circuit 37 as shown in FIG. 48.

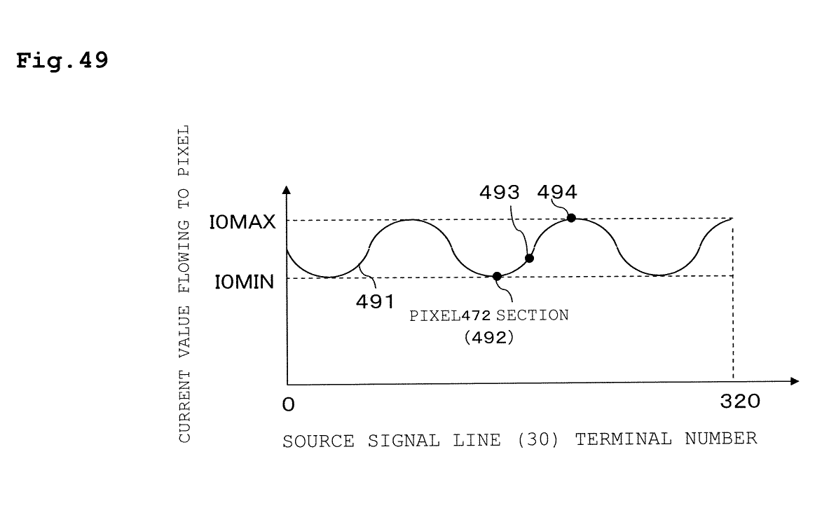

When gradation 0 display is performed by voltage pre-charge, fluctuation occurs in an electric current flowing to pixels (i.e., an electric current flowing to an EL element) in a row including pixels 472 to 474 depending on the pixels as indicated by 491 in FIG. 49. In this example, a minimum current of 10 MIN and a maximum current of 10 MAX flow.

The luminance of the EL element is affected by a difference in this current value. Pixels to which the current 10 MAX flows emit light brightly compared with pixels around the pixels. When this luminance difference is visually recognized as unevenness, a display quality is deteriorated.

Thus, the inventor considered inputting an optimum voltage for each of the pixels to make electric currents flowing to all the pixels the same rather than applying a pre-charge voltage (i.e., a gate voltage of the driving transistor 32) at a potential common to all the pixels.

In order to obtain a predetermine current value 10, if a voltage VA is applied to the pixel 472, a voltage VB is applied to the pixel 473, and a voltage VC is applied to the pixel 474, an electric current of I0 flows to all the three pixels. This only has to be applied to all the pixels in the same manner.

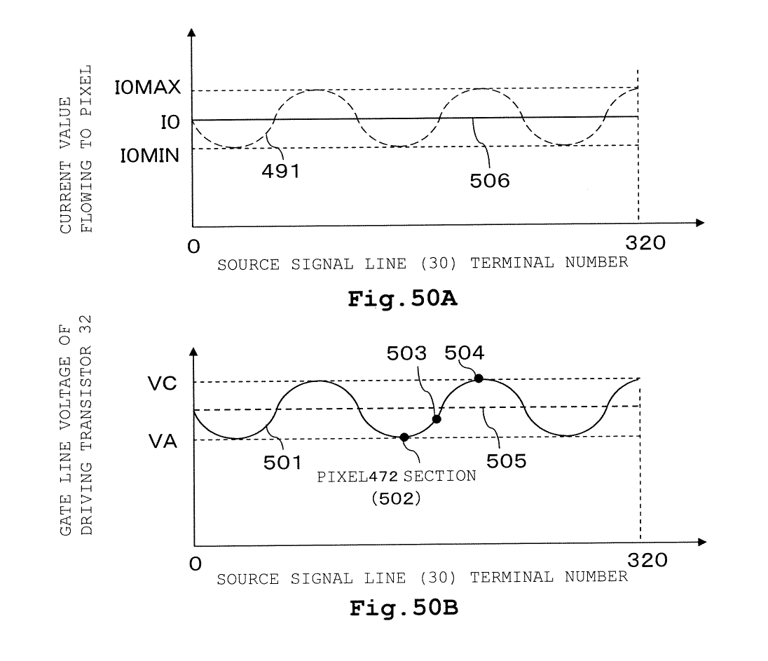

A state of a voltage distribution applied to the gate electrode of the driving transistor 32 in the case of the output current distribution in FIG. 49 is shown in FIG. 50B. This is a distribution of pre-charge voltage values. By changing a pre-charge voltage for each output terminal in this way, it is possible to fix current values flowing to the pixels at the current of about 10 as indicated by 506 in FIG. 50A.

A potential change for one row is shown in FIG. 50B. However, if a voltage value with an 10 output is applied to the other rows as a pre-charge voltage in the same manner, it is possible to realize uniform black display over the entire screen.

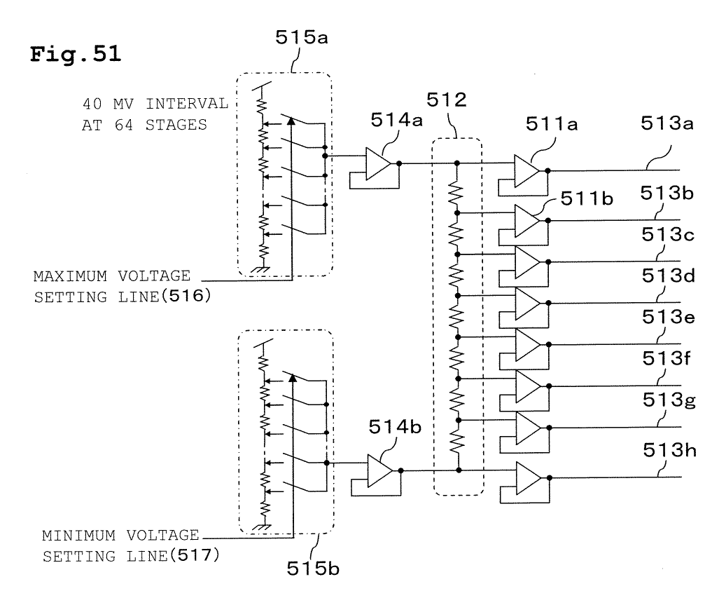

In order to change the pre-charge voltage for each output terminal, a pre-charge voltage generating section that can supply plural voltages is required. A circuit configuration of the pre-charge voltage generating section is shown in FIG. 51. The pre-charge voltage generating section is different from the pre-charge voltage generating section 323 in the past in that the pre-charge voltage generating section can supply plural voltages and can change maximum and minimum values of the plural voltages with electronic volumes 515.

In FIG. 51, first, a maximum volume is supplied from an amplifier of 513a by an electronic volume 515a for determining a maximum voltage. On the other hand, a minimum voltage is supplied from an amplifier of 513h by an electronic volume 515b for determining a minimum voltage. As an intermediate potential, voltages divided by a resistance element 512 are supplied through buffers 511. Voltages of six values 513b to 513g are supplied. In this example, eight kinds of voltages can be supplied.

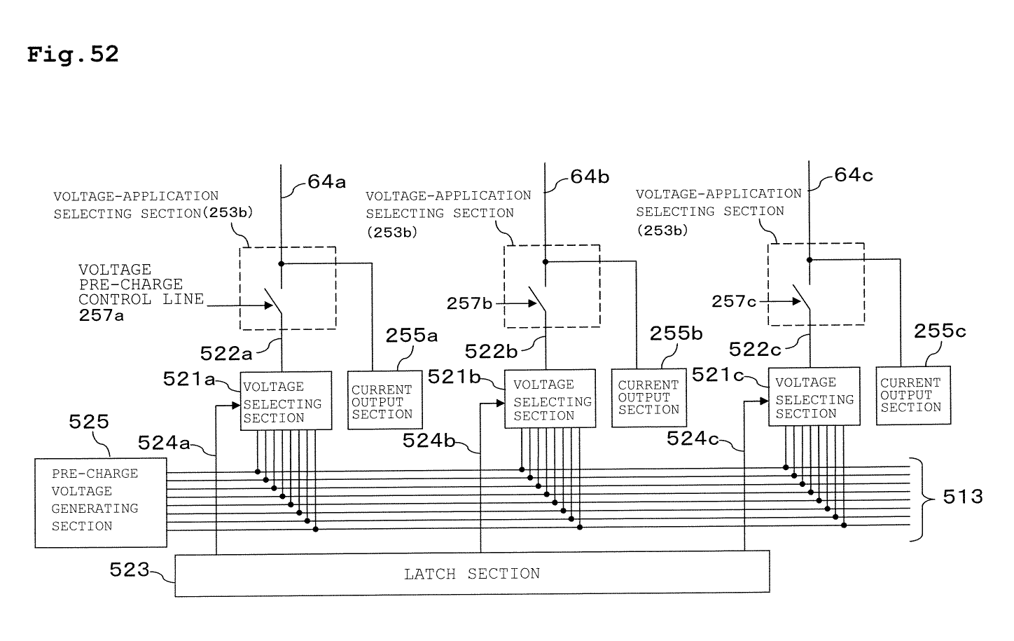

To make it possible to change the eight kinds of voltages for each of the pixels, it is necessary to distribute eight voltage outputs of a pre-charge voltage generating section 525 to respective outputs and make it possible to select one of the voltages of the eight values for each of the pixels. A part of the structure of a source driver output in this case is shown in FIG. 52. In this structure, a voltage selecting section 521 for selecting one voltage value is arranged for each of the pixels right before the voltage-application selecting section 253. To make it possible to individually set a control signal for selecting a voltage value (a pre-charge voltage value selection signal) for each of the outputs, a latch circuit is provided for each of the outputs such that voltage values can be held during one horizontal scanning period. Consequently, when voltage pre-charge is selected by the pre-charge judgment line 251, a voltage pre-charge control line 257 is connected to the output 64. When the voltage pre-charge control line 257 is connected to the output 64, one voltage selected out of the voltage values of the eight values can be outputted.

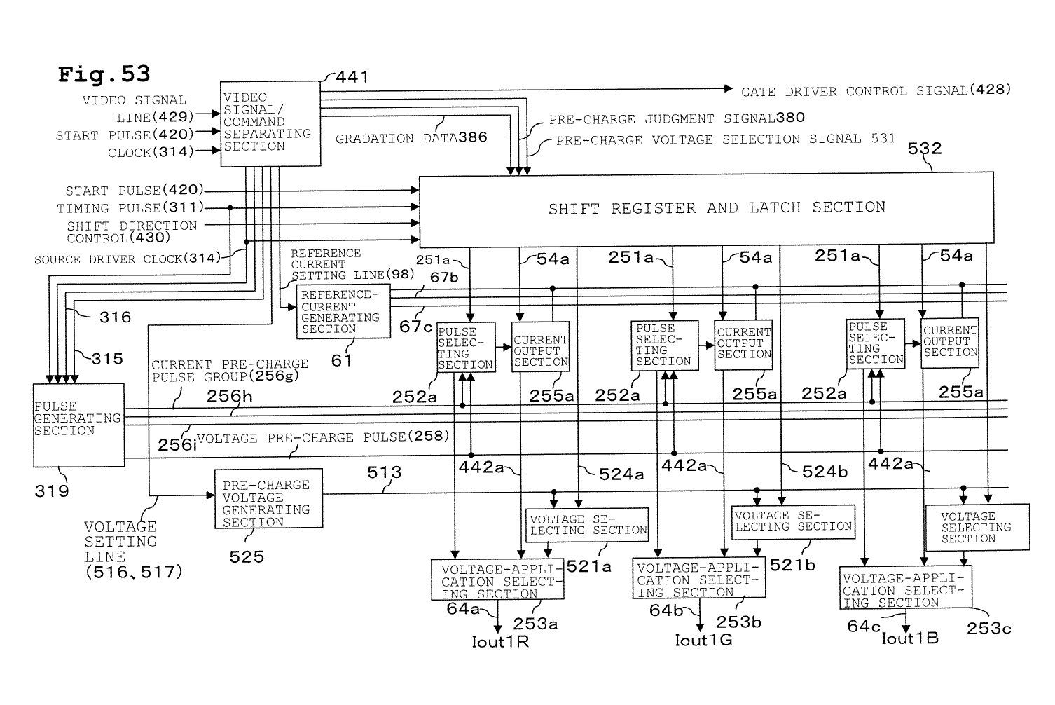

The structure of a driver IC is shown in FIG. 53. A pre-charge voltage selection signal 531 is inputted from the outside such that the eight value voltages can be individually outputted for each output terminal. If the voltages are stored for the respective outputs in the latch section 384 and the pre-charge voltage selection signal 531 is individually set for each of the pixels, an optimum voltage value can be selected for each of the pixels. Since an output of the latch section 384 is inputted to the voltage selecting section 521 by a pre-charge voltage selection signal 524, in one pixel writing time, the same voltage can be continuously outputted.

The maximum and minimum voltages of the eight values can be set by voltage setting lines 516 and 517 from the outside according to a command input. Thus, it is possible to set an optimum output value for each of the panels mounted with the driver IC according to a command.

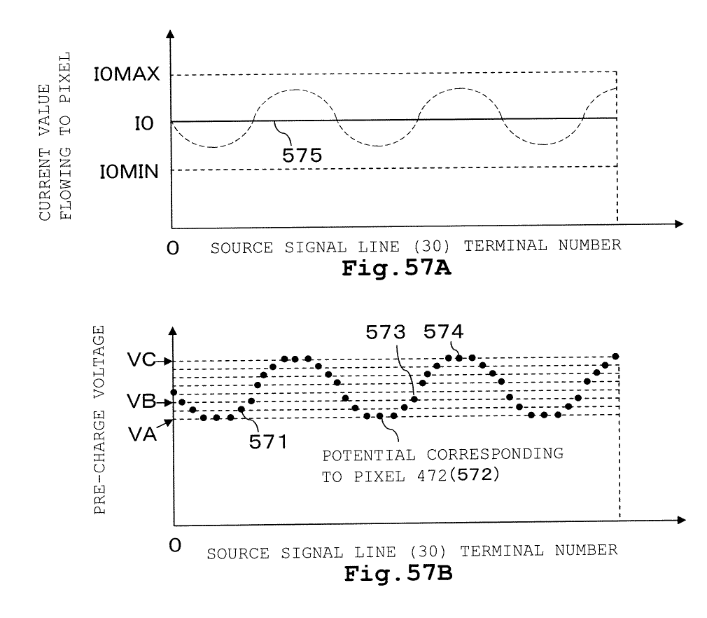

In the case of the panel having the characteristics in FIGS. 47 to 49, the maximum-voltage setting line 516 sets the voltage VC to be outputted from the amplifier of 514. The minimum-voltage setting line 517 sets the voltage VA to be outputted from the amplifier of 514. Consequently, as indicated by respective points in FIG. 57B, a pre-charge output is set for each terminal. As a result, respective pixel currents indicated by 575 in FIG. 57A is obtained.

Therefore, it is necessary to detect a gate potential of the driving transistor 32 at 10 for each of the pixels.

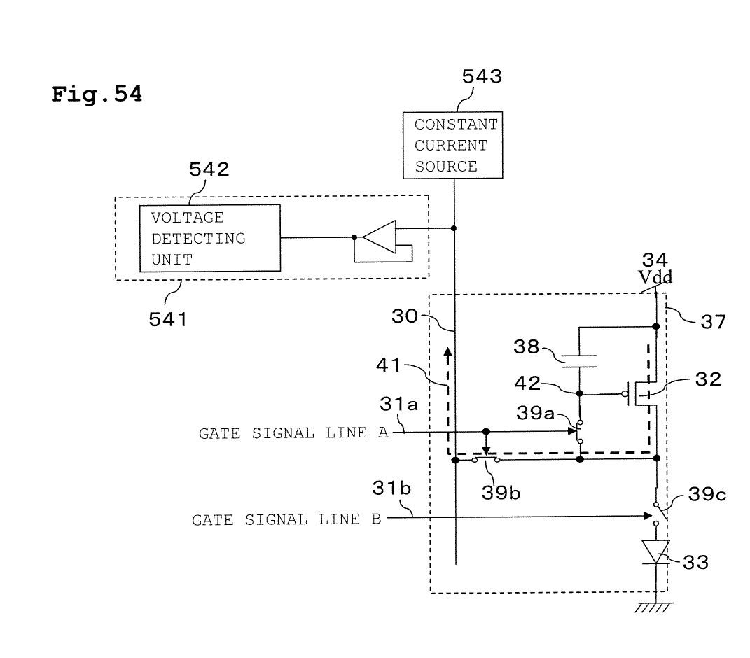

In the case of a pixel structure of a current copier, a gate voltage at the time when a “certain current (11)” is flowing to the driving transistor 32 as shown in FIG. 54 is identical with a potential of the source signal line 30. Thus, if a voltage of the source signal line 30 at the time when an electric current is written in the pixel circuit 37 from a constant current source 543 is detected by a voltage detecting unit 542, a V1 voltage with respect to a current value of V1 can be measured. Since the source signal line 30 is in a high resistance state, for voltage detection, it is preferable to connect the source signal line 30 via an operational amplifier or the like to prevent noise from propagating to the source signal line 30 and make it possible to measure the V1 voltage at a stable potential.

When it is difficult to accurately supply an electric current 0 from the constant current source 543 and a potential is different for each of the pixels 37, a stabilization time until a true voltage value is obtained is long. Thus, it is anticipated that the measurement takes time. Since charging and discharging of a stray capacitance of the source signal line 30 with an electric current equal to or smaller than an order of pA takes time equal to or longer than an order of second, it is realistically difficult to use this for measurement.

Thus, the inventor considered measuring electric currents and voltages at different two points near I0 and calculating a voltage V0 equivalent to I0 from the two points.

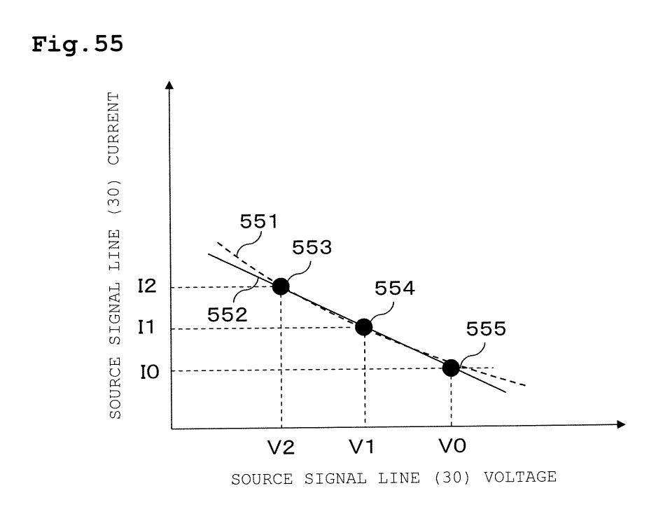

From the characteristic of the driving transistor 32, a voltage-current characteristic of the source signal line 30 is represented by a dash line indicated by 551 in FIG. 55. When a point 12 is near from I0, V0 with respect to I0 may be interpolated by linear approximation from points of I1, I2, V1, and V2 as indicated by 552. A point of 555 calculated in this way is V0. This voltage only has to be set as a pre-charge voltage.

V0 is calculated as follows: V0=(V2−V1)/(I2−I1)×I0+V1−(V2−V1)/(I2−I1)×I1.

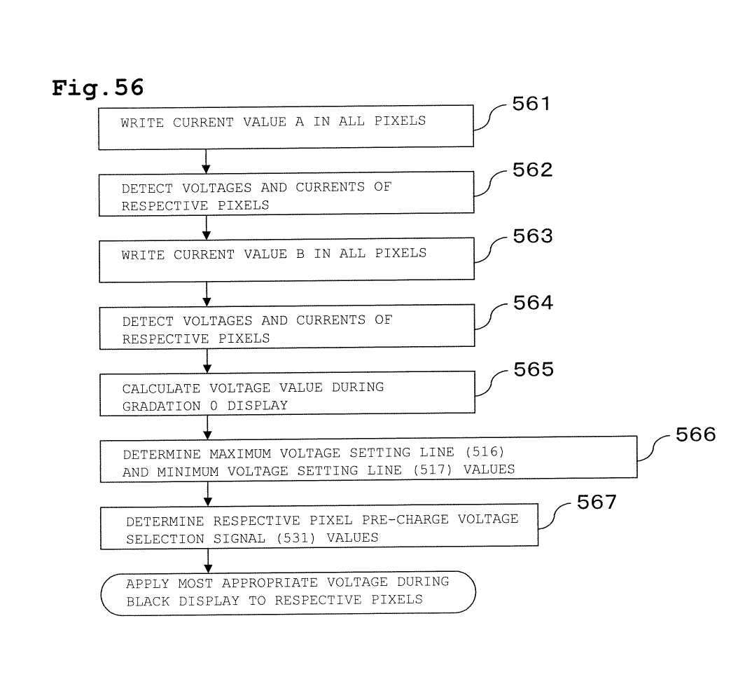

A flow for calculating and applying an optimum voltage for each of the pixels is shown in FIG. 56.

In order to calculate voltages equivalent to a gradation 0 of the respective pixels, two different electric currents are fed and current values and voltage values are measured, respectively. It is difficult to measure a value of an electric current flowing through the organic light-emitting element for each of the pixels. Thus, it is also possible that a value of an electric current flowing to a cathode power supply line that supplies an electric current to a cathode electrode of the organic light-emitting element 33 is measured and a value obtained by dividing the current value by the number of pixels simultaneously lighting is calculated as one pixel current. In this case, identical gradation display needs to be performed over the entire screen. In a module construction, it is not possible to directly designate I1 and I2, and a current is dictated by an input gradation. In this case, V0 can be determined by inputting certain gradations L1 and L2, determining I1 and I2 according to a measured cathode current, and using a voltage for a pixel at the time of L1 as V1 and a voltage for a pixel at the time of L2 as V2.

Subsequently, as indicated by 565, gradation 0 display voltages (V0) are calculated on the basis of a result of the measurement.

A maximum value and a minimum value are detected on the basis of the calculated V0 voltages of the respective pixels to determine a maximum voltage setting line 516 and a minimum voltage setting line 517 (566).

Subsequently, the number of voltages (e.g., eight kinds) that can be set are determined from the number of pre-charge voltages that can be outputted by the source driver 36. Voltage values with smallest errors with respect to voltage data of respective outputs calculated in 565 are selected one by one to determine pre-charge voltage selection signals 531 corresponding to the respective pixels.

Consequently, optimum voltage values during black display can be applied to the respective pixels during voltage pre-charge.

It is necessary to input optimum values different for each of the panels to the maximum voltage setting line 516, the minimum voltage setting line 517, and the pre-charge voltage selection signal 531. Therefore, it is necessary to store the values in ROMs or the like associated with the panels in a one to one relation. Conversely, voltage values outputted to the respective pixels are determined on the basis of data stored in the ROMs. In synchronization with respective pixel data, a pre-charge voltage selection signal is inputted from the ROM 422 to the source driver 36 through the control IC 28.

Since it is necessary to manage ROM data integrally with the panels, it is necessary to measure a voltage during gradation 0 display after the panels and the ROMs are assembled as a module.

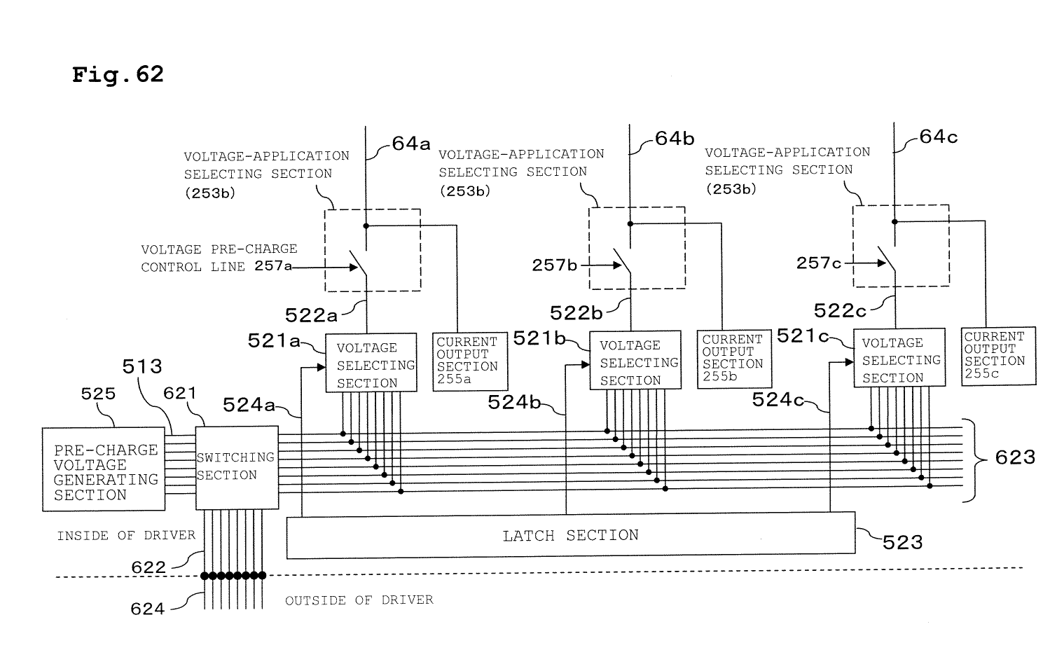

As an example of the voltage detection method shown in FIG. 54, the inventor devised a method of reading out a voltage to the outside via the source driver 36. A circuit configuration added to the driver 36 is shown in FIG. 62. In the added circuit configuration, a switching section 621 is provided in an output of the pre-charge generating section 525 and a path that can directly connect signal lines for voltage output 623 of eight values to an external terminal is added. Consequently, a signal line (one of the signal lines for voltage output 623) selected by the voltage selecting section 521 is connected to a driver external terminal by a signal line 622 via the switching section 621. If a switch is brought into a conduction state by the voltage pre-charge control line 257, the signal line is connected to a source signal line via the output 64. Thus, a voltage of the source signal line 30 can be measured by potential measurement of an external terminal 624. When the selection by the voltage selecting section 521 is identical in plural terminal outputs of the source driver, all the signal lines 522 corresponding to the outputs and one of the signal lines for voltage output 623 come into a connected state. Thus, in this state, when two or more of the voltage pre-charge control lines 257 among the corresponding outputs transmit signals for bringing switches into a conduction state, plural source signal lines come into a connected state. Therefore, it is necessary to prevent the plural voltage pre-charge control lines 257 from simultaneously bringing the switches into a conduction state.

For example, in order to measure voltages of all the pixels with one external connection terminal (624), it is necessary to set all the voltage selecting sections 521 to an identical value (depending on a terminal 624 in use) and control two or more voltage pre-charge control lines 257 not to be a high level at certain timing. (It is defined that the switches come into a conduction state at the high level.)

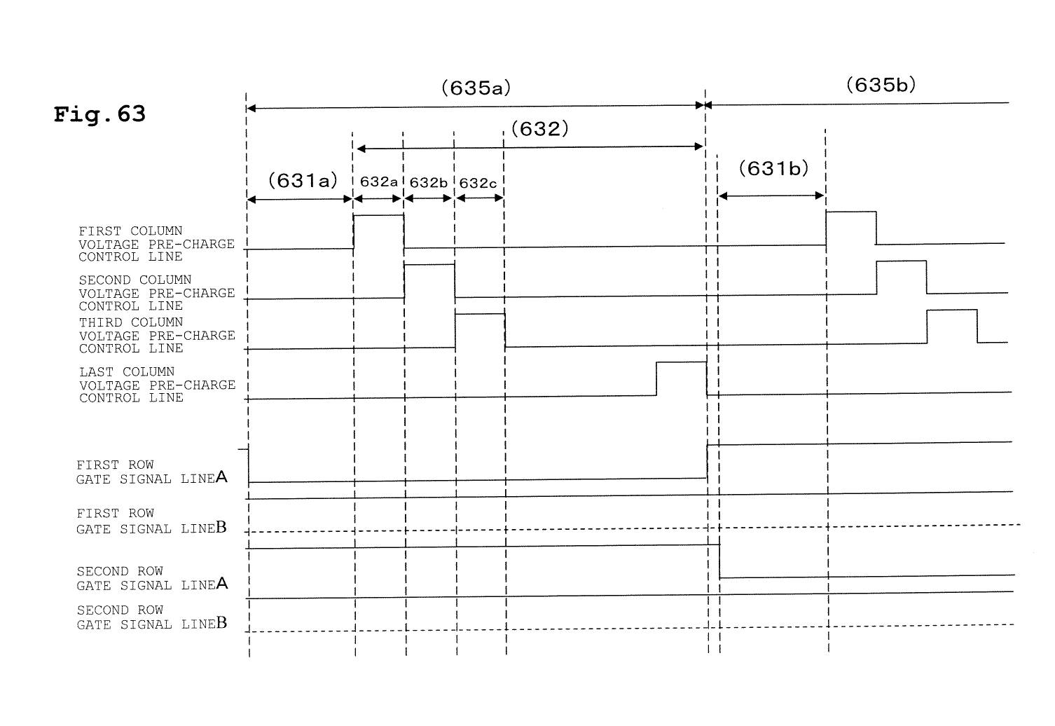

Signal waveforms for reading voltage values of all the pixels are shown in FIG. 63. Time for reading out data of one row is a period indicated by 635. Periods 635 are repeatedly present for the number of display rows. Electric currents and voltages are measured by continuing to output an identical gradation current in all outputs from the current output section 255 of the source driver 36 in this period. Values of I1 and I2 are selected and determined from a range of gradations that can be outputted by the source driver 36.

In a state in which a pixel in a first row is selected (an electric current flows to the driving transistor 32) in the period 635a, first, as indicated by 631, a period in which no pixel reads out a voltage for a fixed period is provided. This is for the purpose of setting time necessary for changing, when a charge different from a measurement object is accumulated in the stray capacitance of the source signal line 30 in an immediately preceding state, the state to a state in which a predetermined current is written. Consequently, before reading out a voltage of the first pixel, it is possible to set a voltage state depending on performance of the driving transistor 32 regardless of the immediately preceding state. This period is set to about 1 ms. In this case, when an electric current of about 50 ns is fed, even if there is a potential change of about 1 V, it is guaranteed that the voltage reaches a predetermined voltage by the time of measurement. The period 631 is determined from a capacitance value of the source signal line 30, a current value written in the source signal line 30, and an estimated potential change amount. The period 631 only has to be about twice as large as a value of (source line capacity)×(potential change amount)/(writing current value).

Thereafter, an operation for reading out a voltage for each of the pixels is carried out (a period indicated by 632). In this period, the voltage pre-charge control line 257 is set to a high level for each of the outputs and a potential of the source signal line 30 of the pixel corresponding to the voltage pre-charge control line 257 is read out. In order to surely read out a potential, a pulse width is set to secure a readout time equal to or longer than 100 microseconds for each of the pixels.

To realize this operation, the pre-charge judgment line 251 of an output corresponding to the voltage pre-charge control line 257 selects a value (7 in the example of the driver here) for carrying out only voltage pre-charge. The voltage pre-charge pulse 258 is always set to be at a high level. In other outputs, a value of the pre-charge judgment line 251 is set to 0 to prevent the voltage pre-charge control line 257 from being at a high level. By repeatedly performing this operation for all the outputs, readout of all the pixels in the identical row is completed in the period 632.

Subsequently, control of the gate driver is performed to bring a gate signal line A in a second row into a conduction state and start a measurement operation for the second row. By repeatedly executing this operation to a final row, measurement of gate voltages of the driving transistor 32 in all the pixels is completed.

By executing the operations in 562 and 564 shown in FIG. 56, original data for voltage calculation during gradation 0 display could be measured. A pre-charge voltage corresponding could be supplied to a pixel.

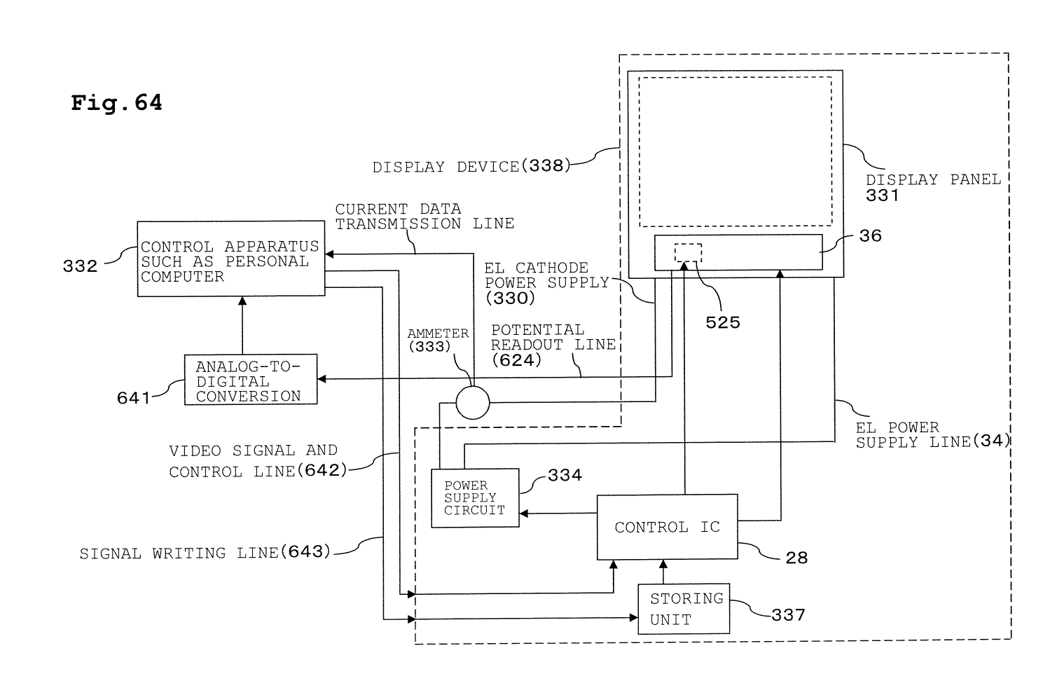

The structure of an adjusting device for determining an applied voltage for each of the pixels during gradation 0 display is shown in FIG. 64. The adjusting device is characterized in that it is possible to draw out a voltage to the outside of a module of the drive 36 having a function of detecting a gate voltage of the driver transistor 32 at the time when a certain electric current is fed to the pixel and input voltage value data to the control apparatus 332 such as a personal computer through an analog to digital converter 641. Since the pre-charge voltage judgment signal 531, the maximum voltage setting line 516, and the minimum voltage setting line 517 have different values for each of the panels. Therefore, the storing unit 337 is mounted on the module to make it possible to perform different setting for each of the panels. A voltage value can be written in the storing unit 337. Since the storing unit 337 needs to hold a value even during power-off, the storing unit 337 needs to be formed of a nonvolatile storage element.

Voltage values of the respective pixels during gradation 0 display are determined in accordance with a process indicated by 561 to 565 in FIG. 56. Voltage values can be detected by using data inputted to the control apparatus 332 such as a personal computer by the analog to digital converter 641. Current values can be detected by inputting a value of the ammeter 333 provided in the EL cathode power supply 330 to the control apparatus 332. Voltage data of the respective pixels during gradation 0 display are calculated on the basis of the inputted data.

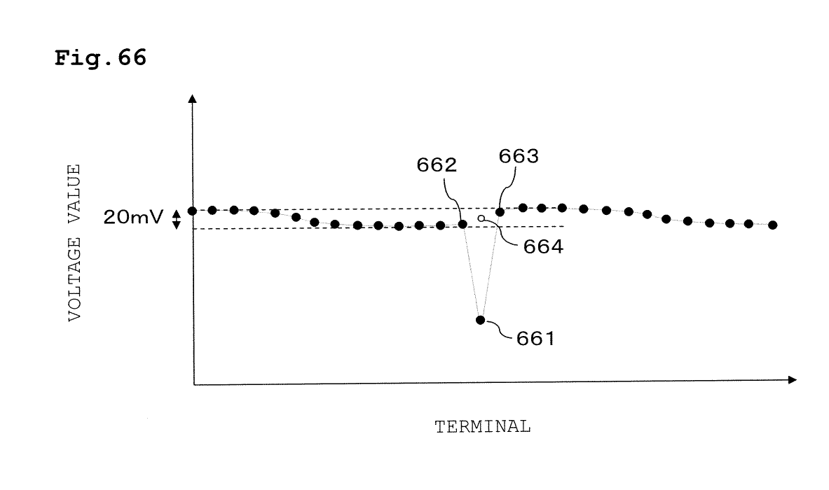

It is likely that, in the voltage calculation process, a voltage value considerably different from that of an adjacent pixel is detected. An example of a distribution of voltage values of respective pixels connected to a certain source signal line 30 is shown in FIG. 66. A point 661 considerably different from other points is observed. It is likely that this point is affected by a short or open state of transistors due to defects of the transistors in the pixels or an EL power supply voltage due to a defect or the like of a storage capacitor. On a screen, this point is equivalent to a pixel at a light-on point or a light-off point. Since this does not straightly indicate the characteristic of the driving transistor 32, it is necessary to discard the point as an abnormal point. A potential of the point is calculated by interpolation from voltages of adjacent pixels 662 and 663. (A potential of 664 is set as a necessary voltage value.)

A 3σ value of a set of voltage data is calculated and a value deviating from 3σ is set as abnormal data.

Thus, for reduction of a necessary capacity of the storing unit 337 and reduction of electric power due to data access, the inventor considered using identical pre-charge voltage judgment data in pixels having similar characteristics.

When a laser is irradiated to polycrystallize an irradiated area as indicated by 471 in FIG. 47, pixels arranged in the vertical direction are less affected by characteristic fluctuation compared with those arranged in the horizontal direction.

A voltage distribution of pixels arranged on an identical source signal line is shown in FIG. 66. In this example, voltage values are distributed in a range of about 20 mV excluding the abnormal data. Thus, the abnormal data is removed, an average value of the voltage values is calculated using interpolation data 664, and the calculated average data is determined as a pre-charge voltage value for this source signal line. By performing this work, voltage value data for the number of pixels required in the past was reduced to voltage value data for the number of pixels in the horizontal direction. A data amount stored in the storage element could be reduced.

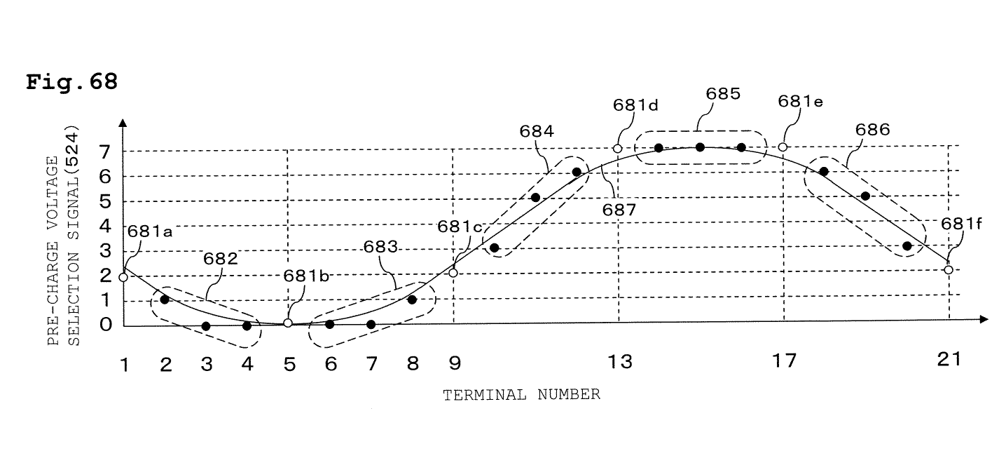

Concerning the horizontal direction, when a frequency characteristic of a distribution of characteristic fluctuation in the driving transistor 32 is low, it is possible to calculate necessary voltage data by sampling one data for every several pixels and linearly interpolating two sampling data in the remaining data. For example, when an optimum value of a pre-charge voltage shown in FIG. 57 is different at a 20 terminal period, if at least data for every five outputs are held, the remaining data can be calculated from the held data and a calculation result of a value generally identical with an original voltage distribution is obtained. For example, even when a voltage distribution is present in a curve indicated by 687 in FIG. 68, only data of terminals indicated by 681 are held in the storing unit 337 and points in the middle are calculated. For example, three points indicated by 682 are calculated from two points 681a and 681b. Three points indicated by 683 are calculated from two points 681b and 681c. In this case, a pattern of voltage application substantially without an error can be realized compared with the case in which all the data are stored.

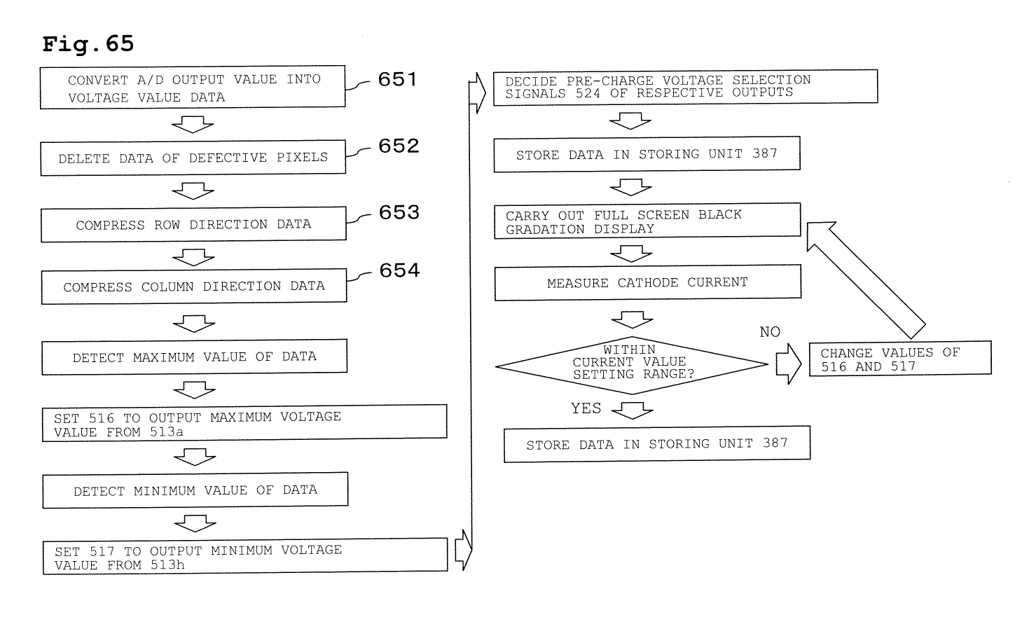

A method of causing the storing unit 387 to store voltage values during black display of the respective pixels is performed according to the flow shown in FIG. 65 and display without unevenness during black display is realized while reducing a storage capacity.

After the voltage values during gradation 0 display are calculated, first, as explained with reference to FIG. 66, data indicating abnormal potential fluctuation due to a defective pixel is removed (652).

Data for several rows are compressed to one data by an averaging method using the characteristic of the fluctuation distribution of the pixel transistor (a characteristic that fluctuation in the vertical direction is small in FIG. 47) (653).

Concerning a column direction, taking into account a change in a gate potential of the pixel transistor 62 at the time when an identical current flows, data stored in a range in which a state of the change can be reproduced is curtailed (654, see FIG. 68).

Subsequently, the voltage data is converted to be represented by the maximum voltage setting line 516, the minimum voltage setting line 517, and the pre-charge voltage selection signal 531 such that the voltage data can be outputted using eight value voltages of the pre-charge voltage generating section 525.

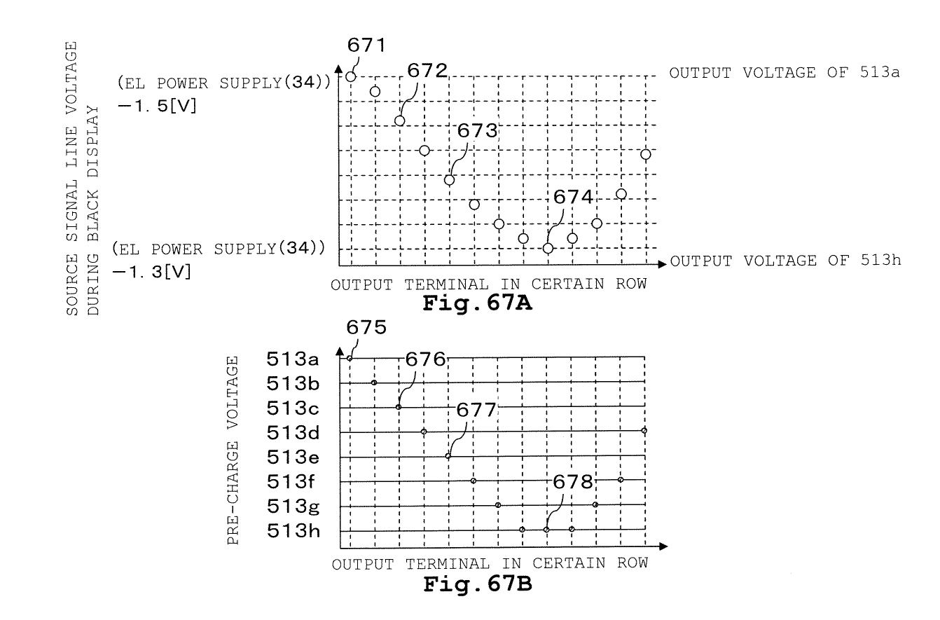

As shown in FIG. 67A, first, a maximum value and a minimum value are detected in a distribution of source signal line voltages. In this case, a point 671 indicates a maximum value having a voltage value of ((EL power supply 34)-1.5) V. This value only has to be a maximum voltage value in the pre-charge voltage generating section 525. Thus, the electronic volume 515a is operated to set a voltage value 513a to ((EL power supply 34)-1.5) V according to the control of the maximum voltage setting line 516. Concerning the minimum value, the minimum voltage setting line 517 is set such that a voltage value at a point 674 is a voltage 513h. Consequently, all voltage values of the eight value voltages are decided. Six value voltages in the middle are designed such that voltage values equally divided by the resistance element 512 are outputted from the circuit configuration in FIG. 51.

In this case, voltages are supplied from the buffer 511 at intervals of about 28.6 mV set by dividing 0.2 V into seven. Therefore, an output deviation of the buffer 511 needs to be accurately set to be equal to or smaller than 10 mV.

Since the eight value voltage outputs are supplied at intervals of 28.6 mV with respect to the source signal line voltage, an identical voltage cannot always be supplied. For example, voltages at terminals 672 and 673 do not coincide with the eight value voltage outputs. In this case, any one of close voltage values is selected as shown in FIG. 67B. In the case of 672, a point indicated by 676 is selected. In the case of 673, a point indicated by 677 is selected. Since pre-charge voltages 513a to 513h are allocated to 0 to 7 of the pre-charge voltage selection signals 531, the pre-charge voltage selection signal 524 is decided on the basis of a graph in FIG. 67B. Consequently, all data necessary for voltage pre-charge during black display are decided. The data are stored in the storing unit 387.

Full black display is performed on the basis of the data finally stored and a current value of the EL cathode power supply 330 during black display is measured. When the current value is within a defined range, the data in the storing unit 387 are held as they are and the adjustment is finished.

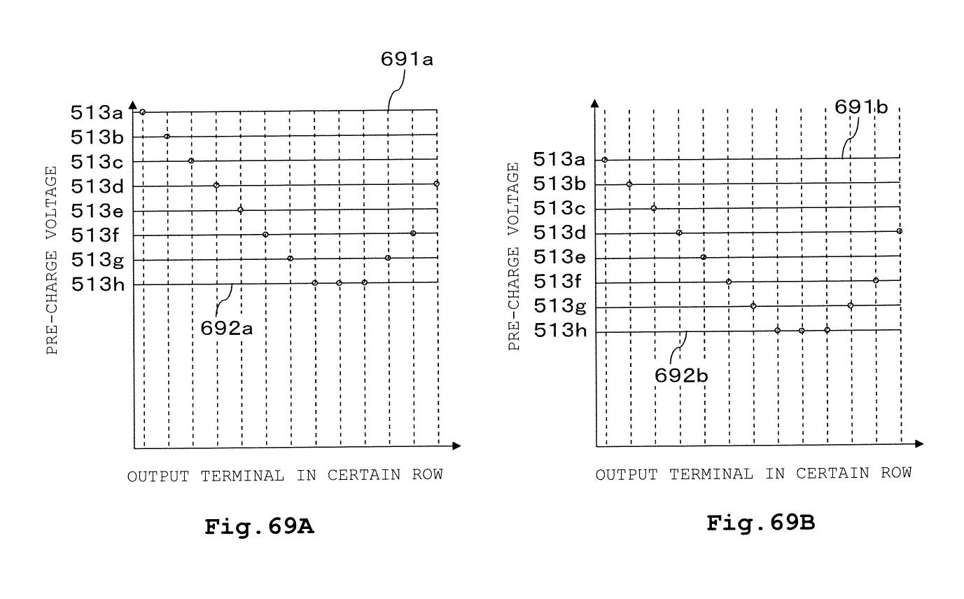

On the other hand, when the current value is outside the defined range, it is possible that the luminance during black display is too bright or too dark. For correction of the current value, values of the electronic volume control signals of the voltage setting lines 516 and 517 are changed. Assuming that a set current value during black display is 0.1 mA, when a measurement value is 0.05 mA, pre-charge voltage values of all the pixels are set low such that an electric current flows. In setting of voltage values shown in FIG. 69A, all voltage values of eight values are lowered by a fixed value as shown in FIG. 69B. At this point, a voltage 513a changes from 691a to 691b according to a control signal of the voltage setting line 516. A voltage 513h changes from 692a to 692b according to a control signal of the voltage setting line 517. This setting is repeatedly carried out until a cathode current value fits in a set range. As a result, it is possible to keep luminance during black display at a substantially fixed value regardless of the panels.

As a method of carrying out black display on the basis of the storing unit 387, first, data of the maximum voltage setting line 516 and the minimum voltage setting line 517 are invoked and an output of the pre-charge voltage generating section 525 is decided. Subsequently, a value of the pre-charge voltage selection signal 524 is read out from the storing unit 387 and supplied to an output corresponding to the signal. Concerning the selection signal 524 of a terminal not present because of data compression, data is created by linear interpolation from two data close to each other. In FIG. 68, data indicated by 682 to 686 are data calculated by the interpolation. For example, the data 686 is calculated from data 681e and 681f. Here, because of data compression in the row direction, an identical pre-charge voltage value is always outputted in an identical source signal line. Therefore, an identical value is always held in the latch section 523 that latches a control signal for selecting a voltage value. In FIG. 53, the control signal is held by the latch section 532 for two rows in the same manner as the video signal. However, in this embodiment, only a latch circuit for one row is enough for a signal for selecting a pre-charge voltage. Thus, it is possible to reduce a circuit size.

Besides the pixel structure of the current copier, the effect of unevenness reduction during black display by voltage readout of the driving transistor 32 can also be realized by the pixel structure of the current mirror shown in FIG. 5. This is because, in the circuit configuration of the current mirror, as in the circuit configuration of the current copier, since an equivalent circuit during voltage measurement is the circuit in FIG. 54 and a gate potential of the driving transistor 32 is identical with that of the source signal line 30, a potential of the source signal line 30 only has to be measured.

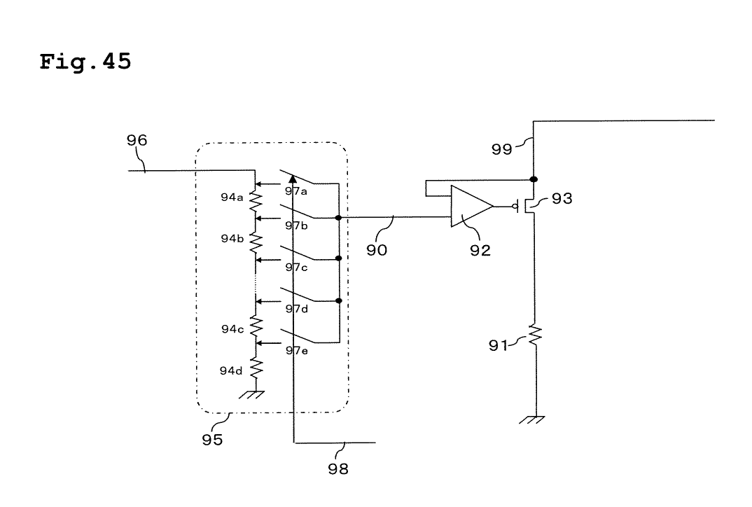

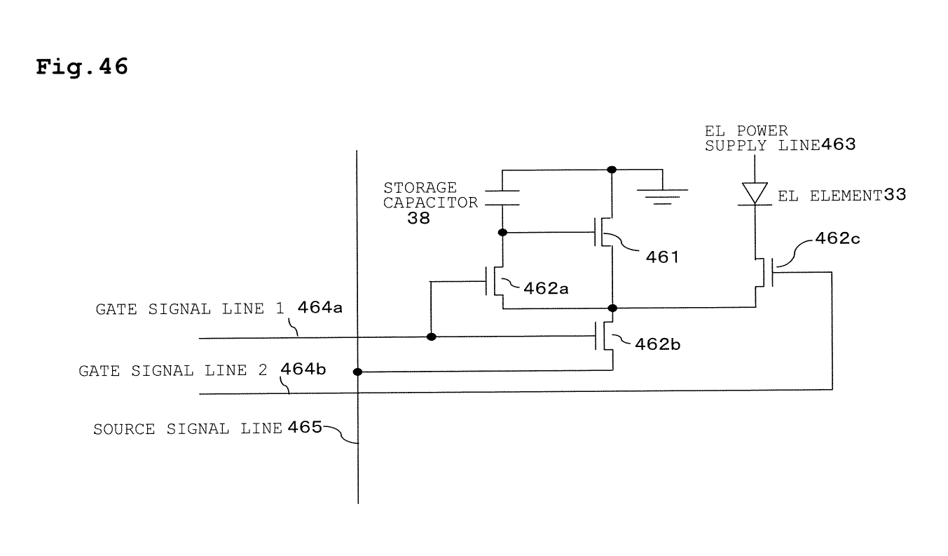

In the above explanation, the driving transistor 32 used for the pixels is the p-type TFT. However, the present invention is also applicable when the driving transistor 32 is an n-type TFT shown in FIG. 46. It is sufficient to cause the reference current line to generate an electric current in an opposite direction as shown in FIG. 45, the current source for gradation display 63 is formed of the p-type TFT in the output section 65 as well, and an electric current is fed to the driver IC output. A sourced signal line potential with respect to a gradation is higher in a gradation closer to a white gradation. (A potential relation is opposite to that described above.) Pre-charge is also applicable if a pre-charge voltage is set to a lowest voltage in black display and a source signal line potential is increased by current pre-charge.

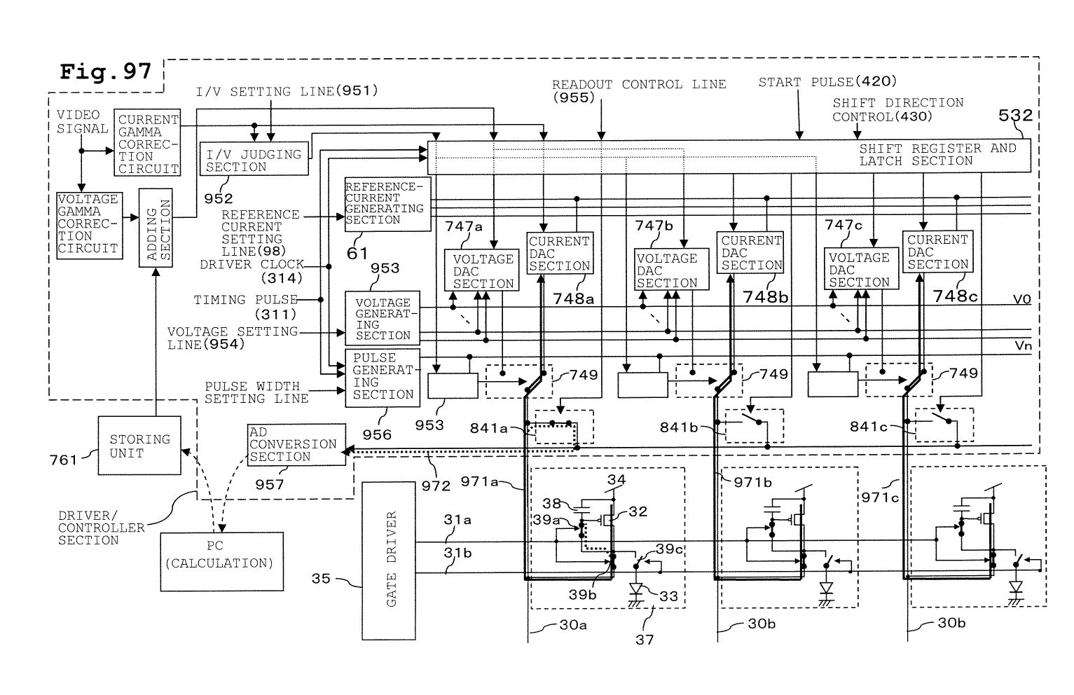

In the following explanation, an active matrix display device shown in, for example, FIG. 97 is more specifically explained. The active matrix display device includes a storing unit 761 for storing compensation data for applying, according to a characteristic of the driving transistor 32 of the pixel 37 that uses the organic light-emitting element 33, a voltage to the pixel 37 and a driver control section for applying a voltage to the pixel 37 on the basis of the compensation data stored by the storing unit 761.

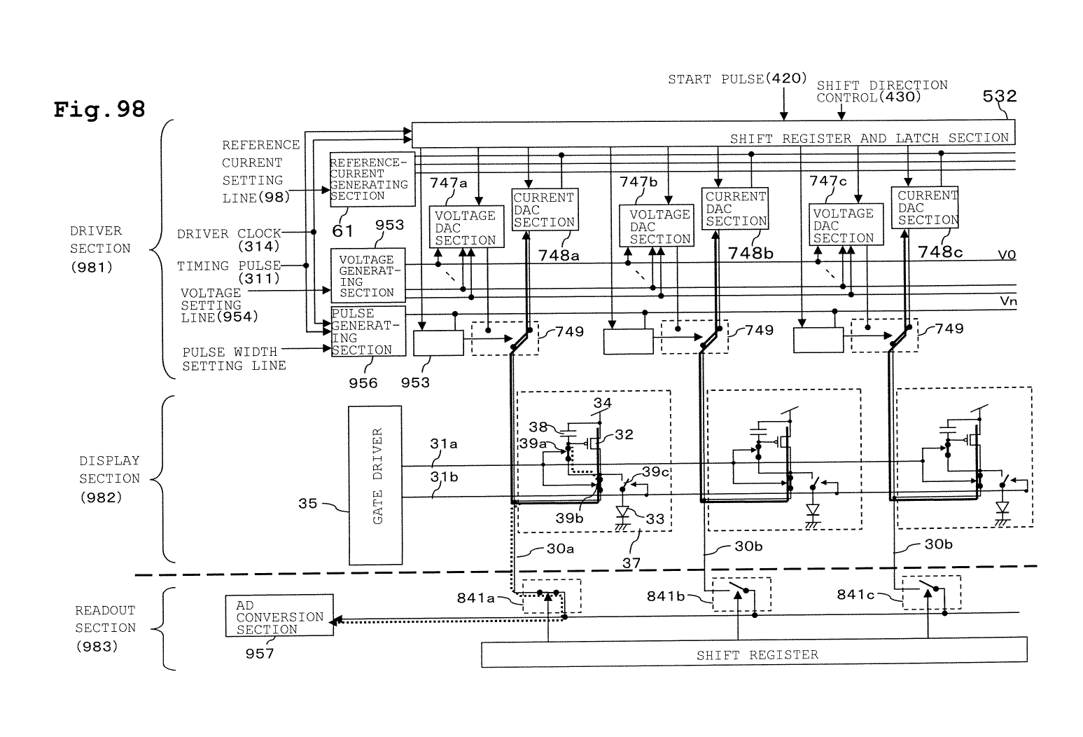

For example, the storing unit 761 (see FIG. 97) corresponds to a storing unit of the present invention. For example, the driver controller section (see FIG. 97) and a driver section 981 (see FIG. 98) correspond to a driver unit of the present invention.

For example, a readout section 983 (see FIG. 98) corresponds to a voltage detecting unit of the present invention.

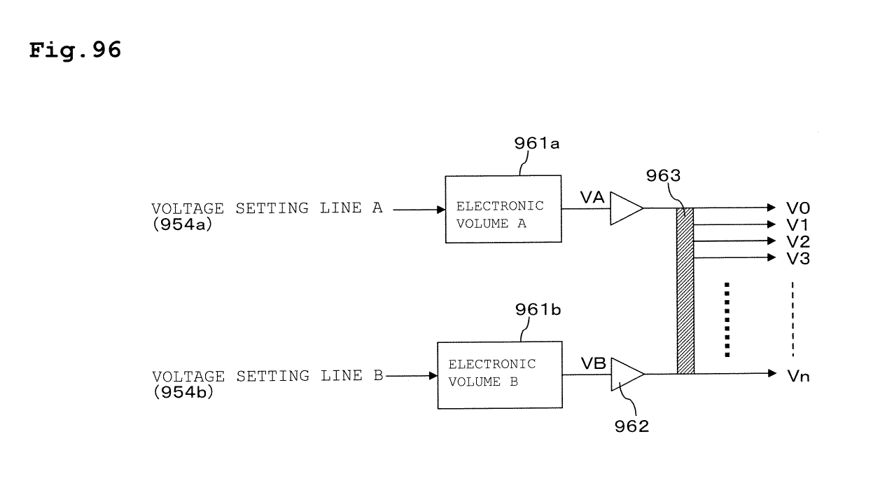

For example, an electronic volume A961a (see FIG. 96) and an electronic volume B961b (see FIG. 96) correspond to an electronic volume of the present invention.

For example, a voltage DAC section 747a (see FIG. 97) corresponds to a voltage output unit of the present invention.

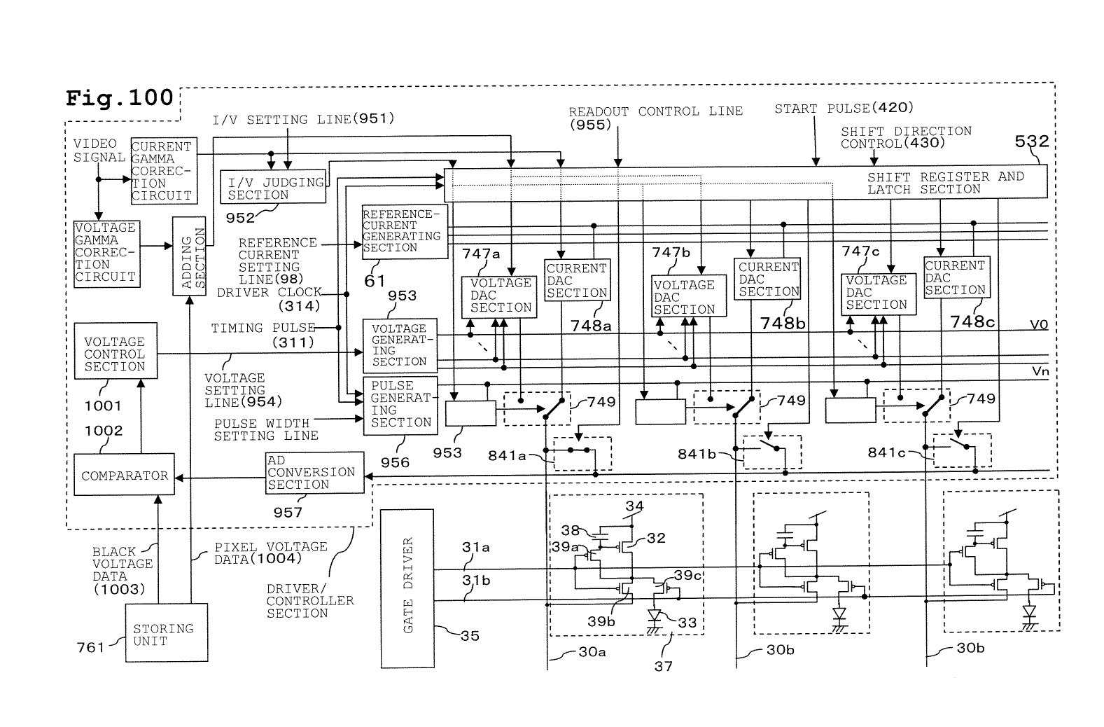

For example, an AD conversion section 957 (see FIG. 100) corresponds to an AD converting unit of the present invention. For example, a voltage control section 1001 (see FIG. 100) corresponds to a voltage control unit of the present invention.

Luminance fluctuation caused by unevenness in a characteristic of a TFT due to unevenness of laser irradiation is explained with reference to FIG. 47. In this example, a laser is irradiated at identical timing along the source signal line and, in the horizontal direction, the laser is irradiated in an area with a certain degree of width.

When an irradiation width of the laser is narrow and the laser is irradiated at different timing for each of the pixels, it is likely that a TFT characteristic is different for each of the pixels. Depending on a setting direction of a beam of a laser irradiation device and a layout of respective panels on an array substrate, a beam of the laser may be irradiated in a direction rotated 90 degrees. Fluctuation may occur in an irradiation amount even in the area indicated by 471 in which the laser is irradiated at identical timing.

In order to cope with such fluctuation, it is necessary to grasp a TFT characteristic of each of the pixels and apply a different black voltage to each of the pixels.

In order to apply a different black voltage to each of the pixels, black voltage data corresponding to all the pixels have to be stored in the storing unit. Therefore, a capacity of the storing unit is large compared with that in the past and a storing unit having a capacity of several kilobytes is required. The storing unit is a storing unit such as a flash ROM.

It is necessary to transmit a video signal and voltage data to the source driver for each of the pixels in synchronization with each other. It is necessary to transfer the voltage data to a driver output stage according to a synchronization signal.

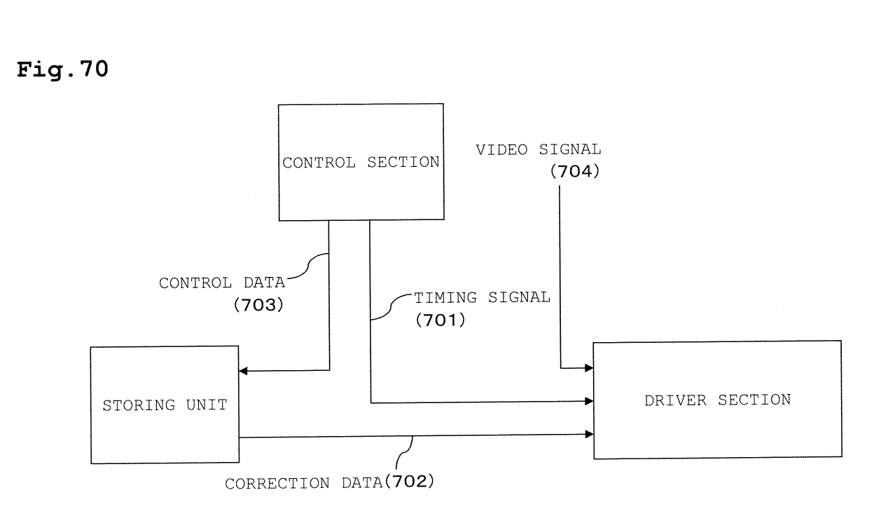

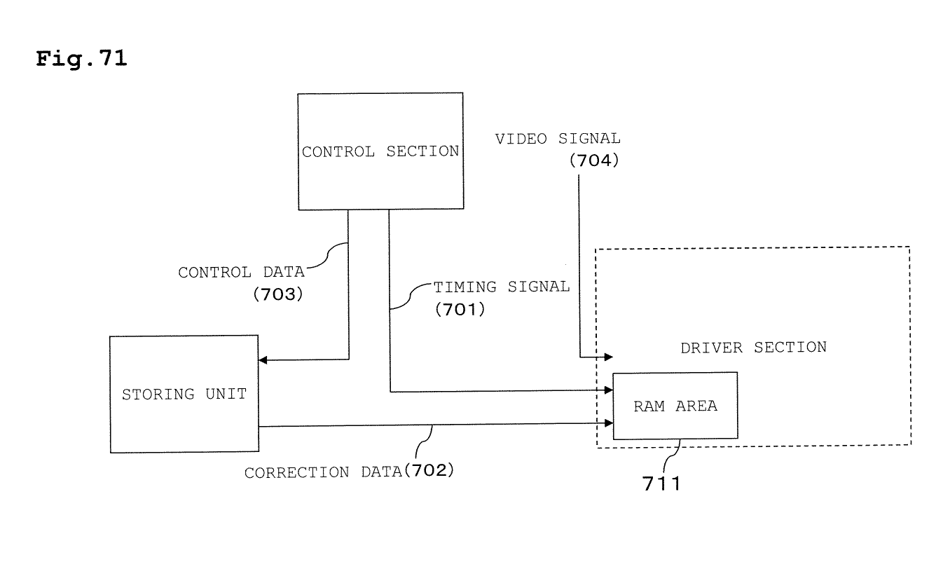

The storing unit 337 in which the voltage data is stored, the control IC 28, and the source driver 36 are connected as shown in FIG. 70 or 71.

In FIG. 70, control data 703 generated by a timing signal 701 from the control IC 28 is inputted to the storing unit 337. Correction data 702 corresponding to a pixel to be displayed is inputted to the source driver 36. The source driver 36 performs gradation display by the video signal 704 to the corresponding pixel on the basis of the video signal 704 and the correction data 702 inputted in synchronization with the timing signal 701. A black voltage is set by the correction data 702 and a voltage corresponding to fluctuation in the TFT is outputted.

In the case of this system, it is necessary to output data from the storing unit 337 for each of the pixels. The correction data 702 operates at a rate identical with that of a dot clock. Therefore, power consumption increases. However, since it is unnecessary to store data in the source driver, there is an advantage that a circuit size is small. Depending on a data bus width of the storing unit 337, there is also a method of simultaneously transferring data of plural pixels and lowering a transfer rate.

Consequently, a black voltage corresponding to TFT fluctuation of all the pixels is transmitted simultaneously with scanning of the video signal and it is possible to correct luminance unevenness of each of the pixels.

As a method of transferring correction data for each of the pixels from the storing unit 337 to the output stage of the driver, the structure shown in FIG. 71 is also conceivable.

In the structure in FIG. 71, a RAM area 711 is provided in the source driver, correction data for each of the pixels is stored in the RAM area 711, correction data corresponding to scanning is read out, and an optimum black voltage is supplied.

In the case of a RAM, when a power supply is shut down, contents held in the RAM are erased. Therefore, the storing unit 337 is also provided on the outside. When the power supply is turned on, the correction data stored in the storing unit 337 is transferred to the RAM area 711 and correction of a black voltage for each of the pixels is performed. There is an advantage that data transfer from the storing unit 337 to the source driver has to be performed only once until display after the power supply is turned on, it is unnecessary to always perform transfer in the correction data line 702, and electric power due to charge and discharge of a data bus is reduced.

Since the correction of the black voltage is applied to the pixels on the entire panel, fluctuation in voltages tends to increase. Therefore, compared with the system described above, since the interval width 10 mV is not changed, it is necessary to increase the number of bits of the voltage output section. Since there is fluctuation of about 320 mV, it is necessary to prepare 5-bit correction data for the pixels of the respective colors. In this case, data of red, green, and blue are 15 bits in total. When a ROM or the like having a 16-bit data bus is used, it is also possible to simultaneously transfer the data of red, green, and blue.

The remainder of 1 bit may be kept unused or may be used for expansion of a correction range. For example, there is a method of using, when 1-bit data is 0, values of the 5-bit data of the respective colors as they are and using, when 1-bit data is 1, values of the 5-bit data of the respective colors added with 16. In this case, whereas a correction range is up to a difference of 310 mV from 0 to 31 in the past, it is possible to expand the correction range to a difference of 470 mV from 0 to 47. Therefore, it is possible to cope with larger TFT fluctuation.

The data bus having 16-bits is explained above. However, if a ROM having a data bus of 32 bits or 64 bits is present, the number of bits of the correction data may be increased according to the capacity of the ROM. When the number of bits is increased, the correction range is widened and it is possible to perform correction of larger unevenness. However, it is preferable that the correction data has about 5 to 8 bits because of problems such as an increase in a memory capacity, an increase in a substrate area involved in an increase in a wiring area between the storing unit and the driver on the substrate, and an increase in power consumption.

In this example, the circuit configuration in which the control section and the driver section are separately provided is explained. However, even in a driver IC in which the control section and the driver section are integrated, the same circuit configuration only has to be implemented. If the driver IC is connected to the storing unit on the outside, it is possible to obtain the same effect even if the driver IC is an integrated driver.

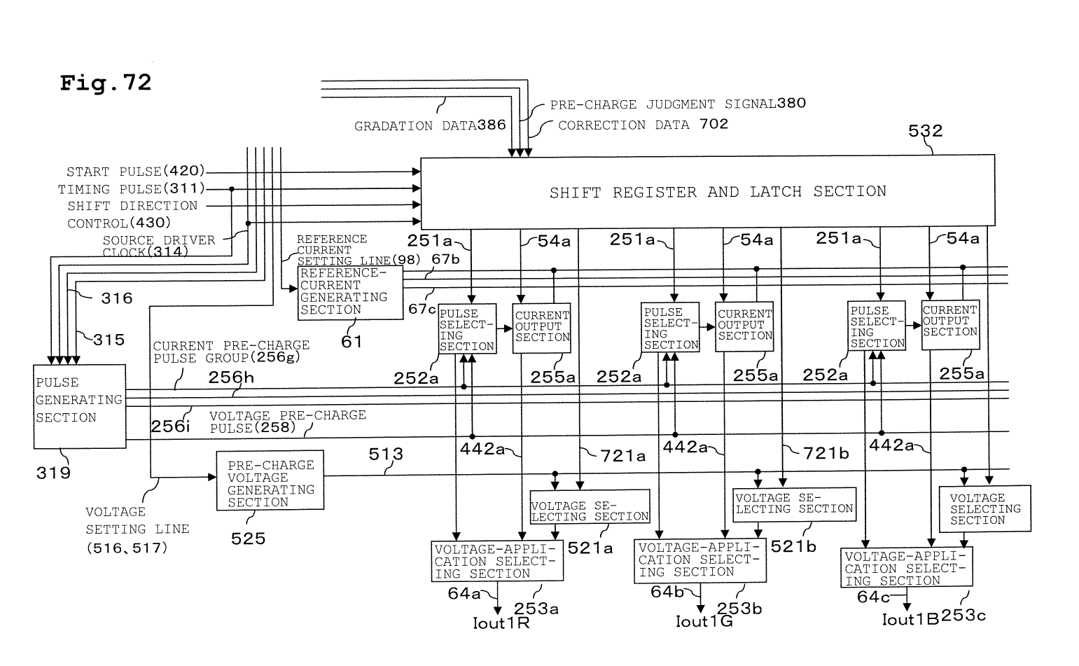

With the structure of an output section shown in FIG. 72, it is possible to perform gradation display according to a black voltage corresponding to unevenness of a TFT and a video signal on the basis of the signal for voltage correction and the video signal.

When black voltages corresponding to all the pixels are applied, it is necessary to measure gate voltages of the driving transistors 32 of all the pixels in order to calculate necessary black voltages.

Since voltage values of all the pixels are measured, the measurement takes time. As shown in FIG. 56, voltage values at current values under two conditions are measured and a voltage at a gradation 0 is calculated to create data for performing correction. Longest time is required to measure voltages of all the pixels twice.

Thus, in order to reduce the time for measuring voltages of the pixels, voltage values under only one condition are measured and a potential difference among the pixels is set as correction data. In the example in FIG. 55, although a voltage V0 corresponding to 10 is originally calculated for each of the pixels, rather than measuring two conditions 12 and 11 in the past, only an electric current of 11 is measured and a voltage of V1 corresponding to I1 is measured for each of the pixels. By storing a potential difference of V1 for each of the pixels in the storing unit as correction data, a potential difference of V0 in the past is replaced with the correction data. It is possible to correct a black level by adjusting a difference between absolute values of the voltages (a difference between V1 and V0) with a voltage fluctuation (fluctuation by the same amount for all the pixels) due to adjustment of electronic volumes commonly for all the pixels using the system shown in FIG. 34. This adjustment is performed only by a change in an electronic volume, measurement of a cathode current, and calculation of a change amount and is completed in about 5 to 15 seconds. Since the voltage measurement for all the pixels takes about 20 to 35 minutes once, it is possible to finish the adjustment earlier when the measurement and the absolute value adjustment are performed once than when the adjustment by measurement is performed twice.

Concerning an error in the method of calculating TFT fluctuation, in the case of black, in the panel in which the organic light-emitting element is used, luminance is equal to or lower than 0.001 candela and unevenness cannot be clearly seen under a dark room environment. Therefore, it is seen that there is no problem even if correction data deviates a little. On the other hand, luminance is equal to or higher than 1 candela near low gradations of 5 to 10 and unevenness can be visually recognized. It is likely that, in these gradations, a gradation current is small, an ability for correcting an error in correction data with current writing is small, and the error is visually recognized as unevenness.

Thus, unevenness is smaller in an entire gradation range when the electric current I1 is set to an electric current of about 5 to 10 gradations, voltages of the respective pixels in the electric current I1 are measured, and unevenness is corrected than when I0 is calculated from I2 and I1 and unevenness correction is performed.

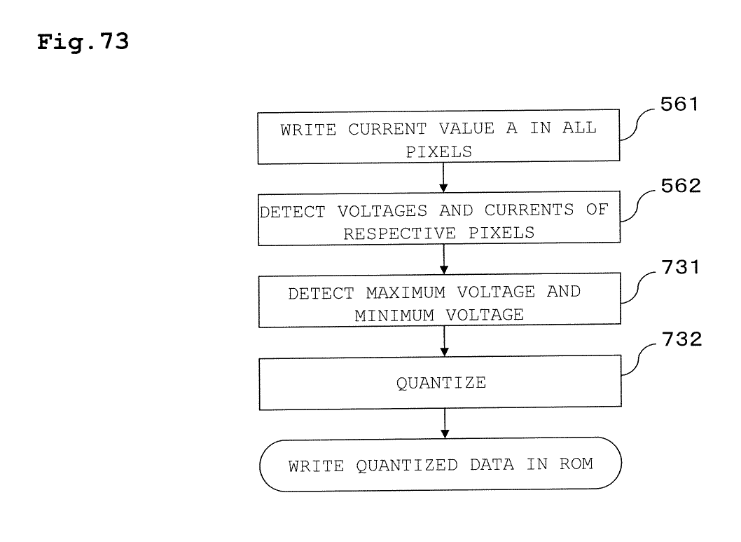

A black voltage calculation method in this case is shown in FIG. 73. Pixel potentials are measured with an electric current equivalent to 5 to 10 gradations and quantized on the basis a potential difference for each of the pixels from between a maximum value and a minimum value of the pixel potentials. (A larger value is obtained when the maximum voltage is 0 and a voltage is smaller.) An interval width of the quantization is determined according to a voltage difference per one gradation held by the voltage DAC section. For example, when the voltage DAC output is set to a 10 mV interval, a value of “5” is determined for a pixel having a potential 50 mV lower than a pixel having the maximum voltage. Quantized data is written in the storing unit 337 and data for correcting TFT characteristic fluctuation is completed. Thereafter, in order to adjust a luminance level during black display, if the processing shown in FIG. 34 is carried out and values of the electronic volumes are stored in the storing unit 337 in the same manner, a display device that compensates for a TFT characteristic and has black luminance equal to or lower than a predetermined range is realized.

Since data to be corrected holds a value of a difference from a maximum voltage of 0 with respect to a voltage distribution over the entire screen curing voltage measurement, only a relative difference is stored.

Absolute values of the voltages are determined by setting of an electronic volume of the voltage generating section that supplies the voltages to voltage DAC sections. An output range of voltage DACs is determined by adjustment of the electronic volume in FIG. 34. Consequently, the voltages are allocated to values of correction data.

Moreover, if the number of bits of the voltage output section is increased, it is possible to perform gradation representation. For example, if the DAC sections of the voltage output sections are increased from 5 bits to 8 to 12 bits, it is possible to perform gradation display of 6 to 10 bits with the voltages.

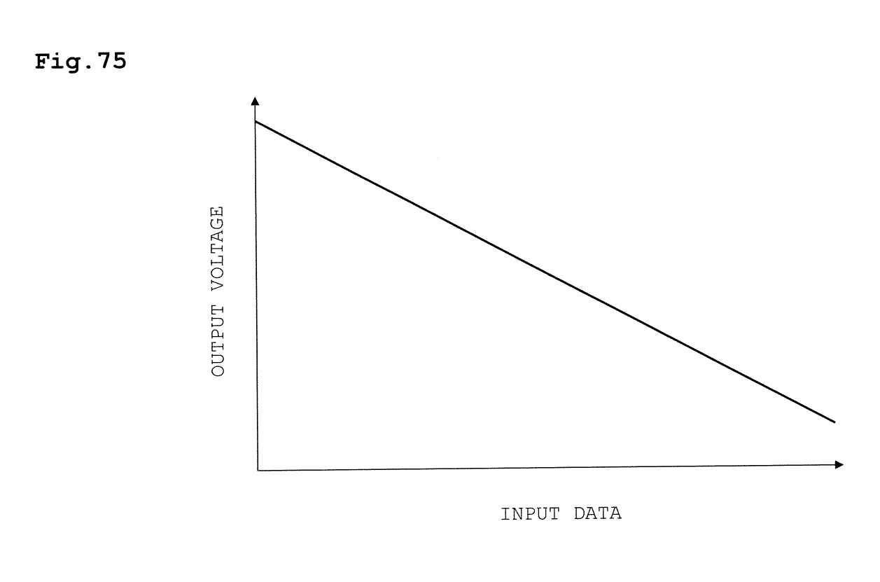

The gradation display and the characteristic compensation for the TFT are performed by addition of compensation data and gradation data. When the driving transistor is formed of the p-type TFT as shown in FIGS. 3 and 5, a voltage value is lower as an electric current is larger. In other words, the DACs are designed such that a voltage is lower as a gradation is larger. For example, as shown in FIG. 75, an output voltage is changed with respect to input data. Data for characteristic compensation is also subjected to the quantization in FIG. 73 such that, as a value thereof is larger, a voltage is lower. In FIG. 75, if the output voltage is set to linearly change with respect to the input data, it is possible to simultaneously realize TFT characteristic compensation and gradation display according to an output of a result of addition of a compensation data value and a gradation data value.

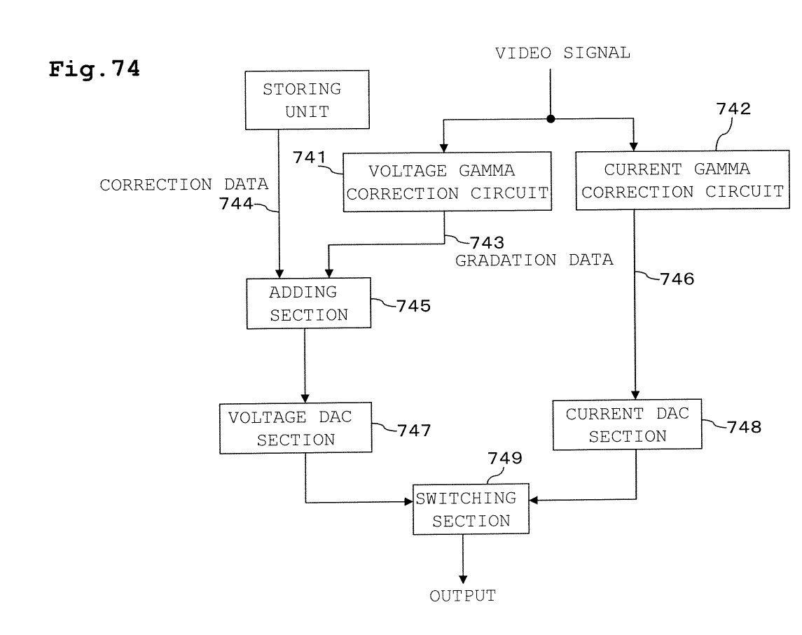

The structure of the output stage is shown in FIG. 74. For simplification of a flow of a signal, only one output is provided in an example in FIG. 74. However, it is also possible to realize the output stage in the same manner when plural outputs are provided. In this case, input data of DAC sections only have to be allocated to the plural outputs with a shift register or the like.

When a video signal is inputted, the video signal is divided into a video signal for a voltage DAC and a video signal for a current DAC. An identical current needs to flow to the organic light-emitting element at an identical gradation in both a voltage output and a current output. In the current DAC, an output current directly flows to the organic light-emitting element. On the other hand, in the voltage DAC, the output is converted into an electric current by a driving transistor and the electric current converted from the output flows to the organic light-emitting element. Since this conversion is nonlinear, different outputs are obtained from an identical input because a converting section is interposed. Therefore, in order to correct a conversion characteristic of this converting section, different kinds of gamma correction are applied to an electric current and a voltage. An output of a gamma correction circuit for voltage DAC 741 is connected to an adding circuit 745 for addition with correction data 744. A voltage corresponding to a gradation is further increased or decreased by an amount of voltage corresponding to characteristic unevenness of the TFT to carry out characteristic compensation. If there is no characteristic fluctuation of the TFT, since the voltage is added with the correction data 744, all of which are an identical value, gradation data 743 is inputted to a voltage DAC 747 and a voltage corresponding to a gradation is outputted. In the method explained here, it is possible to select a circuit configuration for setting all the correction data 744 to an identical value or a circuit configuration for directly outputting the gradation data 743 to the voltage DAC 747 without performing addition in the adding circuit 745. Consequently, it is also possible to realize a circuit without characteristic compensation.

One of a gradation voltage, which is subjected to TFT characteristic compensation, outputted from the voltage DAC 747 and a gradation current outputted from a current DAC 748 is switched by a switching section 749. The switching section 749 is equivalent to the voltage-application selecting section 253 described above. The voltage DAC 747 is selected at the beginning of the horizontal scanning period and charge and discharge is performed at high speed to bring the voltage close to a predetermined voltage. Subsequently, the voltage is changed to an original source potential in current driving by the current DAC 745. Consequently, it is possible to perform display in which a predetermined voltage can be properly written without unevenness due to characteristic fluctuation of the driving transistor and regardless of a state of an immediately preceding row.

In the case of this method, although the voltage DAC section 747 is large, a pre-charge pulse generating section and a pre-charge pulse selecting section required in the past are unnecessary. Moreover, it is unnecessary to generate a judgment signal for judging whether pre-charge should be performed and transmit the judgment signal to a driver output. Therefore, an influence of an increase in size of the circuit of the voltage DAC section 747 is almost eliminated.

It is desirable that an interval width of the voltage DAC section 747 is fixed regardless of a display color and a panel. This is because, in quantizing correction data, taking into account the interval width of the voltage DAC section 747, the quantization is performed at the interval width. It is preferable that the interval width is equal to or smaller than 10 mV when (channel width)/(channel length) of the driving transistor is ¼, although depending on a relation between a gate voltage and a drain voltage of the driving transistor. As a value of (channel width)/(channel length) is smaller, the interval width may be larger. As the value of (channel width)/(channel length) is larger, it is necessary to set the interval width smaller. This is because, as the value of (channel width)/(channel length) is smaller, a change in a current value is smaller with respect to a change in the gate voltage of the driving transistor and a deviation amount of the gate voltage allowed for an error (within about 2% to 3.5%) of a current value observed as luminance unevenness is larger. Therefore, in order to increase the interval width, it is preferable to set the value of (channel width)/(channel length) small. However, since a source signal line amplitude for realizing predetermined luminance increases and, as a result, a power supply voltage has to be increased and electronic power of a panel increases, a minimum value of the interval width is about 1/16. On the other hand, a maximum value of the interval width is determined according to how finely a voltage interval width of the driver IC can be cut. In the present IC, since minimum voltage output fluctuation between adjacent terminals is about 2.5 mV, a maximum value of (channel width)/(channel length) is 1. In future, if a high-precision DAC can be realized, it is possible to further increase the maximum value of (channel width)/(channel length). 2.5/(realizable interval width) is a maximum value of (channel width)/(channel length). An interval width for the voltage DAC section 747, even though determined, may actually fluctuate for each panel. Therefore, an interval width for the voltage DAC section 747 is measured for each panel and the measured interval width is used to perform the quantization for each panel so that the quantization of correction data may not be affected even when the interval width fluctuates. In this way, an interval width for the voltage DAC section 747 may have an error with respect to a designed value, and the fabrication is facilitated.

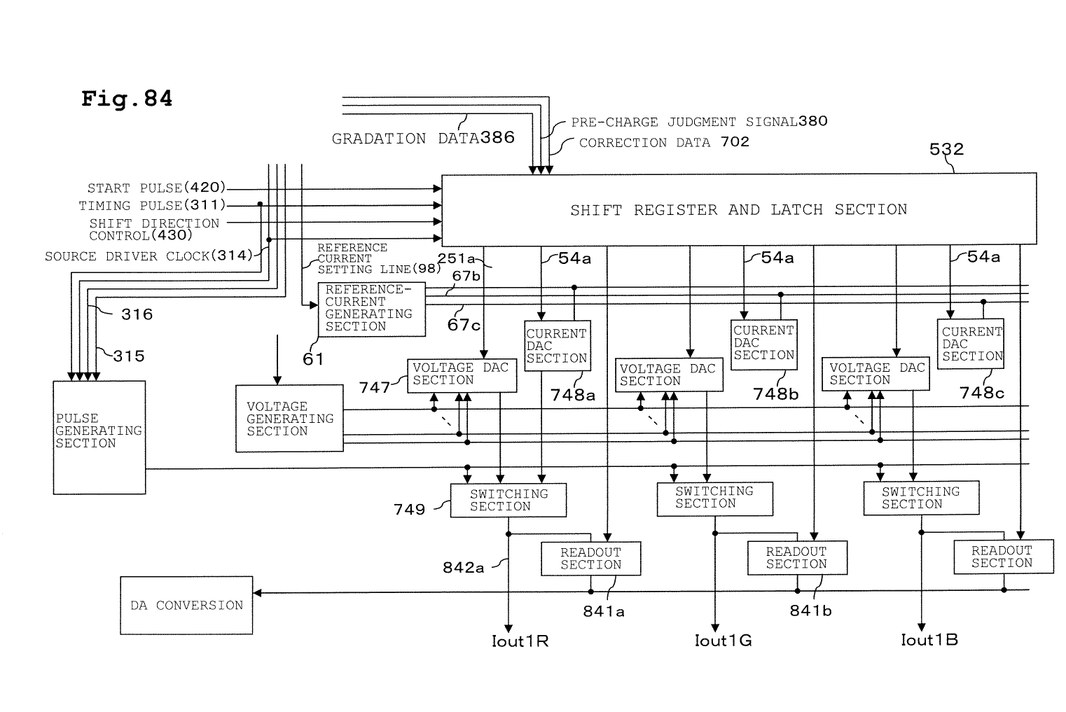

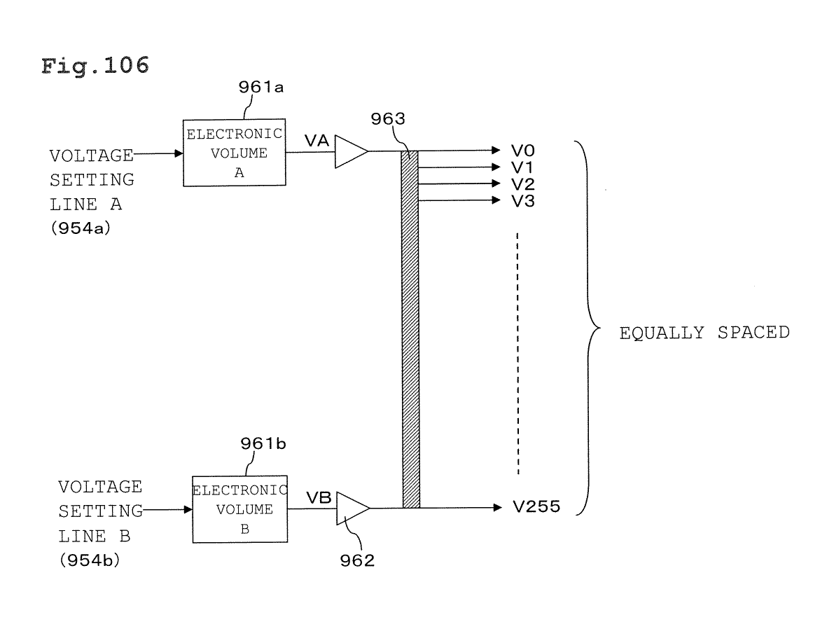

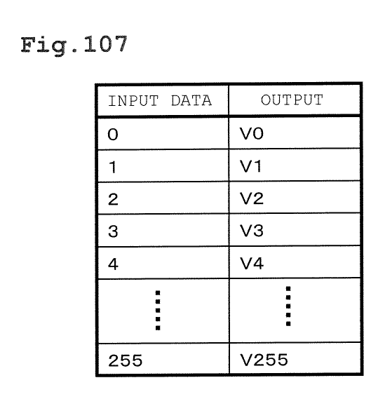

To measure an interval width, for example, in the driver structure in FIG. 84 and when the voltage generating section 953 in FIG. 106 and the voltage DAC section 747 in FIG. 107 are used, the switching section 749 is designed to always select an output of the voltage DAC section 747, and output voltages are measured when “0” is entered to the input of the voltage DAC section 747 and when “255” is entered thereto. The voltage difference between two output voltages at the same output terminal can be divided by 255 to determine the interval width. The quantization may be performed based on the determined interval width.

When output voltages are measured, all interval widths may not necessarily be the same due to a deviation between adjacent terminals. Therefore, the quantization of a corresponding pixel for each output terminal may be performed separately.

Alternatively, even though a deviation of up to 10 to 20 mV will exist with respect to the input range from 0 to 255 when an output deviation in the voltage DAC section is on the order of 10 to 20 mV in one chip, the deviation of only 0.1 mV or lower will exist for one stage. Therefore, an average may be used as the interval width to perform the quantization for all pixels.

When an average is used as the interval width, only a part of outputs, rather than all outputs, may be measured.

The measurement of gradations is not limited to between “0” and “255”, and may be made between any two different gradations. It is similarly possible to calculate an interval width by dividing the potential difference between two voltages by the number of intervals.

The voltage DAC section 747 can also perform curtailment for every two gradations or four gradations in an output corresponding to a high gradation. Whereas voltages are supplied at intervals of 10 mV at a low gradation, on a higher gradation side, it is possible to supply voltages at intervals of 20 mV or 40 mV. This because, since a current value for performing gradation display increases as a gradation becomes higher, an output of the current DAC 748 increases. As the output increases, since an ability for changing a source signal line voltage increases, even if an output error of the voltage DAC 747 is 10 mV or 20 mV, the voltage changes to a predetermined voltage in writing by the current DAC 748 after that and display without unevenness can be realized.

Thus, the voltage DAC section 747 can set resolution to 2^{N} (N>1) times as large as minimum resolution according to a gradation. There is an advantage that, making use of this setting, a chip area can be reduced by reducing the number of voltages that can be outputted. This is a circuit reduction method peculiar to a driving system for writing, after applying a gradation subjected to TFT characteristic compensation with a voltage, the gradation with an electric current in an identical horizontal scanning period.

In a method of determining an output voltage according to addition of a correction value and gradation data, voltage fluctuation due to the correction value and output fluctuation of the voltage DAC section 747 need to coincide with each other in advance. When voltage fluctuation per one stage of the voltage DAC section 747 fluctuates, it is necessary to change data for characteristic correction according to the fluctuation. Since this is addition with a video signal, a voltage change amount with respect to the correction value changes according to the video signal. Therefore, it is difficult to correct the change amount.

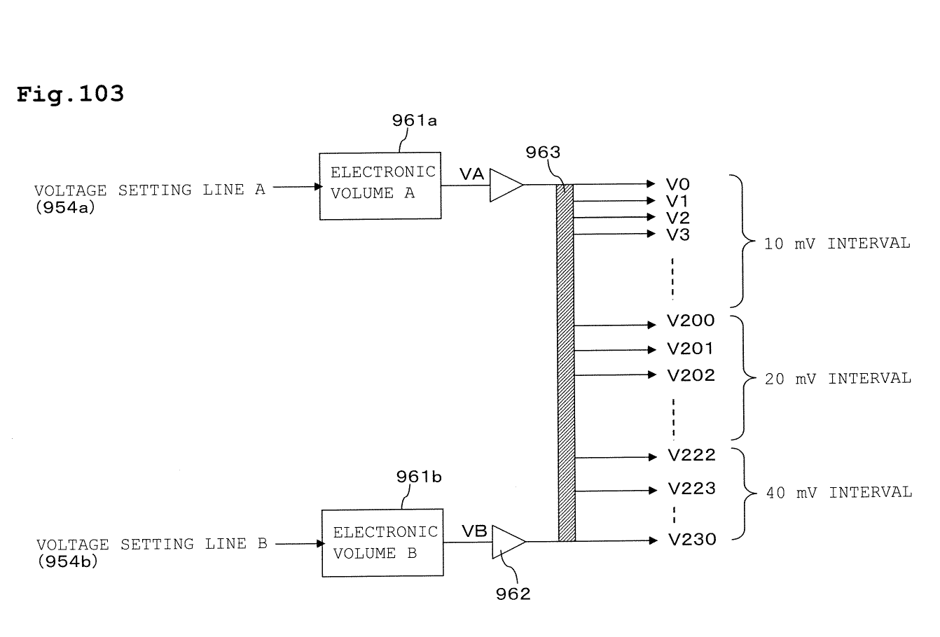

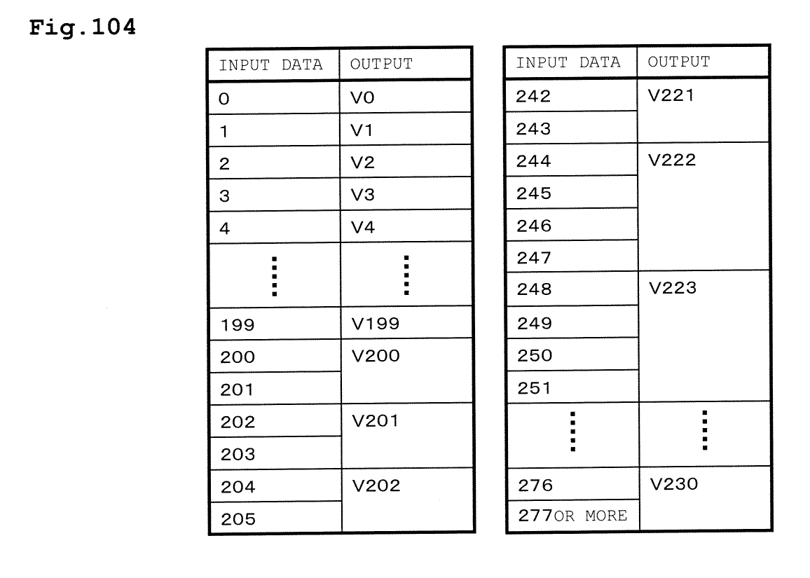

As a method of reducing the number of gradations, the voltage generating section is constituted as shown in FIG. 103 and, when a voltage interval width is rougher as a voltage is lower (a gradation is higher), a relation of voltage DAC sections shown in FIG. 104 is adopted. Then, even if the number of voltages is reduced from 276 to 220, as an output voltage with respect to input data, the same voltage can be supplied at stages other than curtailed stages as in the case in which the number of voltages is 276. Therefore, it is possible to store correction data in the storing unit at intervals of 10 mV. Since the gamma correction circuit 741, the correction data 744, and the adding section 745 without curtailment can be used, a circuit size in this section can be identical. The reduced number of outputs is compensated by adjacent voltages. For example, data 201 for a voltage between V200 and V201 is V200. By setting data 200 and 201 as V200, it is possible to select V200 and select a voltage from higher-order 7-bit data without comparing lower-order 1 bit among 8-bit data. Consequently, since a comparison control section can be simplified, it is possible to reduce a circuit size. In the case of 40 mV intervals, outputs for four data are set as an identical voltage output. Although not described in this example, in the case of 80 mV intervals, outputs are curtailed in such a manner as to set outputs for eight data as an identical voltage output.

Other than the pixel structures of the current copier and the current mirror, this driving system can be implemented in a pixel structure in which fluctuation for each of pixels of a gate voltage of the driving transistor can be seen when predetermined current is written, supplying a voltage to the gate voltage of the driving transistor is possible, and writing a drain current of the driving transistor is possible.

When the driving transistor is the N-type TFT, the change in the voltage with respect to the input data is applicable if the voltage DAC 747 is designed such that the voltage is higher as the input data is larger.

If the capacity of the storing unit 337 is increased, it is also possible to store voltage values with respect to plural current values of all the pixels. If the capacity is increased by three folds, it is possible to store voltage fluctuation data with respect to electric currents I0, I1, and I2. If maximum voltage fluctuation data with respect to electric currents for the number of display gradations are stored, it is possible to apply gradation voltage at all gradations taking into account TFT characteristic fluctuation. If data for all pixels were determined in all gradations, it would be possible to apply optimally corrected voltages at all gradations at any time.

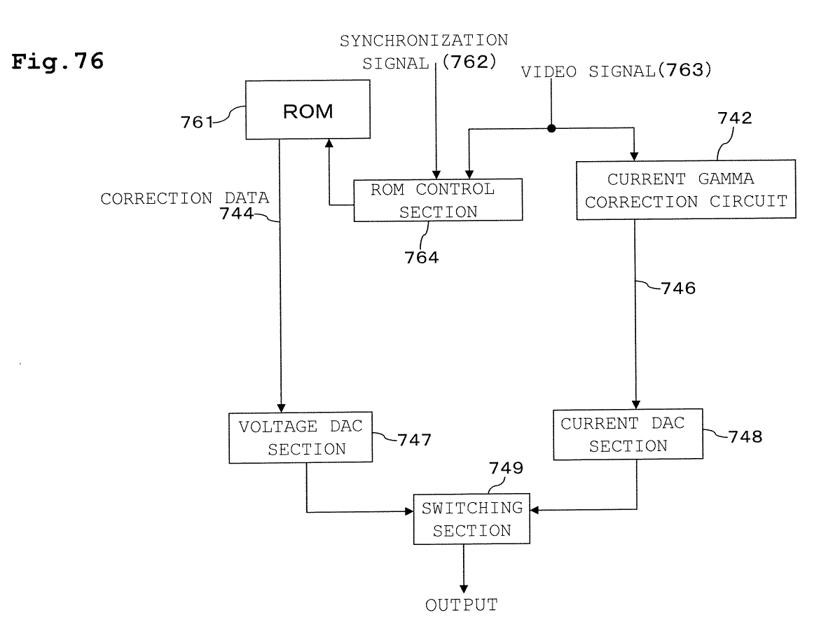

The structure of the output stage in this case is as shown in FIG. 76. When all gradation voltages are held in the ROM, if voltages after gamma correction are input to the ROM in advance, a gamma conversion section for voltage DAC is unnecessary. A gamma conversion section is prepared for only the current DAC. Data for voltage output reads out a voltage value with respect to a desired gradation for a pixel in a desired position, which is held in the ROM 761, from a video signal 763 and a synchronization signal 762, inputs the voltage value to the voltage DAC section 747, and performs voltage output.

When data for plurality of gradation rather than all the gradations are held, potential difference data at the respective gradations are prepared in the ROM. Work shown in FIG. 73 is repeatedly carried out for the number of gradations to be stored and potential difference data among the pixels are created. A voltage change with respect to the gradations is carried out in the voltage gamma conversion section. Data with TFT characteristics corrected for each of the gradations can be outputted by adding up the voltage change with the potential difference data.

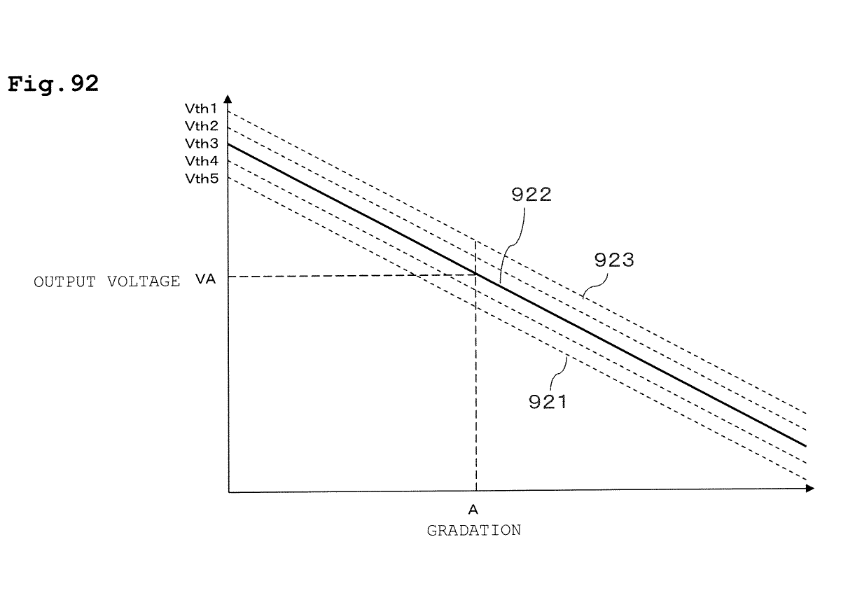

For example, when the number of bits of the ROM is 5 bits, only in-plane fluctuation of the panel is represented by 32 stages, and a voltage is determined so as to output a luminance depending on a gradation at the voltage gamma correction circuit 741. In FIG. 92, characteristic fluctuation can also be dealt with by setting a linear relation shown at 921 by the voltage gamma correction circuit 741, and changing it to a linear relation shown at 922 or 923 for each pixel according to data in the ROM.

When potential difference data for all the gradations are not stored in the ROM, it is necessary to determine a correction value from potential difference data for the other gradations.

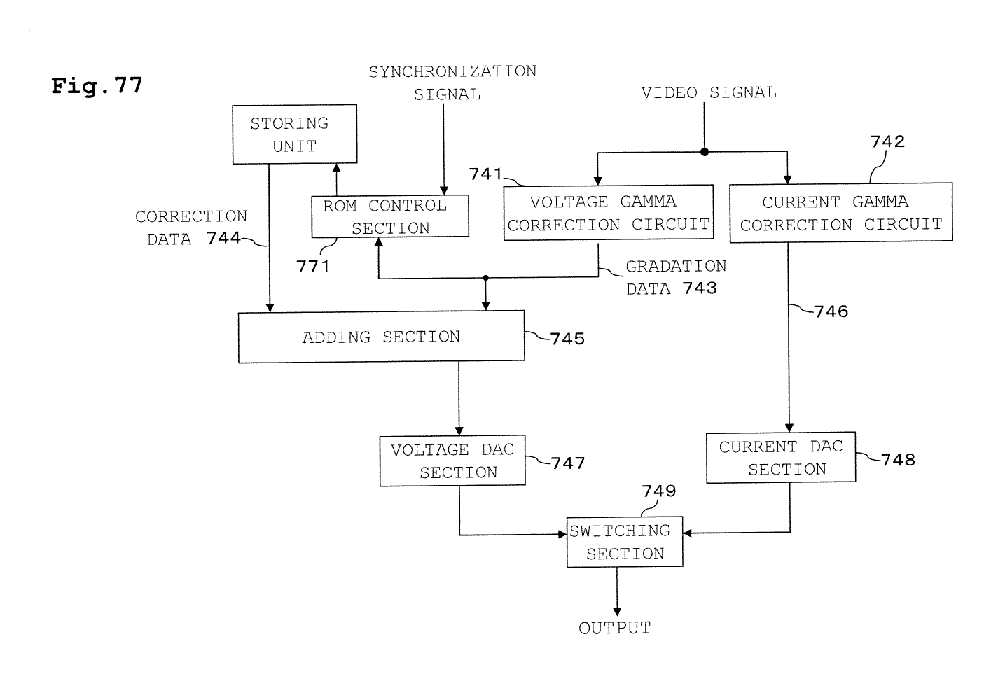

A first method of calculating correction data is a method of directly using correction data of a current value closest to an electric current. In the case of this method, for example, when it is assumed that there are data corresponding to 10, 11, and 12, correction data at 10 only has to be used in the case of a gradation corresponding to an electric current smaller than (I0+I1)/2. Correction data at I1 only has to be used in the case of a gradation corresponding to an electric current equal to or larger than (I0+I1)/2 and smaller than (I1+I2)/2. Correction data at I2 only has to be used in the case of a gradation corresponding to an electric current equal to or larger than (I1+I2)/2. Thus, as shown in FIG. 77, a ROM control section 771 is provided to make it possible to designate an address of the ROM from a video signal (an output of the gamma conversion section for voltage DAC) and a synchronization signal and extract an optimum correction voltage from the ROM according to the video signal and the pixels. Voltages and gradation characteristics are not stored in the ROM (only an inter-pixel potential difference at an identical gradation is stored). A correction voltage corresponding to a gradation can be outputted by adding up potential difference information and a gradation signal and selecting, on the basis of added data, any one of voltage ranges determined by the voltage generating section with the voltage DAC section.

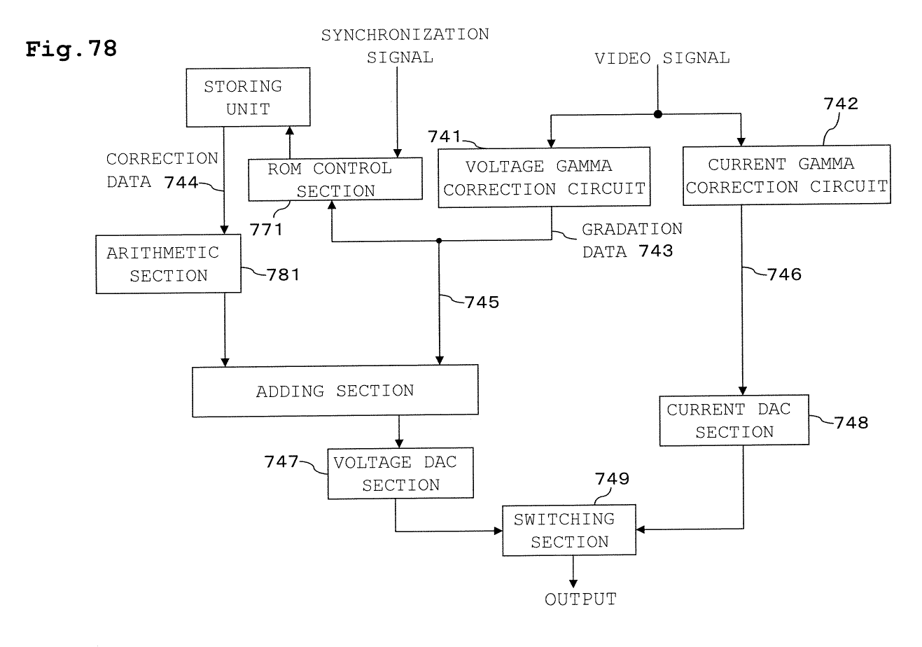

As a second method of calculating correction data, there is a method of calculating correction data during a display gradation from two gradation correction data, for which voltages have been measured, on both sides of a display gradation. In this case, in the ROM control section 771 in FIG. 77, it is necessary to perform control for reading out two correction data from a display gradation. Data corresponding to the display gradation is calculated by point-to-point linear interpolation from two data outputted from the ROM and is set as correction data. Therefore, as shown in FIG. 78, it is necessary to add an arithmetic section 781 to a data output in FIG. 77. As the readout from the ROM, it is necessary to perform the readout twice for one data. Therefore, it is necessary to double a transfer rate or a mechanism such as simultaneous readout from a ROM having a double bus width or from two ROMs is required. The two data are two data having different gradations for an identical pixel. If there are two data, data can be calculated by linearly interpolating the two data. Two data having smaller gradation differences from a necessary gradation are selected or data closest to the necessary gradation on a low gradation side and data closest to the necessary gradation on a high gradation side are selected. Display in which there are fewer errors and unevenness due to a calculation error less easily occurs is obtained by calculating correction data for the display gradation according to any one of the methods.

In the case of the pixel structure in which writing is possible by an electric current shown in FIG. 3, an electric current to be measured can be more easily written by current driving further on a high gradation side. Therefore, even if an input voltage is not accurate, since display without unevenness is possible, it is necessary to mainly measure a low gradation at which unevenness tends to occur.

In the case of a 2 to 5 type panel with the number of pixels of WQVGA, in a current area equal to or higher than 0.1 μA, display without unevenness was realized with correction data from pixel potential data during low gradation display at 0.01 μA. In a current area smaller than 0.1 μA, laser shot and unevenness in an identical direction, which were considered to be causes of mobility fluctuation, were visually recognized.

When pixel potential data at an electric current of 0.05 μA was used, display without unevenness was realized in a range of 0.04 μA to 0.1 μA.

In pixel potential data at an electric current of 0.03 μA, it could be confirmed that there was no display unevenness at gradations in a range of 0.025 to 0.04 μA. In pixel potential data at an electric current of 0.02 μA, it could be confirmed that there was no display unevenness at gradations in a range of 0.018 to 0.026 μA. In pixel potential data at an electric current of 0.01 μA, it could be confirmed that there was no display unevenness at gradations in a range of 0.02 μA or less.

Consequently, in the 2 to 5 type panels with the number of pixels of WQVGA, display without unevenness for all the gradations was realized by performing pixel potential measurement at four points of 0.01, 0.02, 0,03, and 0.05 μA, accumulating data in the storing unit, and performing display on the basis of the data.

In general, types of necessary pixel potential data are obtained from the number of vertical lines (a horizontal scanning period) and a panel size (a wiring capacity). When the number of lines is doubled, the necessary pixel potential data is doubled. When the panel size is doubled, the necessary pixel potential data is doubled.

Therefore, cost is reduced when the number of gradations for correction is as small as possible. When correction is performed only with one gradation, it is advisable to perform correction with a black gradation with a smallest current (since an electric current does not flow, correction by an electric current cannot be expected). However, when luminance of black display is low and, even if there is unevenness, the unevenness cannot be visually recognized, it is preferable to perform correction with a gradation of a minimum current, with which visually recognizable luminance is obtained. In this case, a first gradation, which is a gradation next to black, is an object of correction.

Particularly in a current-driven pixel structure, writing may be performed by the voltage DAC for 2 to 10 μsec at the beginning of one horizontal scanning period, and by the current DAC for the rest of the period. In this way, the voltage deviation due to TFT mobility component fluctuation is corrected by the writing with the current DAC, so that it is possible to provide an even display without complete correction data for all gradations. Particularly, because the higher the gradation (i.e. the more the current) is, the more the writing ability of the current DAC to a pixel is improved, the correction may be applied primarily to lower gradations. For higher gradations, gradation components may be used and the voltage may be changed up to the threshold component so as to use a current to correct mobility components that have not been corrected.

With reduced fluctuation in mobility components of the driving transistor, curtailment can be accomplished even with voltage driving.

An electric current during measurement does not always have to be identical with an electric current during gradation display and may be an electric current near a gradation for correction. A measurement result and a gradation may be associated later. As a condition for measuring a pixel potential, a potential in a state in which a constant current is fed is measured and, on the other hand, a white current is different for each of the panels because of efficiency fluctuation in the organic light-emitting element. Therefore, since an electric current of one gradation does not always have a fixed value and an electric current under a measurement condition may not belong to any gradation, it is difficult to match a gradation with the measurement condition. A voltage stored in the ROM holds a potential difference in a panel surface and may have any absolute value. Therefore, even if a gradation and a measurement current deviate from each other, if a state of fluctuation does not change, a near gradation of the measurement current may be set as a correction gradation. Deviation of an electric current due to efficiency fluctuation was within 10% in a result of current measurement after white adjustment. For example, in the example described above, when four points of 0.01, 0.02, 0.03, and 0.05 μA are measured, even if an electric current corresponding to an identical gradation changes 10% among the panels, since a difference among the four points is equal to or larger than 100%, a gradation does not change until measurement at a different measurement point. Even if an electric current deviates 10% and a distribution of pixel potentials deviates, judging from the result of the current range that can be corrected, current fluctuation is not substantially affected whichever measurement point among the four measurement points is selected.

Therefore, when it is assumed that 0.01 μA is a gradation A, 0.02 μA is a gradation B, 0.03 μA is a gradation C, and 0.05 μA is a gradation D, the gradations A to D may be defined later from data of a white current. A result of the definition is reflected on the ROM control section 771 in FIG. 77 and the like. The gradations A to D are used as a reference to decide correction data for which electric current is selected with respect to a gradation data input. In other words, gradation comparison with the video signal is performed to judge which measurement data is the closest or judge which data is data for selecting closets two data. The synchronization signal is inputted to judge data of which pixel address should be selected. It is decided, from the gradation data 743, fluctuation data of which current condition is selected and it is decided, from the synchronization signal, data of which pixel is extracted.

When writing in current driving is difficult for an entire gradation range in a large panel or the like, voltage application by correction data at all the gradations is necessary.

For creation of correction data, first, white display is performed by current driving to adjust luminance and chromaticity. A current value during while display is determined. Current values of the respective colors at this point are measured. Subsequently, a gamma curve is determined. Luminances, i.e., current values of the respective gradations are determined. Since the current values corresponding to all the gradations are known, voltages of pixels over the entire screen at the time when the respective currents are fed are measured and correction data are calculated for each of the gradations. When correction data corresponding to all the pixels of all the gradations are determined, the correction data are completed by writing the correction data in the storing unit.

This method is also applicable when correction data corresponding to plural gradations are necessary other than when data of all the gradations are measured.

When the driver output section and the voltage readout section are constituted as shown in FIG. 84 and outputs 842 are connected to the source signal line, if the current DAC section 748 is selected by the switching section 749 and one of readout sections 841 is brought into a conduction state in a state in which an electric current is written in a certain pixel, a gate voltage of the driving transistor is inputted to the DA converting section and it is possible to measure a voltage. Characteristic fluctuation is corrected in this way. Moreover, when the switching section 749 is connected to the voltage DAC section 747 and one of the readout sections 841 is brought into a conduction state, it is possible to measure a voltage output of a voltage DAC of certain one output through DA conversion. When this operation is repeatedly carried out for all outputs, it is possible to measure output fluctuation in a voltage DAC of a certain driver.

In a pixel that uses an output with a high voltage even at an identical gradation, the voltage is corrected to a low voltage by adding the correction data to the voltage using a measurement result. Conversely, in an output with a low voltage, the correction data only has to be subtracted from the voltage. (However, since the correction data is not generated in consideration of cases where negative data is also treated, correction over the entire screen is necessary to set a minimum value to 0.)

Consequently, even if an output deviation of the voltage DAC section 747 is large, it is possible to correct the output deviation in the ROM 761 for correction and it is possible to control display unevenness due to the output deviation. Therefore, in the voltage DAC section, a function for reducing the output deviation does not have to be provided as a circuit and it is possible to reduce a circuit size.

When both pixel voltage fluctuation in the driving transistor of the pixel and voltage fluctuation in the voltage DAC section 747 are corrected, a value obtained by adding up results of the pixel voltage fluctuation and the voltage fluctuation only has to be inputted to the ROM 761 for correction.

Since both the data are calculated with the same voltage fluctuation amount per one stage, it is possible to correct the data with a simple addition. Although the data of the pixel potential is data for one screen, the voltage fluctuation in the driver is data for one row, when both the data are added up, in (X,Y) coordinates, correction data in an X column and a Y row can be realized by addition of pixel potential fluctuation data in the X column and the Y row and Xth driver voltage fluctuation data. (X and Y are integers representing addresses of a pixel.)

When fluctuation of driving transistors for pixels exists only in a small part of the display area, or when a periodic unevenness appeared over plural pixels is to be removed, pixel potential fluctuation data may not necessarily be required for all pixels.

For example, when pixel potential characteristics do not fluctuate between two horizontally adjacent pixels, fluctuation data of X=2p and 2p+1 (p is an integer), which are common to the two pixels and identical to each other, may be used. This allows the reduction of fluctuation data to half, and it is possible to reduce the capacity of the ROM 761 to be used for correction. The same applies to the vertical direction.

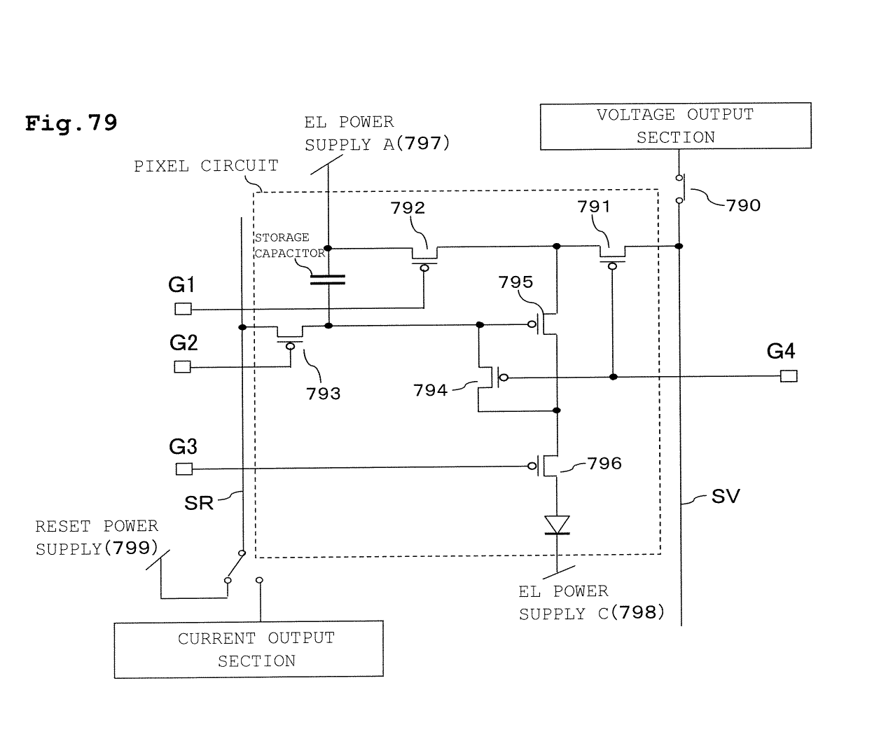

FIG. 79 is an example of a pixel circuit for voltage driving with threshold fluctuation correction function of a driving transistor 795. A driving method is explained with reference to the drawing.

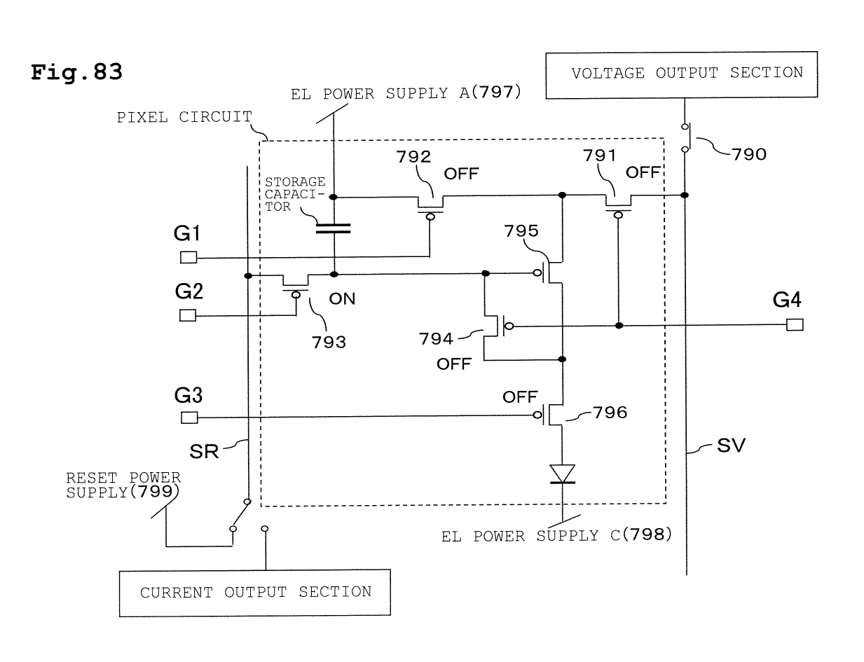

Before writing a desired gradation in a pixel, four gate signal lines (G1 to G4) and a reset power supply 799 shown in FIG. 83 are inputted to apply a reset voltage to the driving transistor 795. This is an operation same as that in an offset cancel pixel structure.

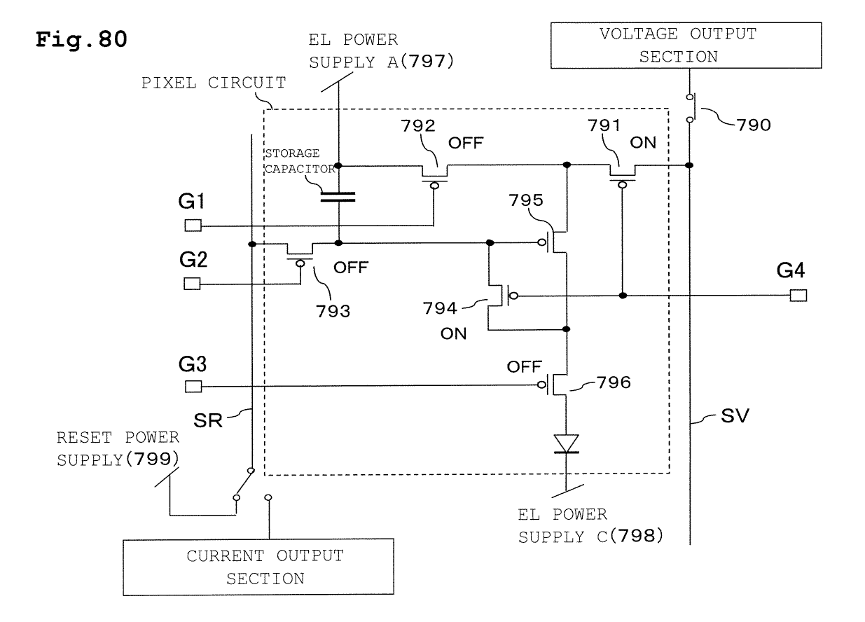

Subsequently, an output voltage from the voltage output section is written in the pixel by an input of the gate signal lines shown in FIG. 80. At this point, as a gate voltage of the driving transistor 795, a voltage lower than the voltage of the voltage output section by a threshold voltage of the driving transistor 795 is applied.

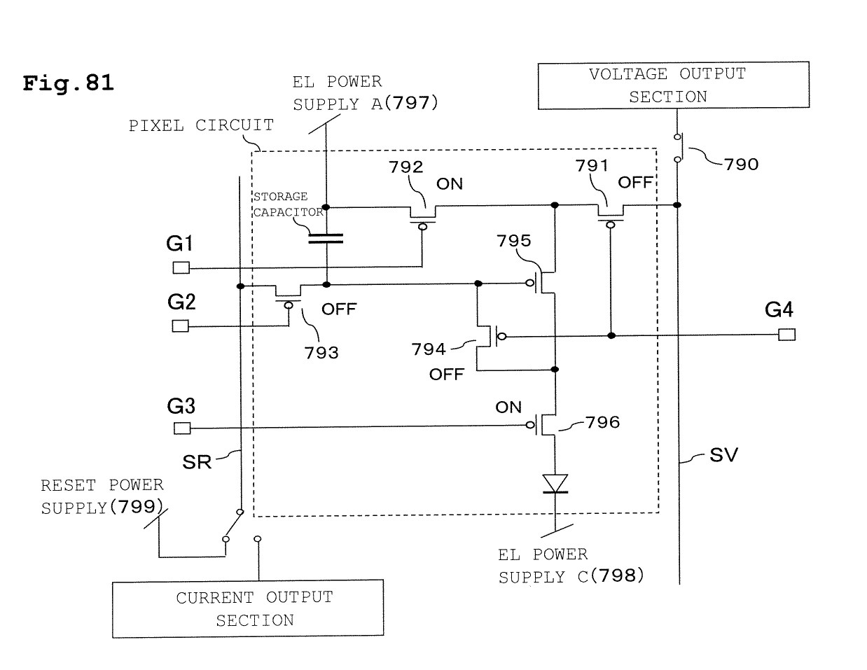

Subsequently, an electric current flows to an EL element and gradation display is performed according to operation of the gate signal lines shown in FIG. 81. The electric current that flows to the EL element depends on charges stored at both ends of a storage capacitor. The charges stored in the storage capacitor depend on a voltage of the voltage output section explained with reference to FIG. 80 and the threshold voltage of the driving transistor 795. Therefore, in this circuit configuration, it is possible to correct fluctuation in the threshold voltage of the transistor. In correcting the fluctuation, since a drain current of the driving transistor 795 is not flowing, it is possible to perform transistor characteristic correction during black display in which the drain current does not flow.

A gradation is changed according to a potential change in the voltage output section. Since the potential change is performed by a voltage DAC output of the driver IC, correction for each of driving transistors is not performed. Therefore, it is likely that unevenness due to mobility fluctuation occurs.

In order to correct the mobility fluctuation, it is necessary to check fluctuation in a gate to source voltage with respect to a change in a drain current for each of the driving transistors 795 and vary an output of the voltage output section in the driver for each of the pixels even at an identical gradation.

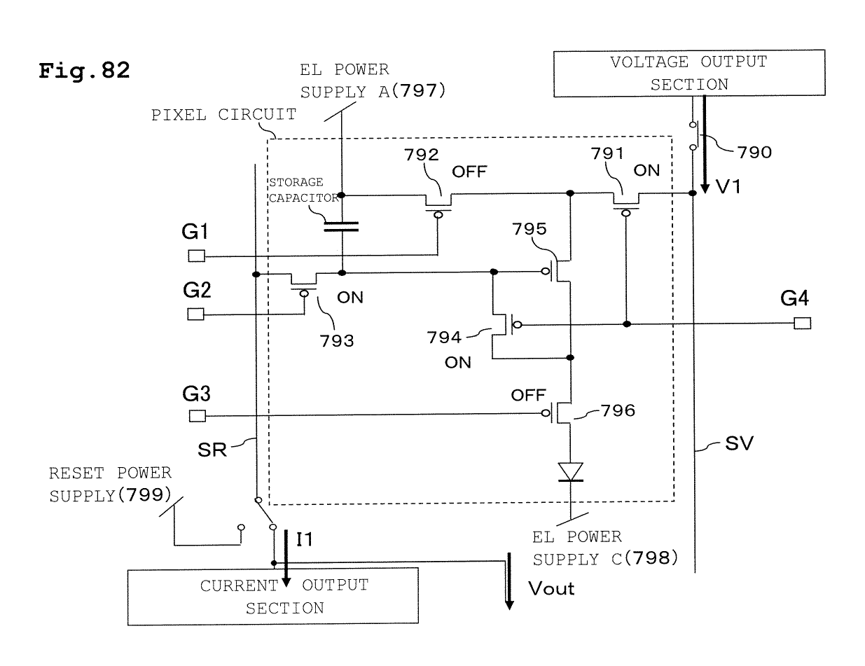

Therefore, before shipment, an operation shown in FIG. 82 is carried out, voltage fluctuation in the driving transistor is measured and ROM data for compensating for the fluctuation is created on the basis of potential fluctuation for each of the pixels and held. During display, the display is performed on the basis of the ROM data and gradation data.

First, control of a gate signal line of a pixel to be measured is performed as shown in FIG. 82. A voltage V1 is applied from the voltage output section and an electric current I1 is applied from the current output section to measure a gate voltage of the driving transistor from Vout.

When the electric current I1 is set to 0, it is possible to measure a gate voltage of the driving transistor in the state in FIG. 80. Voltage fluctuation for each of the pixels is observed as gate voltage fluctuation of the transistor during black display. (The voltage fluctuation is defined as V1-Vth).

If an electric current corresponding to gradation display other than 0 is applied as the electric current I1, it is possible to observe gate voltage fluctuation during corresponding gradation display for Vout. This voltage is defined as V1-Vg. Vg is a voltage equivalent to potential fall due to the driving transistor and obtained by combining the threshold voltage and a mobility component.

A potential difference between a voltage 0 and a voltage other than 0 is Vg−Vth. Vg can be represented as Vg=Vu+Vth (equivalent to a potential difference among Vu gradations) and a calculation result is Vu+Vth−Vth=Vu. An amount of change Vu from a black voltage necessary for the gradation display is calculated. If a value obtained by subtracting a value of Vu from a voltage during black display is outputted from the voltage output section, predetermined gradation display is realized. If data of Vu is individually inputted for each of the pixels, it is possible to perform signal output corresponding to fluctuation in the driving transistor.

In holding the data in the ROM, a minimum value of Vu is calculated and is first reflected on an output of the DAC. Input data of the DAC is set such that a voltage lower than the voltage during black display by the minimum value of Vu becomes an output voltage of the gradation. A potential difference is calculated from the minimum value of Vu for each of the pixels and a calculation result is stored in the ROM. If ROM data and a calculation result of the input data of the DAC are inputted to the voltage DAC, it is possible to apply a predetermined gradation voltage corresponding to characteristic fluctuation to the panel for each of the pixels and it is possible to perform display with less influence of the characteristic fluctuation.

If voltages are measured at plural gradations and values of Vu are calculated, it is possible to apply optimum pixel voltages at the plural gradations. When this is carried out at all the gradations, voltages with the characteristic fluctuation corrected are supplied from the drivers to the panels in all the pixels and it is possible to realize display without unevenness.

Long time is required for measurement at all the gradations, time required for adjustment is extended, and cost increases. Since a large ROM capacity is required, cost further increases. Thus, it is preferable to set a ratio of gradations for correction to about ¼ to 1/128 of all the gradations. Under the present situation, correction is carried out in data for one to three gradations.

In the case of the pixel structure of the current copier shown in FIG. 3, since an output of the voltage DAC section is directly supplied to the gate of the driving transistor, a measured voltage only has to be used as it is. In the structure shown in FIG. 79, since an output from the voltage DAC is not directly applied but a voltage reduced from the output by the threshold voltage is applied, it is necessary to apply a voltage taking into account the reduction by the threshold voltage. Therefore, the method is different in that a voltage obtained by subtracting the threshold from a result of threshold voltage measurement for each of the pixels is stored in the ROM.

Moreover, in the pixel structure of the offset cancel system, it is possible to correct a voltage with the ROM. In the pixel structure of the offset cancel system, characteristic fluctuation in the driving transistor is compensated for in a current value corresponding to a cancel point. However, as the current value further deviates, the fall in a compensation ability due to mobility fluctuation occurs and display unevenness tends to occur.

Therefore, the display unevenness due to the characteristic fluctuation is reduced by measuring gate voltage fluctuation of the driving transistor for each of current values, and adjusting and setting a voltage applied from the source driver for each of pixels even at an identical gradation.

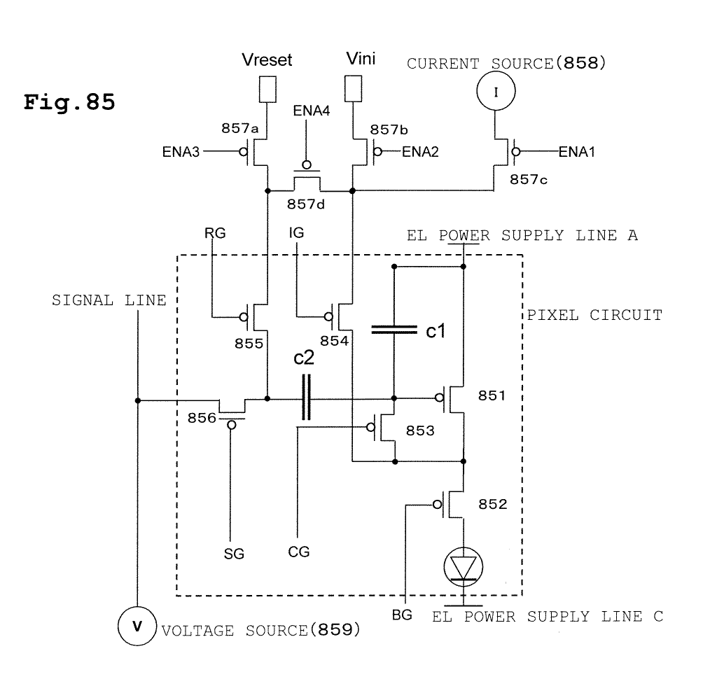

One pixel circuit and a peripheral circuit are shown in FIG. 85. As a characteristic of the pixel circuit and the peripheral circuit, compared with the configuration in the past, switches 857 for output open are inserted in an initialization signal line for initializing a gate voltage of a driving transistor 851 and a reset signal line for resetting a charge of a capacitor C2 for storing a gradation voltage and a switch 857 that can apply an electric current from a current source 858 to the initialization signal line and the reset signal line and the current source 858 are added. The current source 858 may be arranged for each of source lines on an array substrate or formed in the driver IC.

To cause the circuits to perform a usual offset cancel operation, the switches connected to an ENA 1 and an ENA 4 are turned off and the switches connected to an ENA 2 and an ENA 3 are turned on. Moreover, a charge of the capacitor C2 is discharged by an input of the gate signal line shown in FIG. 85, threshold correction of the driving transistor 851 is carried out in a cancel period 862, and a gate voltage of the driving transistor 851 is changed to the threshold voltage. In this state, a voltage during black display is obtained. In a signal writing period 863, by writing a potential corresponding to a difference between black display and a predetermined gradation from the source signal line, a gradation voltage corresponding to fluctuation in the threshold voltage of the driving transistor 851 is inputted to the gate of the driving transistor 851. In a light emission period 864, light is emitted at predetermined luminance.

In this system, it is determined, according to a difference between a reset voltage (Vreset) and a voltage of a voltage source 859, to which extent a gate voltage of the driving transistor 851 should be changed from a black display state. Since a potential difference between the reset voltage and the voltage of the voltage source is identical in all the pixels, when there is fluctuation in mobility of the driving transistor 851, fluctuation occurs in a drain current at a gradation (in this case, white) deviating from the reset voltage and display unevenness occurs.

As a characteristic of this system, an output voltage of the voltage source 859 changes according to characteristic fluctuation for each of the pixels even at an identical gradation. By storing a method of the change in the ROM section in the module, it is possible to output a voltage corresponding to a characteristic even in driving from a state without a power supply after adjustment and shipment.

A procedure for creating data to be stored in the ROM is explained.

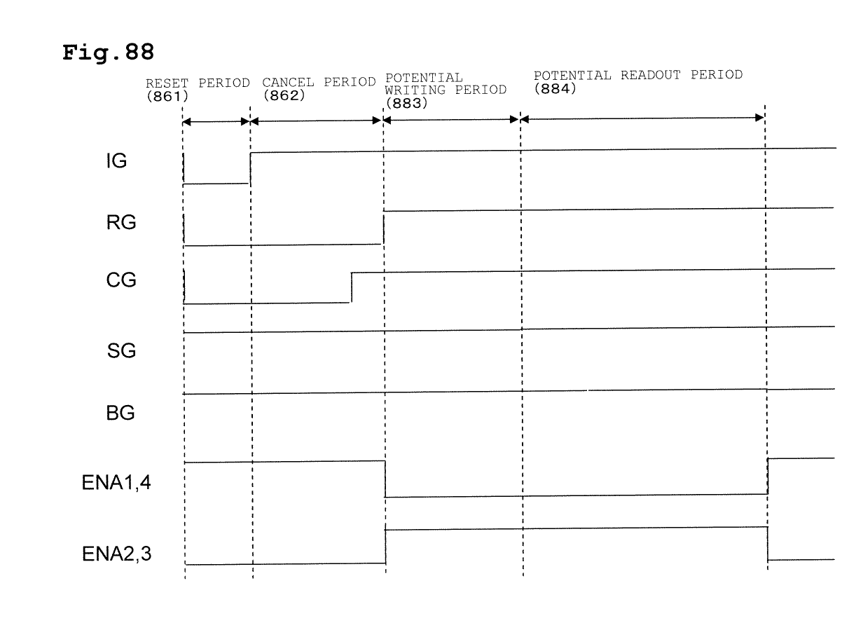

Driving waveforms in one pixel is shown in FIG. 88. In a reset period 861 and a cancel period 862, threshold fluctuation in the driving transistor 851 is corrected as in the past. At this point, a gate voltage of the driving transistor 851 is a gate voltage at a drain current of 0 and is a voltage corresponding to fluctuation for each of the pixels.

Subsequently, ENA 1 to 4 signals are controlled and, in a potential writing period 883, an electric current of the current source 858 is fed into the driving transistor 851. At this point, transistor 854 and 855 are in an ON state and a transistor 853 is in an OFF state. The gate voltage is changed such that the driving transistor 851 feed an electric current (e.g., I1) of the current source 858. While the charge stored in the capacitor C2 is held in the cancel period 852, a potential of a node 871 changes by an amount of change of the gate voltage of the driving transistor 851. The potential of the node 871 is a potential necessary for feeding the electric current I1 to the EL element.

The potential of the node 871 written in the potential writing period 883 only has to be read out to the outside in a potential readout period 884. For example, there is also a method of preparing a signal for extracting a voltage from between the switches of the current sources 858 and 857, extracting data in AD conversion, and extracting a voltage from a signal line after cutting off an output of the voltage source 859.

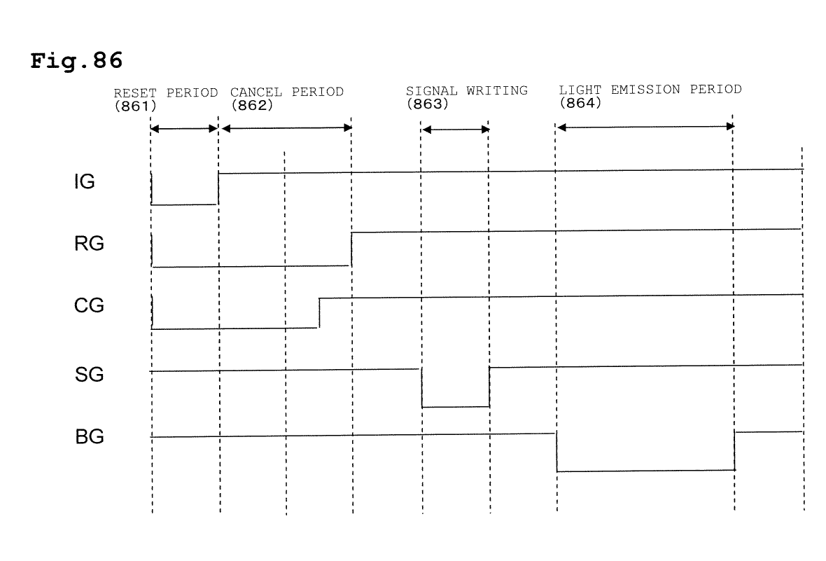

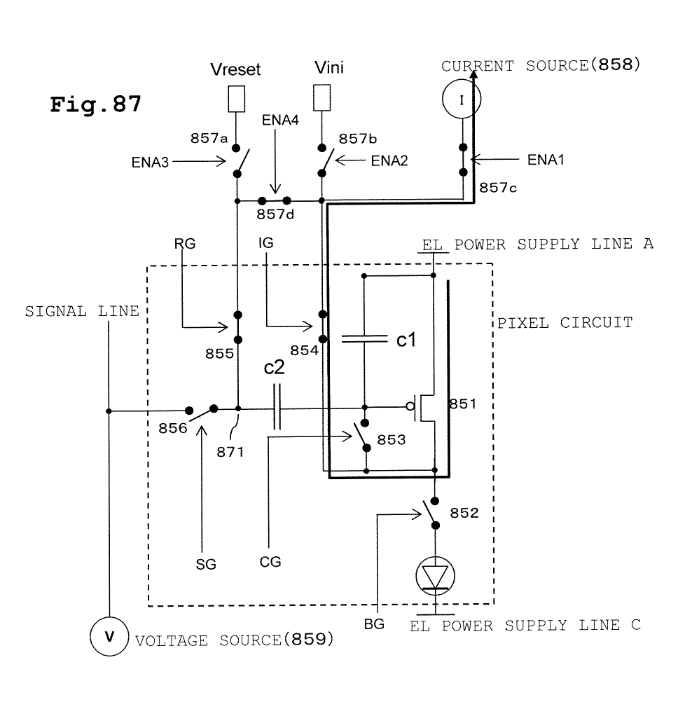

By repeatedly carrying out the procedure by the number of pixels, a voltage value that should be applied from the voltage source 859 at the electric current I1 in all the pixels is calculated. If this voltage value is inputted in the signal writing period 863 in FIG. 86, the electric current I1 flows to the EL element regardless of characteristic fluctuation in the driving transistor and it is possible to realize display without unevenness.

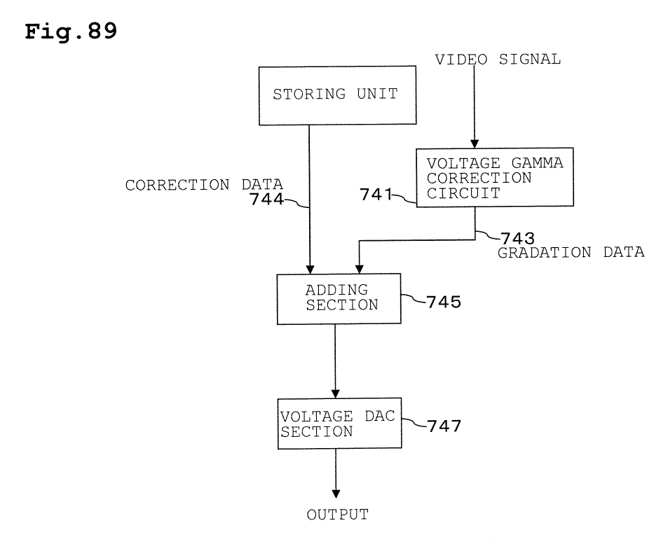

As a method of applying a different voltage for each of the pixels even at an identical gradation, a method of storing voltage fluctuation at the identical gradation in the ROM and storing maximum, minimum, or average voltages at the respective gradations in the gamma correction section as a gradation-voltage characteristic is conceivable. By determining an output of the voltage source 859 by adding up data after gamma correction and ROM data, it is possible to output a voltage matching a characteristic of the driving transistor 851 of the pixel even at an identical gradation. As a flow of a signal per one output, the signal flows through the sections excluding the current output sections in FIG. 74 as shown in FIG. 89.

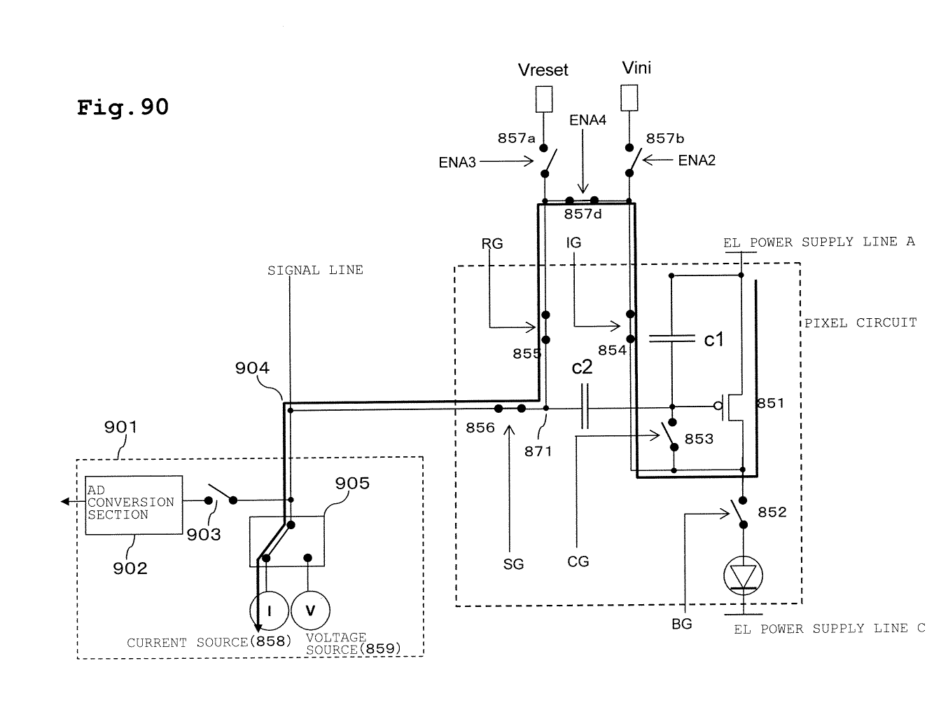

The current source 858 may be provided on an array or a test circuit separately from the driver IC or may be built in the driver IC as a current source for voltage measurement. For example, as shown in FIG. 90, the current source 858 and the voltage source 859 are built in a driver section 901. In FIG. 90, an AD conversion section 902 for measuring a voltage is further connected to the current source 858 and the voltage source 859 via a switch 903. An output of the AD conversion section 902 can be extracted to the outside. A path for feeding the electric current I1 to the driving transistor is as indicated by 904. According to the path, a switch 856 is turned on and a switching section 905 selects the current source 858. Therefore, in the potential writing period 883, the voltage of the node 871 changes to a voltage necessary for feeding the electric current I1. After the change ends, the switch 903 is turned on and the AD conversion section 902 and the node 871 are connected. Consequently, a voltage value is detected and a necessary voltage for each of the pixels is known.

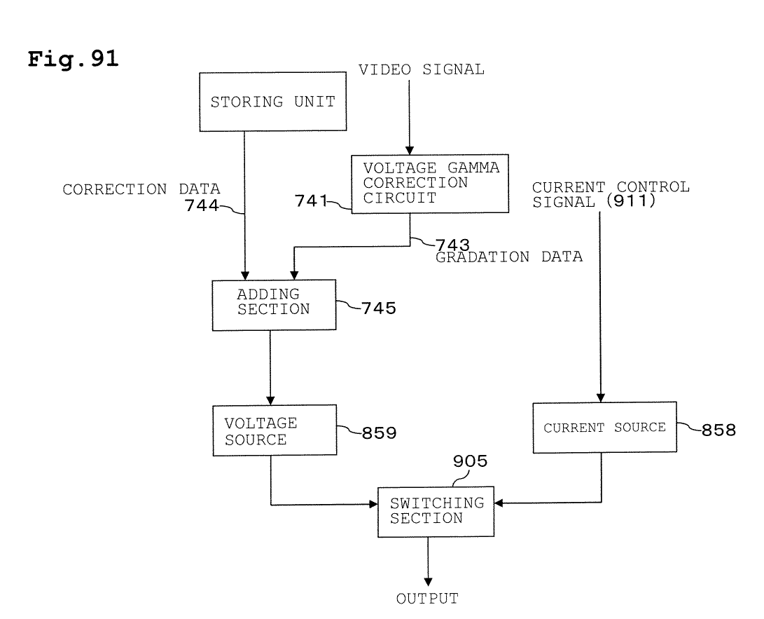

As the structure of the driver IC, as shown in FIG. 91, data obtained by adding up a video signal and correction data stored in the storing unit is inputted to the voltage source 859 side and an optimum voltage is outputted from the voltage source 859 according to the video signal and the pixel. On the other hand, a current control signal 911 for determining an output current is inputted to the current source 858 side. The current control signal 9I1 determines the electric current I1. When the number of bits of the current control signal is larger, it is possible to set a writing current in a finer or wider current range. However, since the driver IC is a circuit unnecessary for original display and a circuit size thereof is preferably as small as possible, the driver IC is formed by a DAC of about 5 to 6 bits. The driver IC may be created by combining bits for rough adjustment and bits for fine adjustment.

In this way, as shown in FIG. 92, it is possible to constitute the voltage output section that outputs different voltages even at an identical gradation. In the case of black display, in this example, it is possible to output five kinds of voltages Vth1 to Vth5. When data for one gradation is stored in the ROM for correction, five kinds of voltages can be also selected at the other gradations. At the gradation A, outputs at five points around VA, i.e., (VA+(Vth1−Vth3), VA+(Vth2−Vth3), VA, VA−(Vth3−Vth4), and VA−(Vth3−Vth5), are possible. In general, the number of outputs at an identical gradation depends on the number of bits of the ROM for correction. Therefore, as straight lines indicating a relation between a gradation and an output voltage shown in the figure, there are 8 to 256 kinds of relations per one color per one panel.

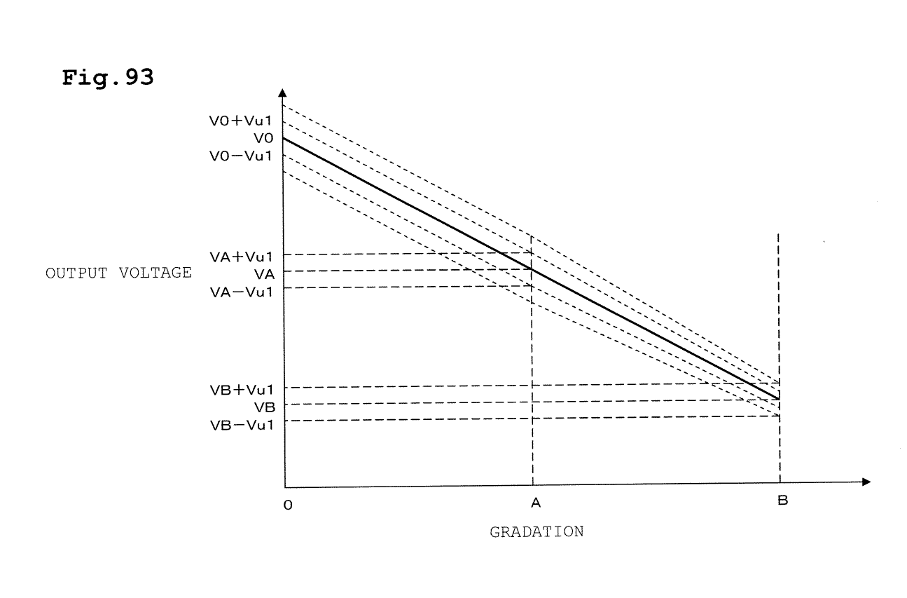

In FIG. 93, correction voltages are measured at three points of gradations 0, A, and B and output voltages are different even at an identical gradation. A gradation and an output voltage are in such a relation when fluctuation is smaller in the gradation B than in the gradation A.

In the above explanation, the driving transistor is the p type. However, an n-type driving transistor can be realized in the same manner. It is sufficient to reverse a direction of an electric current for reading out a voltage and set a change in a voltage with respect to an input gradation such that a voltage is higher as a gradation is higher. Therefore, in inputting data to the storing unit, it is sufficient to cause the storing unit to hold data such that data 0 is held in a pixel with a lowest voltage and data is increased as a voltage is higher.

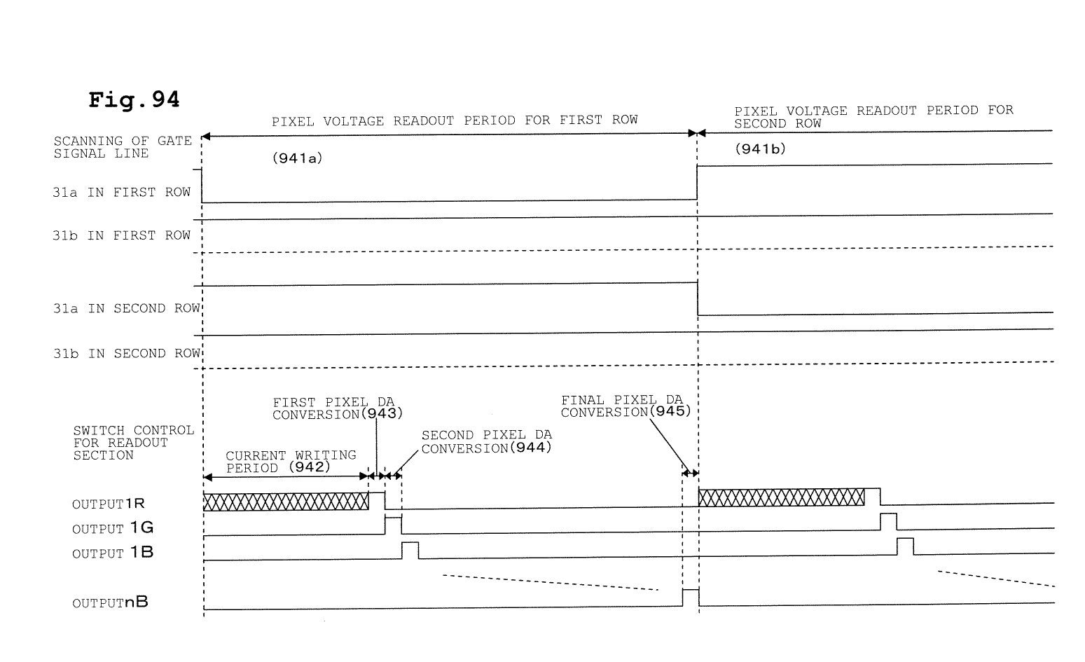

A timing chart of a method of reading out a voltage for each of the pixels in the case of the driver structure in FIG. 84 and the pixel in FIG. 3 is shown in FIG. 94. An identical current value is applied to at least all pixels of an identical color and the switching section 749 selects an output on the current DAC side in order to check voltage fluctuation. Applied current to the respective pixels are determined according to a video signal and the control by the gamma correction circuit. A pattern in which at least the same electric current is written in the same color is inputted to the driver IC. In this state, when a 31a signal on a first row is applied such that an electric current is written in pixels in the first row, the electric current is written in all pixels in the first row. This period is equivalent to a current writing period 942.

Since it takes time to write the electric current in the pixels, the current writing period 942 is continued until the writing is completed. Time of about 0.2 to 2 ms is required in the 2 to 3-type panel.

When voltages written in the pixels are stabilized, the voltage is read out from one pixel at a time. This is an example in the case in which there is only one AD conversion circuit. If there are plural AD conversion circuits, it is possible to simultaneously read out the voltages from plural pixels.

In order to read out the voltages of the pixels in order, the readout sections 841 are provided and outputs 842 of the readout sections 841 are connected to the AD conversion sections 957 one by one. In this example, in order to reduce an area of the driver, a shift resister usually used for display is also used to perform AD conversion of the voltages in order. All the pixels present in one row are scanned in order from a first pixel to obtain voltage fluctuation data of the pixels. Times 943 to 945 are about 5 to 20 nm per one pixel. This scanning was repeatedly carried out for each of the rows by operating the gate driver 31 and voltage fluctuation data of all the pixels were obtained to create original data of data stored in the storing unit.

Since long measurement time is required when the voltage of one pixel are converted at a time, as a method of simultaneously converting the voltages in the plural pixels, plural AD conversion sections only have to be prepared. In this case, it is anticipated that there is fluctuation for each of the AD conversion sections and it is likely that output data is different even at an identical input voltage. In this case, it is sufficient to input voltages supplied from an identical amplifier to the plural AD conversion sections, detects offset fluctuation in the AD conversion sections from fluctuation in output value, and correct the offset fluctuation.

When the cause for voltage fluctuation, such as due to a laser shot, is known and the location or period of the fluctuation is known, or when voltage fluctuation does not exist among plural adjacent pixels, correction data may be shared among plural pixels instead of having separate data for all pixels. In this case, a voltage of at least one of shared pixels may be read, and when data is shared among four pixels, the number of pixels to be read may be reduced to one fourth. (To improve accuracy in reading a voltage, 2 to 4 pixels may be read and the result may be averaged to obtain correction data. Even in this case, when 2 to 3 pixels are read, reading time can be shorter than when reading all pixels.)

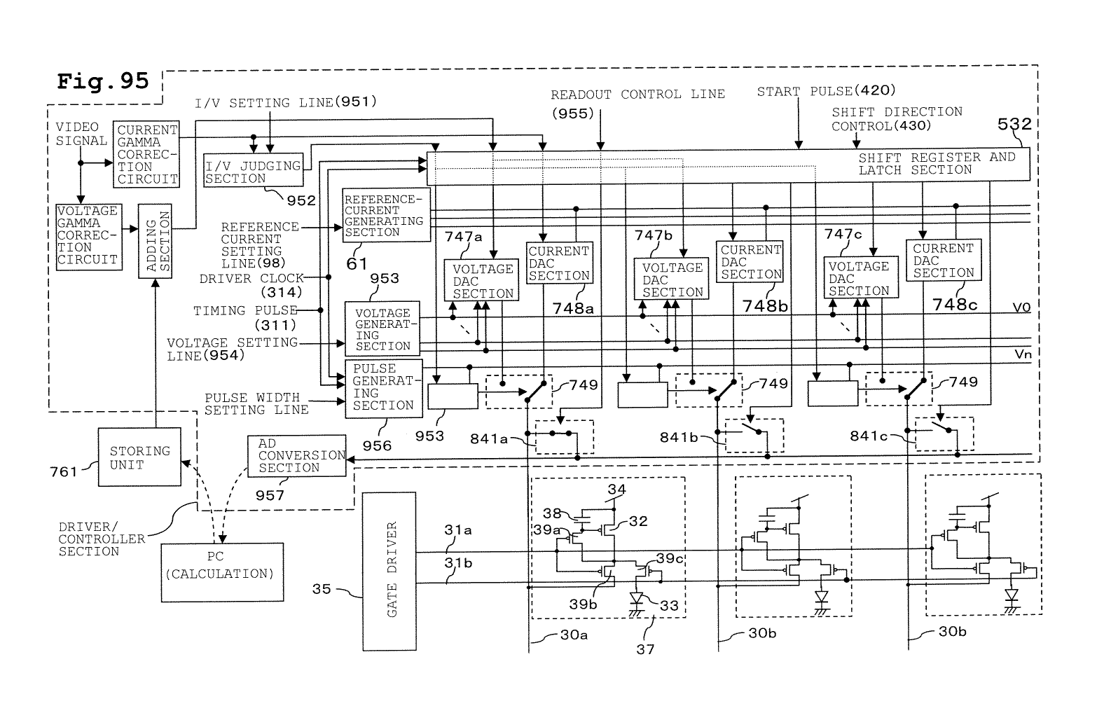

The structure in which the driver, the panels, and the ROM are combined in the method described above is shown in FIG. 95.

An inputted video signal is inputted to the DAC section via the gamma correction circuit. After the video signal is converted into an analog signal by the DAC section, the switching section 749 determines which of a voltage and an electric current should be outputted. This determination is based on a pulse output by a pulse generating section 956 and an output of an I/V judging section 952. The pulse generating section 956 is a section for determining time for performing voltage writing in one horizontal scanning period. The pulse generating section 956 outputs a pulse of about 2 to 10 microseconds at the beginning of a horizontal scanning period. The I/V judging section 952 is a section for determining, for each of the pixels, whether a voltage writing period should be provided. An output of the I/V judging section 952 is “1” when voltage writing is permitted and is “0” when voltage writing is not permitted. Consequently, it is possible to perform writing in only current driving. Even if the voltage writing is permitted, when there is no pulse in the pulse generating section 956, a switching control section 953 always selects the current DAC section. The switching control section 953 calculates a logical product (AND) of an output of the I/V judging section 952 and an output of the pulse generating section 956. Therefore, when only current driving is carried out, there is a method of always not permitting voltage writing with an I/V setting line 951 or setting a pulse width to zero with a pulse width setting line, It is also possible to carry out only voltage driving. If an output of the I/V judging section 952 is always set to “1” and an output of the pulse generating section 956 is always set at “H” level, the voltage DAC section is selected. If this operation is used, it is also possible to use this driver in the pixel structure in FIG. 85.

The I/V judging section 952 captures an output of a current gamma correction circuit 742. Consequently, it is also possible to carry out, for example, only current driving at a gradation equal to or higher than a fixed gradation. In other words, when the output of the current gamma correction circuit 742 is equal to or higher than the fixed gradation, an output of the I/V judging section 952 only has to be “0”. This is applicable when writing is possible only with current driving. It is possible to reduce electric power by charge and discharge of an amplifier by not using the voltage DAC.

As a method of inputting fluctuation data of the driving transistor by the storing unit 761, as explained above, a constant current is applied to the pixels, a gate voltage of the driving transistor at that time is measured, and fluctuation is quantized and written.

As a method of applying a constant current to the pixels, a fixed gradation is inputted to a video signal such that the same current output is performed from the current DAC section in all the pixels. In this case, it is necessary to eliminate an output of the pulse generating section 956 or set an output of the I/V judging section 952 to “0” such that the current output can be selected.

When the constant current is written in the pixels in this way, the constant current is written in the driving transistor 32. A flow of an electric current (971) at the time when the electric current is written in the driving transistor 32 is shown in FIG. 97. In order to measure a gate voltage of the driving transistor 32 at this point, one of the readout sections 841 is connected to the AD conversion section 957. Since different voltages are connected if two or more readout sections 841 are simultaneously connected, only one readout section 841 is connected. In FIG. 95, the readout section 841 can be connected one by one in order by a readout control line 955 and the shift register 532. It is possible to keep all the readout sections 841 disconnected. In that case, an “L” level only has to be inputted through the readout control line 955. When the readout sections 841 are connected, if an “H” level is inputted at the width of one shift clock, the readout sections 841 are connected in order for each of outputs.

Consequently, as indicated by a dotted line 972 in FIG. 97, a gate voltage of the driving transistor 32 propagates to the source signal line 30 via the switch 39b and is inputted to the AD conversion section 957 via a selected readout section 841a. As timing of AD conversion, the AD conversion needs to be carried out after stray capacitance charge and discharge of the respective signal lines are completed until the gate voltage of the driving transistor 32 is inputted to the AD conversion section 957. When the AD conversion is completed, the selected readout section 841a is changed to a readout section 841b. After completion of the readout section 841b, voltages of pixels in the same row as the readout section 841c are sequentially read. After having read all pixels in one row, the gate driver operates to continue with reading voltages in the next row.

Although description has been made in a pixel structure of a current copier in FIG. 97, it is also possible to read voltages in a similar way with other pixel structures such as a pixel structure of a current mirror (FIG. 5). This approach could be applied similarly to a structure in which drain voltage can be applied to the driving transistor 32 that controls a current flowing to the organic light-emitting element, and in which the current value can be externally known and a gate voltage or a drain voltage can be externally extracted. This approach can be applied even to the pixel structure in FIG. 79 or FIG. 85, in addition to the current-driven pixel structure.

Data after the conversion is captured into a PC. Calculation is performed in accordance with FIG. 73 when data for all the pixels are collected. The data are written in the storing unit 761 to complete the creation of correction data.

The AD conversion section 957 and the PC do not have to be always connected and the PC and the storing unit 761 do not always have to be connected. These devices only have to be connected in an adjustment process (a process for correcting pixel voltages) before shipment. Therefore, the AD conversion section 957 is unnecessary during normal driving. The AD conversion section 957 may be built in the driver section as shown in FIG. 95 or, like the PC, may be mounted on an external circuit for adjustment only during adjustment. The readout sections 841 are usually set in an OFF state in all the circuits.

A voltage generating section 953 includes a circuit shown in FIG. 96.

A maximum voltage is V0 and a minimum voltage is Vn. (n is the number of stages necessary for voltage output and is equal to or larger than 1.) A voltage is generated by resistance division of a resistance element 963 to improve gradation properties. For outputs V0 to Vn, a buffer may be provided depending on a load capacity. The maximum and minimum voltages can be changed taking into account characteristic fluctuation of the driving transistor of the array. The maximum voltage is substantially equivalent to a threshold voltage of the transistor. The level of a voltage can be adjusted according to fluctuation in the threshold voltage. The voltage generating section 953 includes electronic volumes 961 in order to perform adjustment. The electronic volumes 961 can be adjusted by voltage setting lines 954 from the outside. A Vn side is a voltage on a high gradation side. As explained with reference to FIG. 78 and the like, concerning a voltage correction portion, since voltage display is performed by adding and subtracting data on the basis of a voltage per one stage of V0 to Vn, a voltage fluctuation width per one stage cannot be changed. (E.g., the voltage fluctuation width is fixed at 10 mV.) Therefore, if the voltage V0 is changed, it is necessary to change the voltage Vn by an identical voltage value. The electronic volume and the voltage setting line are provided on the Vn side as well. In operation, the electronic volumes A and B need to be simultaneously changed by an identical voltage value.

Even if the electronic volumes are not provided in two places, if it is possible to fix a potential difference between V0 and Vn, one of the electronic volumes is unnecessary. Such a circuit configuration is acceptable.

A system for providing the electronic volumes in the two places has an advantage that it is possible to correct, for example, deviation of a potential difference per one stage due to offset of amplifiers 962 provided in a VA output and a VB output.

Voltage values of V0 and Vn are measured and a voltage per one stage is calculated on the basis of measured voltages. When the voltage deviates from a voltage interval width at the time when correction data is inputted to the storing unit, one of the electronic volumes A and B only has to be adjusted to adjust the voltage per one stage to the voltage interval width. When amplifiers are provided in the respective outputs, it is likely that a deviation of the output amplifiers affects the voltage. Thus, in that case, for example, output voltages at plural (or all) terminals may be measured and adjusted as an average value.

In measurement of the V0 and Vn voltages, first, since correction data is not stored in the storing unit 761, addition with correction data in the storing unit 761 by the adding section is stopped (no correction) and data corresponding to V0 is inputted to the voltage DAC section 747 according to a video signal and setting of the voltage gamma correction circuit. Moreover, the switching section 749 selects the voltage DAC section. Therefore, if the I/V judging section 952 sets an output to “1” and the pulse generating section 956 is always set to the “H” level, the voltage DAC section is always connected to the source signal line 30. By connecting the readout sections 841 to the AD conversion section 957 one by one in this state, it is possible to measure a voltage equivalent to V0 among voltages generated by the voltage generating section 953. It is possible to measure a voltage corresponding to Vn from the AD conversion section 957 by inputting data corresponding to Vn to the voltage DAC section according to a video signal and setting of the voltage gamma correction circuit.

Subsequently, a difference between a voltage equivalent to V0 and a voltage equivalent to Vn is calculated. The calculation of the difference may be calculation of a difference between an average of an output data group of V0 and an output data group of Vn, an average of at least two outputs of data of an output potential difference between V0 and Vn at an identical terminal, or a potential difference between V0 and Vn at one arbitrary output. When a potential difference is known, a dynamic range of the voltage DAC section 747 is known. When the number of stages of the DAC is known, a voltage interval width per one stage is known.

In order to match an actual interval width of the voltage DAC section to an interval width in quantizing fluctuation data, a value of one of voltage setting lines 954a and 954b and an electronic volume are changed. Thus, matching can be performed. For example, when the actual interval width is small, in order to increase the interval width, the voltage VA only has to be increased (the electronic volume 961 is controlled) or the voltage VB only has to be decreased (the electronic volume 961b is controlled).

On the contrary, the quantization may be performed using interval width data of the actual voltage output section. Prior to performing the quantization (732) in FIG. 73, data corresponding to V0 and Vn is measured and an interval width per one stage for the DAC is calculated. The quantization is performed depending on the calculated interval width.

It is also possible to measure voltage fluctuation between adjacent terminals of the voltage DAC section using a method of measuring voltages V0 and Vn. It is possible to show voltage fluctuation small by adding or subtracting data inputted to the voltage DAC 747 by an amount of voltage deviation. For example, in the case in which a fifth output voltage is 20 mV higher than other outputs, when an interval width of the voltage generating section is 10 mV and the voltage DAC 747 has a lower voltage as input data is larger, in pixels that use a fifth output, if a correction value is set larger than a pixel potential measurement result by “2”, a voltage is lower in all the pixels by 20 mV. In this way, deviation of an output voltage is corrected and occurrence of unevenness is prevented. In this case, as data stored in the storing unit, data of fluctuation obtained by superimposing characteristic fluctuation of the driving transistor for each of the pixels and characteristic fluctuation in an output voltage of the source driver is written.

Since the DA conversion sections and the readout sections 841 are not used during normal driving, the DA conversion sections and the readout sections 841 do not have to be included in the driver section. For example, as shown in FIG. 98, a read out section may be formed on another place, for example on an array separately from a driver section and a display section. As an advantage of forming the readout section on the array, it is possible to adopt a method of dividing a circuit for readout including the readout section after the end of an inspection and removing the readout section together with a circuit space during shipment to thereby providing a panel without increasing a frame.

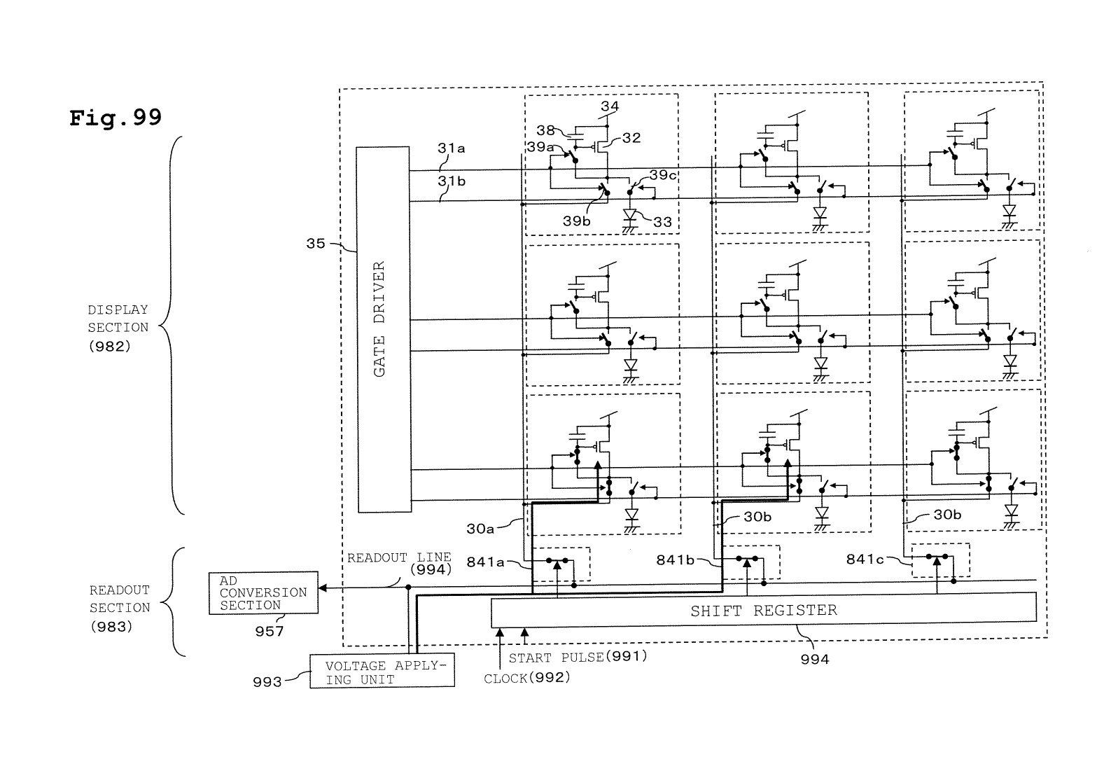

Moreover, in FIG. 99, a shift register is provided in the readout section and voltage applying section 993 for applying a voltage from the outside is further provided and connected to a readout line 994. Then, a voltage is applied to the gate of the driving transistor 32 with a voltage value corresponding to a voltage from the voltage applying unit 993 by an operation of the readout section 841 and scanning of the gate driver, whereby the organic light-emitting element 33 is lit. The lighting is possible even if the source driver I is not provided. Since writing is performed at a constant voltage regardless of the characteristic of the driving transistor 32, it is likely that luminance is different for each of the pixels. However, the pixels are in a display state, it is possible to detect a point defect and a line defect such as a light-on point and a light-off point.

As described above, in order to inspect a defect of the pixels, it is sufficient to allow the shift register 994 to turn on all the switches of the readout sections 841 such that voltages can be simultaneously supplied to the source signal line 30 in an inspection area. For example, a start pulse 991 is always set at a high level during inspection and a pulse corresponding to a readout time is inputted during voltage readout to connect the pixels to the readout line 994 one by one.

By sharing the circuit for inspection and voltage readout in this way, it is possible to remove a circuit necessary for inspection and reduce a size of a penal frame. When the circuit is divided for shipment, since a layout area per one panel is reduced because the readout section is reduced in size, there is an advantage that it is likely that the number of manufactured product can be increased.

There is temperature dependency in a relation between a drain current and a gate voltage of the driving transistor 32. As temperature is higher, a gate voltage needs to be set higher in order to have an identical drain current. Conversely, when a constant voltage is applied, as temperature is higher, a drain current increases and an electric current flowing to the organic light-emitting element 33 increases. As a result, luminance increases. In other words, it is likely that the luminance of the panel is changed by temperature. In the pixel having the structure in FIG. 3, since current writing is performed by the current DAC section 748, a voltage change due to temperature is compensated for by current driving. However, a current value is small, it is likely that a compensation operation is not sufficiently performed, the operation is incomplete, and a luminance change is caused.

Thus, as shown in FIG. 100, the AD conversion section 957 is provided in the driver IC section to make it possible to measure voltages of the pixels during a normal operation other than during inspection. In such structure, voltages of the pixels are measured, an applied voltage is changed according to an amount of change of the voltages, and a luminance change due to temperature is reduced.

A pixel voltage of the driving transistor 32 at the room temperature (e.g., 25 degrees) is recorded in advance. An optimum voltage is determined during measurement according to a potential difference between the pixel voltage and a voltage during measurement. For example, if a voltage during adjustment is 4.5 V and a voltage during measurement is 4.2 V, a voltage 0.3 V is an amount of change due to temperature. Thus, if voltages are reduced by 0.3 V in both the two electronic volumes 961 of the voltage generating section 953, it is considered that an electric current same as that under the room temperature flows to the EL element.

Therefore, the structure in FIG. 100 in which voltages of the pixels can be fed back from an output of the AD conversion section 957 such that a value of the voltage setting line 954 for determining a voltage of the electronic volume 961 can be changed according to the voltages of the pixels.

In order to detect a difference between a voltage during adjustment and a voltage during measurement, an amount of voltage change is detected by a comparator 1002. It is necessary to adjust a voltage during adjustment to be equal to a voltage under the room temperature while the temperature during adjustment is kept constant.

An amount of voltage change is calculated by the comparator 1002 and outputted to the voltage control section 1001. In the voltage control section 1001, the amount of voltage change is divided by an interval width of the electronic volume to calculate an amount of increase or decrease of the electronic volume by a circuit block that calculates how much a value of the electronic volume should be changed. Values of the generated voltages V0 to Vn are changed by adding a value of the amount of increase or decrease to or subtracting the value from a present electronic volume value. An optimum gradation voltage is outputted from the voltage generating section 953 for each temperature.

As the number of pixels is larger, an average amount of change of measured voltages over the entire panel is known better and there is a more effect of fixing average luminance. However, when it is taken into account that it takes time to read out voltages and display cannot be performed during readout, it is necessary to read out voltages in time as short as possible. Therefore, it is preferable that the number of pixels from which voltages are read out is equal to or smaller than ten. Moreover, it is preferable to select pixels having voltages in a range of in-plane fluctuation (an average value ±Γ) from a voltage during adjustment. From the viewpoint of reduction in a temperature readout time, it is possible to readout voltages faster as the number of pixels in one row, in which a current value can be simultaneously written, is larger. Therefore, voltages of ten or fewer pixels are read out from an identical row.

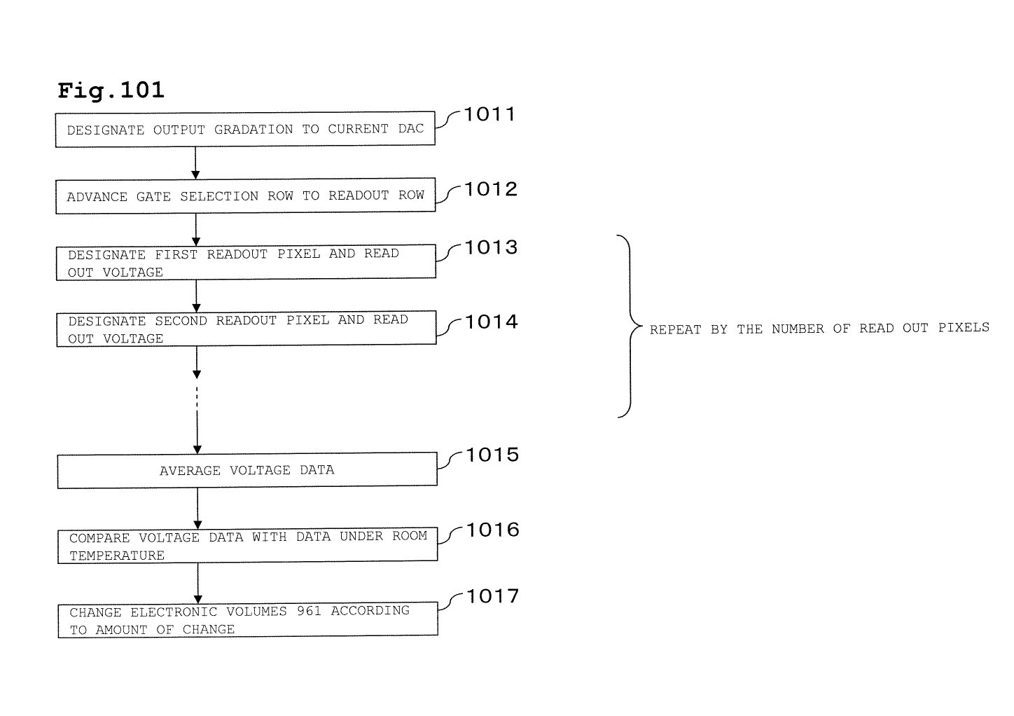

A flow of a method of reading out voltages and changing the voltages according to temperature is shown in FIG. 101. This is a flow at the time when there is already voltage data under the room temperature at an adjustment stage. In reading out voltages, it is necessary to measure voltages under conditions identical with those during adjustment except temperature. Therefore, first, a gradation of the current DAC is set. (The setting may be always fixed or may be stored in the storing unit and read out from a designated address of the storing unit.)

Subsequently, an electric current is written in pixels from which voltages are read out. The pixels from which voltages are read out are plural pixels in one row determined in advance during adjustment. The number of rows, the number of columns, and the number of pixels are stored in the storing unit during adjustment and read out from a stored address. This is for the purpose of preventing data of defective pixels from being obtained. During adjustment, data are examined and addresses of nondefective pixels are described in the storing unit. Voltage readout is carried out for a designated number of designated pixels. The voltage readout from the pixels is controlled by the readout circuit 841 in order. Both setting of rows and setting of columns are often performed by the shift register. A controller for changing a row to a designated row is necessary. (A case in which, for example, the gate driver stops in a seventh row is assumed.)

Since the change of a pixel potential is carried out uniformly over the entire screen rather than in pixel sections, only one data is sufficient. Therefore, when voltages in plural pixels are measured, the voltages are averaged to reduce an influence of white color noise.

Subsequently, the voltages are compared with the voltage under the room temperature measured in advance to calculate an amount of change in the voltages (1016).

Values of the two electronic volumes 961 are changed according to the amount of change such that an applied voltage can be changed by the amount of change.

Consequently, a gradation voltage corresponding to a potential change responding to temperature could be supplied, although the gradation voltage is an average in a plane, and display with less influence of temperature characteristic fluctuation could be realized.

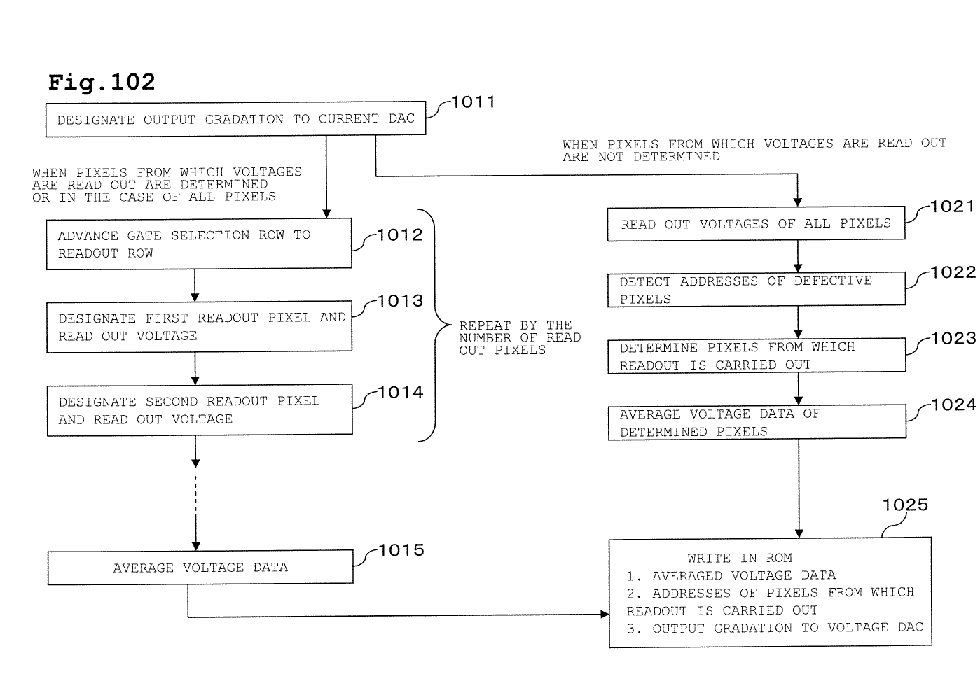

Voltage data under the room temperature, addresses of pixels from which voltages are read out during temperature correction, and a writing current are stored in the ROM according to a flow shown in FIG. 102. Data to be stored is created according to the flow in FIG. 102.

If pixels from which voltages are read out are determined, voltage measurement is performed only in the pixels. However, if such pixels are not determined, all the pixels are read out and room temperature data is detected from pixels obtained by excluding defective pixels having isolated values from voltage data. The isolated values may be, for example, values deviating from 3σ.

When it is assumed that the number of defective pixels is small or when the number of pixels from which voltages are read out is small, the defective pixels may be excluded from pixels in a part of areas rather than all the pixels.

Since the correction of a change in a pixel voltage due to temperature is performed by the electronic volumes 961, it is likely that sudden luminance change occurs or correction is insufficient depending on an interval width of the electronic volumes.

Although a finer interval width is better, the number of states of the electronic volumes increases and cost increases. Since measurement accuracy for a pixel voltage includes noise of about 2 to 5 mV, an interval width smaller than 10 mV is affected by the noise and the temperature correction effect does not easily appear. Since it is impossible to measure voltages at the accuracy of an interval smaller than 10 mV, an interval width may be equal to or larger than 10 mV. On the other hand, when an interval width is rough, an amount of potential change per one stage increases and an amount of luminance change per one stage also increases. Therefore, since an optimum value cannot be set and a potential difference between a measured value and a calculated value due to a rounding error changes every time measurement is performed, it is likely that luminance changes and flicker occurs. Thus, as a method of preventing flicker from occurring, the number of times of measurement is reduced or measurement timing is taken into account.

As the reduction of the number of times of measurement, for example, there is a method of performing measurement only after the power supply is turned on, only immediately before the pixels come into the display state, or only during a substantial scene change. In a normal state of life, since a substantial temperature change rarely occurs during display, it is possible to sufficiently correct a change in a pixel voltage by measuring temperature when the power supply is turned on or in a state immediately before display. If a temperature change after that is less than 10 degrees, since a luminance change is about 5%, the luminance change is not a problem because the luminance change is not recognizable during the use of a display.

Concerning an interval width, if an operation of temperature correction is performed only about once during display, luminance deviation in every display is less noticeable unless luminance is extremely high or extremely low. If a ratio of a channel width to a channel length of the driving transistor 32 is about (channel width)/(channel length)=1/4, even if an interval width is 60 mV, luminance deviation due to a rounding error is about 5%. This is deviation unnoticeable during use.

Consequently, an interval width of the electronic volumes 961 is preferably designed in a range of 10 to 60 mV.

According to the method of reading out a pixel voltage, comparing the pixel voltage with a voltage during adjustment, and correcting a difference between the voltages, it is possible to correct not only voltage fluctuation due to a temperature change but also voltage fluctuation due to aged deterioration of the TFT. Consequently, it is possible to adopt a voltage driving system in which amorphous silicon having conspicuous Vth shift is used for the driving transistor 32. When Vth changes because of aged deterioration or application of a high voltage, since it is possible to detect an amount of voltage change, a constant current can be supplied by voltage application corresponding to an amount of change. Therefore, a luminance change due to aged deterioration of the driving transistor is prevented.

Detection of an amount of voltage change from data stored in the storing unit performed by using the AD conversion section 957, the comparator 1002, and the voltage control section 1001 has a function of compensating for an amount of change when a characteristic of the TFT changes because of an external factor other than a change due to temperature and a change in a TFT characteristic due to aged deterioration. Time for tracking the change changes depending on a measurement interval of the AD conversion section 957.

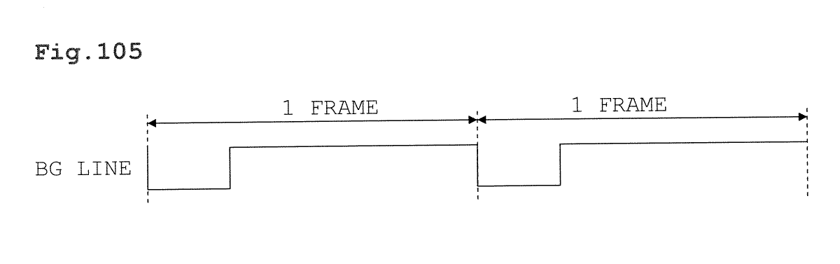

The system described above can be feasible even in case of duty-driven elements with black insertion used to improve the motion response. With the duty-driven elements, gate signal lines of BG in FIG. 85, G3 in FIG. 79, 31b in FIG. 3 or 31d in FIG. 5 are controlled such that a current flowing to the organic light-emitting element is eliminated for a fixed period as shown in FIG. 105 and are caused to be conductive for only a partial period of one frame (1/N).

In this case, the applied current should be increased by a factor of N in order to maintain the luminance. In the system described above, a current may be increased by a factor of N when reading fluctuation data from a pixel and the setting in the voltage gamma correction circuit may be changed such that the current increased by a factor of N can be flown. A current output of the current DAC section is also increased by a factor of N when performing current driving. The operation of increasing a current output by a factor of N is performed by the reference-current generating section 61. Other operations are similar to the case without black insertion.

In the above explanation, the organic light-emitting element is used as the display element. However, the present invention can be carried out using any display element such as a light-emitting diode, an SED (Surface-conduction Electron-emitter Display), or an FED in which an electric current and luminance are in a proportional relation.

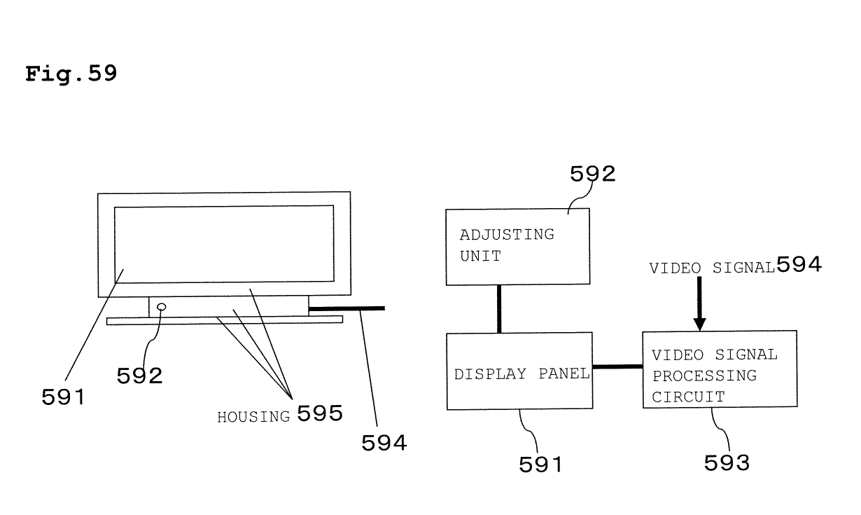

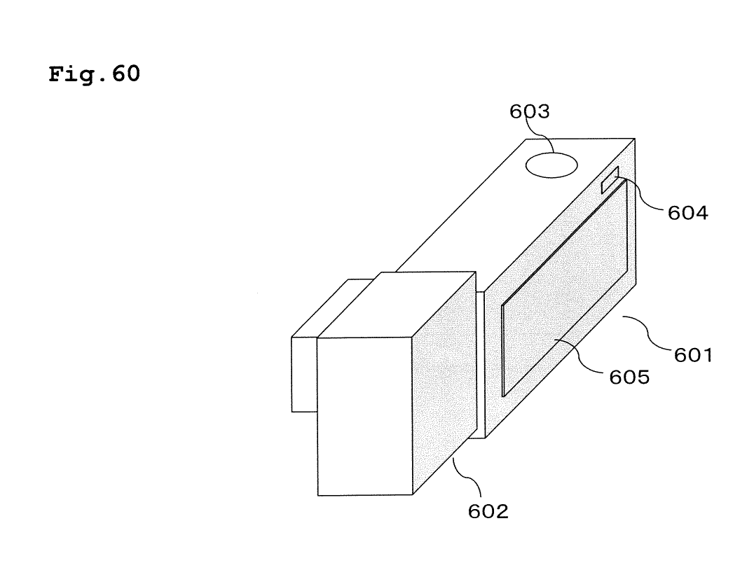

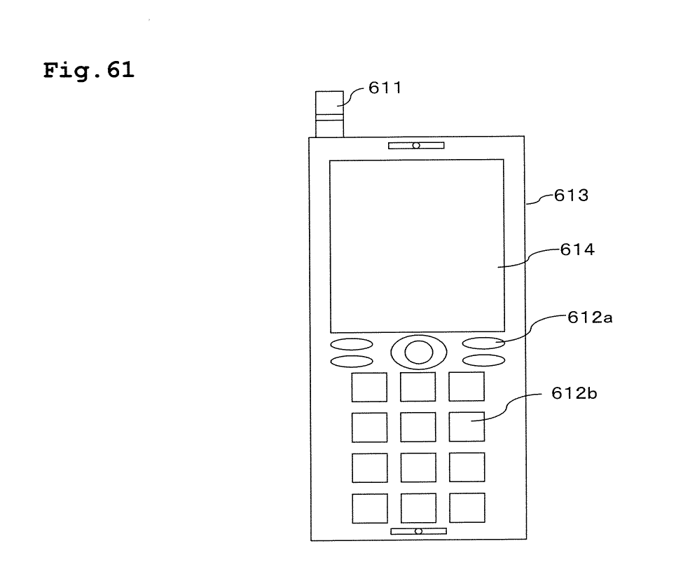

As shown in FIGS. 59 to 61, it is possible to realize products having higher gradation display performance by applying a display device in which such a display element is used to a television, a video camera, and a cellular phone.

In the example illustrated and explained above, the control IC 28 or the controller and the source driver 36 are realized by using separate ICs, respectively. However, even when the control IC 28 or the controller and the source driver 36 are integrated on an identical chip, it is also possible to carry out the present invention and the same effect is obtained.

In the above explanation, the transistor is a MOS transistor. However, an MIS transistor and a bipolar transistor are also applicable.

Materials such as crystal silicon, low-temperature polysilicon, amorphous silicon, and gallium arsenide compound are also applicable as the transistor.

In the current output type semiconductor circuit and the display device described above, the number of output bits of the current driver may be increased.

The active matrix display device, and method of driving active matrix display device using organic light-emitting element according to the present invention can prevent display unevenness from occurring in display performed by using the organic light-emitting element and is useful as a display device and the like that perform gradation display according to a current amount using the organic light-emitting element and the like.

What is claimed is:

1. An active matrix display device using an organic light-emitting element comprising:
a pixel having the organic light-emitting element;
a driving transistor that determines an electric current flowing to the organic light-emitting element according to a gate voltage;
a storing unit; and
a voltage output unit that supplies a voltage to the pixel,
wherein a voltage output from the voltage output unit varies depending on data in the storing unit.

2. The active matrix display device using an organic light-emitting element according to claim 1, further comprising a voltage detecting unit which detects at least one of a gate voltage of the driving transistor, a drain voltage of the driving transistor, and an output voltage from the voltage output unit.

3. The active matrix display device using an organic light-emitting element according to claim 2, wherein the voltage detecting unit is formed in a driver unit including the voltage output unit.

4. The active matrix display device using an organic light-emitting element according to claim 2, wherein the voltage detecting unit is provided in an array substrate on which the pixel is arrayed.

5. The active matrix display device using an organic light-emitting element according to claim 2, wherein the gate voltage of the driving transistor or the drain voltage of the driving transistor is a voltage taken when a first electric current is flown to the driving transistor.

6. The active matrix display device using an organic light-emitting element according to claim 2, wherein the gate voltage of the driving transistor or the drain voltage of the driving transistor is a voltage taken when a drain current at a first input gradation is flown to the driving transistor.

7. The active matrix display device using an organic light-emitting element according to claim 2, wherein the output voltage from the voltage output unit is a voltage at a second input gradation.

8. The active matrix display device using an organic light-emitting element according to claim 1, wherein the storing unit retains correction data generated on the basis of at least one of a gate voltage of the driving transistor, a drain voltage of the driving transistor, and an output voltage from the voltage output unit.

9. The active matrix display device using an organic light-emitting element according to claim 8, further comprising a voltage detecting unit which detects at least one of a gate voltage of the driving transistor, a drain voltage of the driving transistor, and an output voltage from the voltage output unit,
wherein a voltage is detected by using the voltage detecting unit.

10. The active matrix display device using an organic light-emitting element according to claim 8, wherein the gate voltage of the driving transistor or the drain voltage of the driving transistor is a gate voltage of the driving transistor or a drain voltage of the driving transistor for a fourth gradation input different from second and third gradation inputs,
wherein a gate voltage of the driving transistor or a drain voltage of the driving transistor is measured with respect to the second gradation input and the third gradation input different from the second gradation input, respectively, and
the gate or drain voltage for the fourth gradation input is calculated based on, with regard to the pixel in the same position,
the gate voltage of the driving transistor or the drain voltage of the driving transistor corresponding to the second gradation input and
the gate voltage of the driving transistor or the drain voltage of the driving transistor corresponding to the third gradation input.

11. The active matrix display device using an organic light-emitting element according to claim 8, wherein a potential difference per one gradation in the voltage output unit is calculated based on
an output at a fifth gradation input in the voltage output unit and
an output at a sixth gradation input different from the fifth gradation input in the voltage output unit, and
wherein the voltage is sampled according to the calculated potential difference and retained.

12. The active matrix display device using an organic light-emitting element according to claim 8, wherein two or more pieces of the correction data are retained with regard to the pixel in the same position, and the respective retained correction data is a voltage for a different input.

13. The active matrix display device using an organic light-emitting element according to claim 8, wherein the correction data is formed for each of the pixel.

14. The active matrix display device using an organic light-emitting element according to claim 1, further comprising an electronic volume for adjusting a voltage applied to the pixel,
wherein a luminance during black display is adjusted by adjusting the electronic volume, and
a value of the electronic volume at a predetermined black luminance is retained in the storing unit.

15. The active matrix display device using an organic light-emitting element according to claim 1, further comprising a voltage output unit that performs D/A conversion using gradation data inputted to perform display corresponding to display gradations and correction data stored by the storing unit.

16. The active matrix display device using an organic light-emitting element according to claim 15, wherein the voltage output unit outputs linear outputs and performs the D/A conversion by adding up the inputted gradation data and the stored correction data.

17. The active matrix display device using an organic light-emitting element according to claim 15, wherein when two or more pieces of the correction data exist with regard to the pixel in the same position and forms a correction data group,
the correction data closest to the inputted gradation data in terms of a measurement condition is used from within the correction data group to perform the D/A conversion.

18. The active matrix display device using an organic light-emitting element according to claim 15, wherein when two or more pieces of the correction data exist for the pixel in the same position and forms a correction data group,
third correction data corresponding to the inputted gradation data is calculated based on two first and second correction data, the first being the data closest to the inputted gradation data in terms of a measurement condition from within the correction data group and the second being the next closest data, and
the third correction data and the inputted gradation data are used in the D/A conversion to determine an output of the voltage output unit.

19. A method of driving the active matrix display device using an organic light-emitting element of claim 1, wherein there is a duration during which the voltage output unit performs output.

20. The method of driving the active matrix display device using an organic light-emitting element according to claim 19, wherein the pixel has a pixel structure corresponding to a current driving system, and
the voltage is applied by the voltage output unit to the pixel in a voltage pre-charge period in the current driving system on the basis of gradation data inputted to perform display corresponding to display gradations and compensation data stored by the storing unit.

21. The method of driving the active matrix display device using an organic light-emitting element according to claim 19, wherein the voltage is applied by the voltage output unit to the pixel in a signal writing period on the basis of compensation data stored by the storing unit.

22. The active matrix display device using an organic light-emitting element according to claim 1, further comprising:
an AD converting unit that performs A/D conversion in order to perform measurement of a voltage applied to the pixel during operation; and
a voltage control unit that performs control of a voltage applied to the pixel according to a result of the measurement.

23. The active matrix display device using an organic light-emitting element according to claim 22, wherein the voltage control unit performs control of the voltage according to a result of comparison between a result of the measurement and compensation data stored by the storing unit.

24. The active matrix display device using an organic light-emitting element according to claim 23, wherein the voltage control unit performs control of the voltage taking into account ambient temperature.

25. The active matrix display device using an organic light-emitting element according to claim 23, wherein the voltage control unit performs control of the voltage taking into account elapsed time after a power supply is turned on.
